(19) United States
(12) Patent Application Publication
(10) Pub. No.: US 2014/0115596 A1
(43) Pub. Date: Apr. 24, 2014

(54) CODELETSET REPRESENTATION, MANIPULATOIN, AND EXECUTION - METHOD, SYSTEM AND APPARATUS

(71) Applicants: Rishi L. Khan, Wilmington, DE (US); Daniel Orozco, Newark, DE (US); Guang R. Gao, Newark, DE (US); Kelly Livingston, Elkton, MD (US)

(72) Inventors: Rishi L. Khan, Wilmington, DE (US); Daniel Orozco, Newark, DE (US); Guang R. Gao, Newark, DE (US); Kelly Livingston, Elkton, MD (US)

(73) Assignee: ET International, Inc., Newark, DE (US)

(21) Appl. No.: 13/218,082

(22) Filed: Aug. 25, 2011

Related U.S. Application Data
(60) Provisional application No. 61/377,067, filed on Aug. 25, 2010.
(60) Provisional application No. 61/386,472, filed on Sep. 25, 2010.

(51) Int. Cl. G06F 9/50

(52) U.S. Cl. CPC G06F 9/50
USPC 718/104

(57) ABSTRACT

Codeletset methods and/or apparatus may be used to enable resource-efficient computing. Such methods may involve decomposing a program into sets of codelets that may be allocated among multiple computing elements, which may enable parallelism and efficient use of the multiple computing elements. Allocation may be based, for example, on efficiencies with respect to data dependencies and/or communications among codelets.

### CROSS REFERENCE TO RELATED APPLICATIONS

This application claims the benefit of U.S. Provisional Application No. 61/377,067, filed Aug. 25, 2010, and U.S. Provisional Application No. 61/386,472, filed Sep. 25, 2010, each of which is incorporated by reference in its entirety.

### GOVERNMENT RIGHTS

The United States Government has rights in portions of this invention pursuant to Contract No. HR0011-10-0007 between the United States Defense Advanced Research Projects Agency (DARPA) and ET International, Inc.

### BACKGROUND

1. Technical Field

Various embodiments of the present invention may relate generally to the field of data processing, system control, and data communications, and more specifically to an integrated method, system, and apparatus that may provide resource-efficient computation, especially for execution of large, many-component tasks that may be distributed on multiple processing elements.

2. Descriptions of the Related Art

Modern high-end computer architectures embody tens of thousands to millions of processing elements, large amounts of distributed memory, together with varying degrees of non-local memory, networking components and storage infrastructure. These systems present great challenges for both static and dynamic optimization of resources consumed by executing applications. Traditionally, computer architectures have labored to present applications with a single simple address space, along with intuitively reasonable semantics for sequential execution of code and access to data. The resulting paradigm has served well for years, but becomes an impediment to efficient resource allocation when both computation and data are distributed and virtually all hardware speedup is accomplished via parallel processing, rather than by faster clock rates. However, there may be a time when semiconductor manufacturers approach physical or cost-efficiency limits on the reduction of circuit sizes, leaving parallelism as the most promising avenue for performance improvement. Already, in applications where maximum performance is critical, traditional operating system (OS) resource allocation via interrupts and pre-emption impedes performance.

A challenge in efficient distributed computing is to provide system software that makes efficient use of the physical system while providing a usable abstract model of computation for writers of application code. To do so, it is advantageous that consistent choices be made along the spectrum of system elements, so that control, monitoring, reliability and security are coherent at every level. It would also be advantageous to provide computer specification systems, coordination systems, and languages with clear and reasonable semantics, so that a reasonably large subset of application developers can work productively in the new environment, and to provide compilers or interpreters that support efficient distributed execution of application code and related development tools that provide developers with options and insight regarding the execution of application code. An additional facet of the challenge is that there is a large body of existing code that exploits little or none of the potential parallelism afforded by new languages and applications.

### RELATED ART

Art of note that may be in the same general field as the current invention includes: U.S. Pat. Nos. 5,388,238, 5,583,453, 5,924,114, 6,088,817, 6,178,473. 6,625,689, 6,668,291, 6,782,447, 6,889,269, 6,965,961, 6,978,344, 7,130,936, 7,205,792, 7,246,182, 7,404,058, 7,594,087, 7,716,396, 7,730,491, and US patent applications including: 2002007830, 2003006589, 2003017716, 2003018246, 2004001551, 2005006608, 2006025364, 2008011242, 2009005567, 2009008949, 2009020475; and papers by Michael and Scott, Shavit and Zemach, Mendes, Herlihy and Wing.

### SUMMARY OF VARIOUS EMBODIMENTS OF THE INVENTION

Codeletsets may be constructed to exploit highly parallel architectures of many processing elements, where both data and code can be distributed in a consistent multi-level organization. Codeletset systems and methods may achieve efficient use of processing resources by maintaining a model in which distance measures can be applied to code and data. A fine level of task allocation can be performed at the level of codelets, which are groups of instructions that can be executed non-preemptively to completion after input conditions have been satisfied.

In embodiments of the invention, the Codeletset systems and methods can allocate computing resources to computing tasks by performing one or more of the following: obtaining a set of codelets that accomplish a set of tasks; obtaining a set of specifications of data requested by codelets; constructing a metric space representing localities of codelets and the data they can access; obtaining statically defined initial arrangements for codelets with respect to the metric space distances; using the metric space representation for initially placing codelets or the data; obtaining dynamically-available runtime resource requests for codelets and data; and using the metric space representation for dynamically placing or moving codelets or data.

Additionally, in embodiments, the Codeletset systems and methods can prepare for allocation opportunities and may exploit those opportunities at run-time, e.g., by analyzing at compile-time potential code and data allocations for operations and references that indicate opportunities for merging or migrating codelets and data, and then performing run-time migration of these codelets, merged codelets, or data to exercise opportunities presented by actual code and data allocations.

Moreover, in support of fine-grained execution of codelets, embodiments of Codeletset systems and methods can provide secure and efficient localized memory access through one or more of the following actions: decomposing application code to codelets; providing a local table containing logical and physical addresses; mapping the physical addresses of distinct groups of related codelets to distinct address spaces, where each distinct address space is accessible to its distinct group of related codelets; and treating any access by a given distinct groups of codelets to a space outside its distinct address space as an error.

Various embodiments of the invention may further provide methods and/or systems for representation, manipulation and/or execution of codeletsets. Codeletsets are groups of codelets that can be treated as a unit with respect to dependency analysis or execution. Codeletsets may provide a mechanism for developing and executing distributed applications, as well as a mechanism for composability of an application: codeletsets can contain codeletsets, and they can be hierarchically constructed and reused. Even though codelets can run to completion without preemption as soon as their dependencies are satisfied, they can also be run on preemptive systems, either to simulate non-preemptive multicore architectures, or because some other attributes of preemptive computing are desirable for the distributed application represented by the codeletsets. Further, hints can be given to pre-emptive OS's to minimize preemption, such as core affinity and process priority. In this way, the Codeletset systems and methods of codelets can coexist with other legacy applications on current computer systems.

According to embodiments of the invention, rather than centralized control and allocation of resources, the system code (which may, itself, be implemented via codeletsets) may merely initialize the platform for codeletsets to run by enabling the initial routines of a codeletset. According to embodiments of the invention, application programs may be decomposed into independent segments of code that can be executed with minimal system coordination.

### BRIEF DESCRIPTION OF THE DRAWINGS

Figures are described as follows. Note that figures are intended to provide necessary background and to teach embodiments of the invention, and are not to be considered limiting.

FIG. 1 illustrates an exemplary codeletset architecture.

FIG. 2 shows exemplary codeletset allocation with multiple scopes.

FIG. 3 portrays an exemplary codeletset runtime system.

FIG. 4 illustrates an exemplary case of runtime performance monitoring and allocation.

FIG. 5 exemplifies runtime behavior for code in the codeletset system.

FIG. 6 portrays an exemplary hierarchy of interactions.

FIG. 7 illustrates an exemplary self-optimizing operating system.

FIG. 8 exemplifies explicit and implicit application directives.

FIG. 9 shows an exemplary micro-memory management unit.

FIG. 10 depicts an exemplary application use case.

FIG. 11 illustrates an exemplary grouping of codelets with local resources v. time

FIG. 12 illustrates an exemplary computing system using codeletsets.

FIG. 13 shows an exemplary codeletset representation system.

FIG. 14 shows an example of translation of codeletsets.

FIG. 15 shows an example of meta-level codeletset distribution.

FIG. 16 shows an example of codeletset execution and migration.

FIG. 17 illustrates an example of double-ended queue concurrent access mechanisms: write/enqueue.

FIG. 18 shows an example of dequeue concurrent access mechanisms: read/dequeue.

FIG. 19 illustrates an example of concurrent access via atomic addition array (A): write.

FIG. 20 illustrates an example of concurrent access via atomic addition array (B): write.

FIG. 21 illustrates an example of concurrent access via atomic addition array (C): read

FIG. 22 illustrates an example of linked list, specifically atomic addition arrays (A).

FIG. 23 illustrates an example of linked list, specifically atomic addition arrays (B).

FIG. 24 illustrates an example of linked list, specifically atomic addition arrays (C).

FIG. 25 illustrates an example of linked list, specifically atomic addition arrays (D).

FIG. 26 illustrates an example of linked list, specifically atomic addition arrays (E).

FIG. 27 illustrates an example of concurrent access via shared array with turns.

FIG. 28 illustrates an example of a combining network distributed increment.

FIG. 29 illustrates examples of monotasks and polytasks performing concurrent access via an atomic addition array (A).

FIG. 30 illustrates examples of monotasks and polytasks performing concurrent access via an atomic addition array (B).

FIG. 31 illustrates examples of monotasks and polytasks performing concurrent access via an atomic addition array (C).

FIG. 32 illustrates examples of monotasks and polytasks performing concurrent access via an atomic addition array (D).

FIG. 33 illustrates examples of monotasks and polytasks performing concurrent access via an atomic addition array (E).

FIG. 34 illustrates an exemplary codeletset computing system scenario.

FIG. 35 illustrates an example of a generic exemplary architecture at a chip level.

FIG. 36 illustrates an example of a generic architecture at a board/system level.

FIG. 37 illustrates an example of designation of codelets and codeletsets.

FIG. 38 illustrates an example of double buffer computation (A).

FIG. 39 illustrates an example of double buffer computation (B).

FIG. 40 illustrates an example of double buffer computation (C).

FIG. 41 illustrates an example of double buffer computation (D).

FIG. 42 illustrates an example of double buffer computation (E).

FIG. 43 illustrates an example of double buffer computation (F).

FIG. 44 illustrates an example of double buffer computation (G).

FIG. 45 illustrates an example of matrix multiply, with SRAM and DRAM.

FIG. 46 illustrates an example of matrix multiply double buffer/DRAM.

FIG. 47 illustrates an example in computing UNPACK DTRSM (a linear algebra function).

FIG. 48 illustrates an example of runtime initialization of codeletset for DTRSM.

FIG. 49 illustrates a quicksort example.

FIG. 50 illustrates an example of scalable system functions interspersed with application codeletsets.

FIG. 51 illustrates an example of the conversion of legacy code to codeletset tasks or polytasks.

FIG. 52 illustrates an example of blackbox code running with polytask code.

FIG. 53 illustrates an example of improved blackbox code running with polytask code.

### DETAILED DESCRIPTION

Glossary of Terms as they are Used

Application: a set of instructions that embody singular or multiple related specific tasks that a user wishes to perform.

Application Programmer Interface (API): a set of programmer-accessible procedures that expose functionalities of a system to manipulation by programs written by application developers who may not have access to the internal components of the system, or may desire a less complex or more consistent interface than that which is available via the underlying functionality of the system, or may desire an interface that adheres to particular standards of interoperation.

Codelet: a group of instructions that are generally able to be executed continuously to completion after their inputs become available.

Codeletsets: groups of codelets that can be treated as a unit with respect to dependency analysis or execution. A codeletset can also consist of a singleton codelet.

Computational domain: a set of processing elements that are grouped by locality or function. These domains can hierarchically include other computational domains. Hierarchical domain examples may include system, node, socket, core, and/or hardware thread.

Concurrent systems: sets of concurrent processes and objects that are manipulated by those processes.

Core: a processing unit in a computation device. These include, but are not limited to a CPU (central processing unit), GPU (graphics processing unit), FPGA (field gate programmable array), or subsets of the aforementioned.

Dependency: a directed arc between two codeletsets representing that one is to finish before the other can start.

Fractal regulation structure: mechanisms that provide efficient use of resources securely and reliably on multiple scales within the system, using similar strategies at each level.

GACT, Generalized actor: one user or a group of users, or a group of users and software agents, or a computational entity acting in the role of a user so as to achieve some goal.

GCS, Generalized computing system: one or more computers comprising programmable processors, memory, I/O devices that may be used to provide access to data and computing services.

CSIG, a codelet signal: a communication between codelets, or between a supervisory system and at least one codelet, that may be used to enable codelets whose dependencies are satisfied or to communicate status and/or completion information.

Hierarchical execution model: a multi-level execution model in which applications are disaggregated at several levels, including into codelets at a base level of granularity.

Linearizability: One or more operations in a concurrent processing system that appear to occur instantaneously. Linearizability is typically achieved by instructions that either succeed (as a group) or are discarded (rolled back) and by systems that provide “atomic” operations via special instructions, or provide locks around critical sections.

Lock-free synchronization: non-blocking synchronization of shared resources to ensure (at least) system-wide progress.

Local Area Network (LAN): connects computers and other network devices over a relatively small distance, usually within a single organization.

Node: a device consisting of one or more compute processors, and optionally memory, networking interfaces, and/or peripherals.

Over-provisioning: Providing more numerous processing elements and local memories than are minimal, to allow more latitude in resource allocation. For instance, replacing a small number of processing elements running highly sequential tasks at high clock speeds with more processing elements, running more distributed code and data at slower clock speeds.

PolyTasks: A group of related tasks that can be treated as a unit with respect to a set of computational resources. Typically, polytasks have similar resource demands, and may seek allocation of a block of resources. Polytasks can also have complementary resource requirements, and can perform load balancing by virtue of distributed requests.

Proximity: locality as in memory space, compute space, or the state of being close in time or dependence.

Queue: a data structure that can accept elements for enqueue and remove and return elements on dequeue. An element may be enqueued or dequeued at any position including, but not limited to, the beginning, end, or middle of the queue.

Run-time system (RTS): a collection of software designed to support the execution of computer programs.

Scalability: an ability of a computer system, architecture, network or process that allows it to efficiently meet demands for larger amounts of processing by use of additional processors, memory and/or connectivity.

Self-aware control system: a system that employs a model of its own performance and constraints, permitting high-level goals to be expressed declaratively with respect to model attributes.

Signal: An event enabling a codeletset. A signal can be sent by a codelet during execution.

Task: a unit of work in a software program.

Thread: a long-lived runtime processing object that is restricted to a specific processing element.

Wait-free synchronization: non-blocking synchronization of shared resources that guarantees that there is both system-wide progress, and per-thread progress.

Wide Area Network (WAN): Connects computers and other network devices over a potentially large geographic area.

Embodiments of the invention may provide methods and/or systems for representation, manipulation and/or execution of codeletsets. Codelets are groups of typically non-preemptive instructions that can normally execute continuously to completion after their dependencies are satisfied. Codeletsets are groups of codelets that can be treated as a unit with respect to dependency analysis or execution. Codeletsets may diverge from traditional programming and execution models in significant ways. Applications may be decomposed into independent segments of code that can be executed with minimal need for system coordination. According to embodiments of the invention, rather than centralized control and allocation of resources, the system code (itself implemented via codeletsets) may initialize the platform for codeletsets to run by enabling the initial codelets of a codeletset. These codelets have no prior dependencies and can therefore be enabled as soon as the codeletset is enabled. Codeletset applications need not be entirely held as text code space during their execution. In fact, translation of some infrequently used codeletset elements can be deferred, even indefinitely, if they are not required for a particular run or particular data provided during an execution.

Characteristics of embodiments of the codeletset approach may include:
a) decomposition of computational tasks to abstract modules that may minimize inter-module dependencies;
b) construction of a map of abstract dependencies that may guide initial codelet enablement and the initial and on-going allocation of computing resources;
c) use of a computational representation that may have at least as much expressive power as Petri nets;
d) migration of executing or soon-to-executed codeletsets to exploit locality of resources such as local memory, particular data and intermediate results, and the locality of cooperating codelets, in order to minimize communication delays;
e) migration of codeletsets to obtain better global allocation of resources, to allow some processing resources to be attenuated for energy saving or for reserve of capacity, or, e.g. in heterogeneous systems, to make use of resources better suited for a given processing task;
f) use of polytasks, i.e., related tasks that can be treated as a unit with respect to a set of computational resources, and that can be managed by a representative proxy task that may act to obtain needed resources or additional tasks for the group;
g) use of atomic addition arrays, which may efficiently mediate concurrent access for codelets that work on shared data or other processing inputs or resources, where the sequence of access is of potential significance;
h) use of linked-list atomic addition arrays, which may permit the efficiency of predominantly local access while supporting growth of concurrent data stores;
i) use of multi-turn/multi-generational atomic addition arrays, to maintain the benefits of strictly local storage while supporting a large number of pending operations;
j) combining networks, to provide cascaded increments to memory access, which may help avoid the bottleneck of a single global next function;
k) use of resource representations to encode capabilities and conditions of varied computational resources in a heterogeneous computing environment, supporting an efficient allocation of codeletsets and execution tasks within the heterogeneous computing environment; and/or
l) use of tasks or polytasks to improve the performance of legacy routines or applications by replacing existing library calls with Codeletset implementations or refactoring existing applications to provide increased use of Codeletset implementations.

Various concepts and aspects of embodiments of the invention are described in the following with references to the drawings. Note that in the description that follows, the steps and ordering of steps is given for the purpose of illustration, but many other orderings, subsets, and supersets will become obvious to the practitioner after exposure to the instant invention. The goal of brevity precludes enumerating every combination of steps that falls within the legitimate scope of the invention.

### System Utilization and Management Overview:

In embodiments of the invention, such as those studied in the following in greater detail, the codeletset execution model may pervade all levels of system utilization and monitoring. At a fine-grained level, the execution model may provide a series of codelets and their respective dependencies. The fine-grained nature of codelets may allow the runtime system to allocate resources efficiently and dynamically while monitoring performance and power consumption and making or enabling schedule changes to meet the performance and power demands of the application.

The Codeletset system may allocate available resources to a given application and may provide an API to access off-chip resources such as disks, peripherals, other nodes' memory, etc. The domain of the application (i.e., the nodes that are useable by the application) may be defined by the hypervisor.

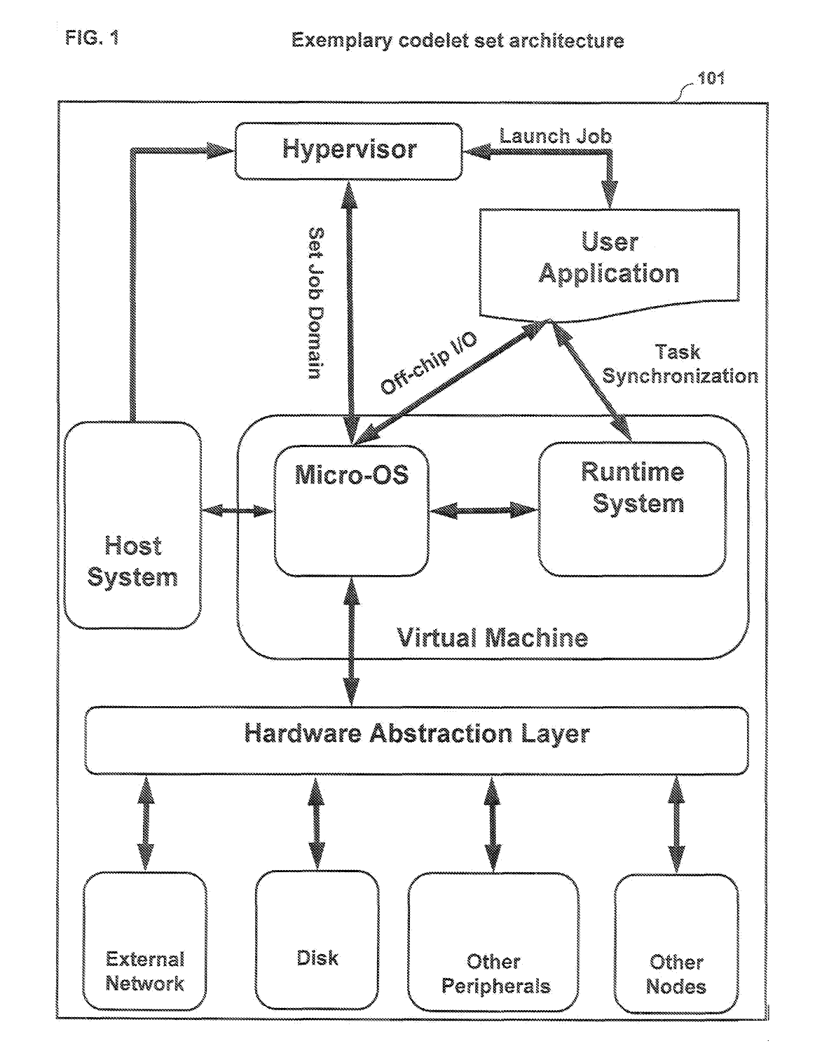

In a system 101 according to an embodiment of the invention, as illustrated in FIG. 1, there are five components that may be used for system utilization and management: (1) a traditional operating system (OS) for shared long-term file systems and/or application launch, (2) a hypervisor to control system resource allocation at a coarse level, (3) a microOS to manage off-chip resources, (4) a runtime system to provide task synchronization and manage energy consumption and performance, and (5) a hardware abstraction layer to provide portability of the microOS and allow access to new peripherals. According to such embodiments, a Thread Virtual Machine (TVM) may take the place of a conventional OS to provide direct access to the hardware and fine grained synchronization between the codelets. TVM is not herein considered to be a separate component, but rather it is considered to be implemented by the runtime system and microOS. FIG. 1 outlines the overall interactions between the components.

### Hvpervisor:

The hypervisor may allocate global resources for the given application based on the user's parameters and, optionally, parameters specified in the application. This may include how many nodes should be used and, in certain embodiments, the connectedness of the nodes. The hypervisor may set the application domain and may define the microOS running on each node. Then, the hypervisor may load application specific parameters (such as command line arguments, environment variables, etc.) and may instruct the runtime system to launch the application. The runtime system may begin the user application by launching one or more codelets on one or more cores, starting at the main program start pointer. The user application can request more codelets to be spawned at runtime. Additionally, the user application may interact directly with the runtime system for task synchronization. All off-chip I/O may be mediated by the microOS, which may serialize requests and responses for passage through serial conduits (such as disk 110, Ethernet, node-to-node communication, etc). Additionally, the microOS may facilitate the runtime system in communicating between nodes to other runtime system components. The hardware abstraction layer may provide a common API for microOS portability to other platforms and/or for the discovery of new peripherals.

The next paragraphs outline the overall structure and functionality of the different components involved in system utilization and maintenance.

### Thread Virtual Machine (TVM):

TVM may provide a framework to divide work into small, non-preemptive blocks called codelets and schedule them efficiently at runtime. TVM may replace the OS with a thin layer of system software that may be able to interface directly with the hardware and may generally shield the application programmer from the complexity of the architecture. Unlike a conventional OS, TVM may expose resources that may be critical to achieve performance.

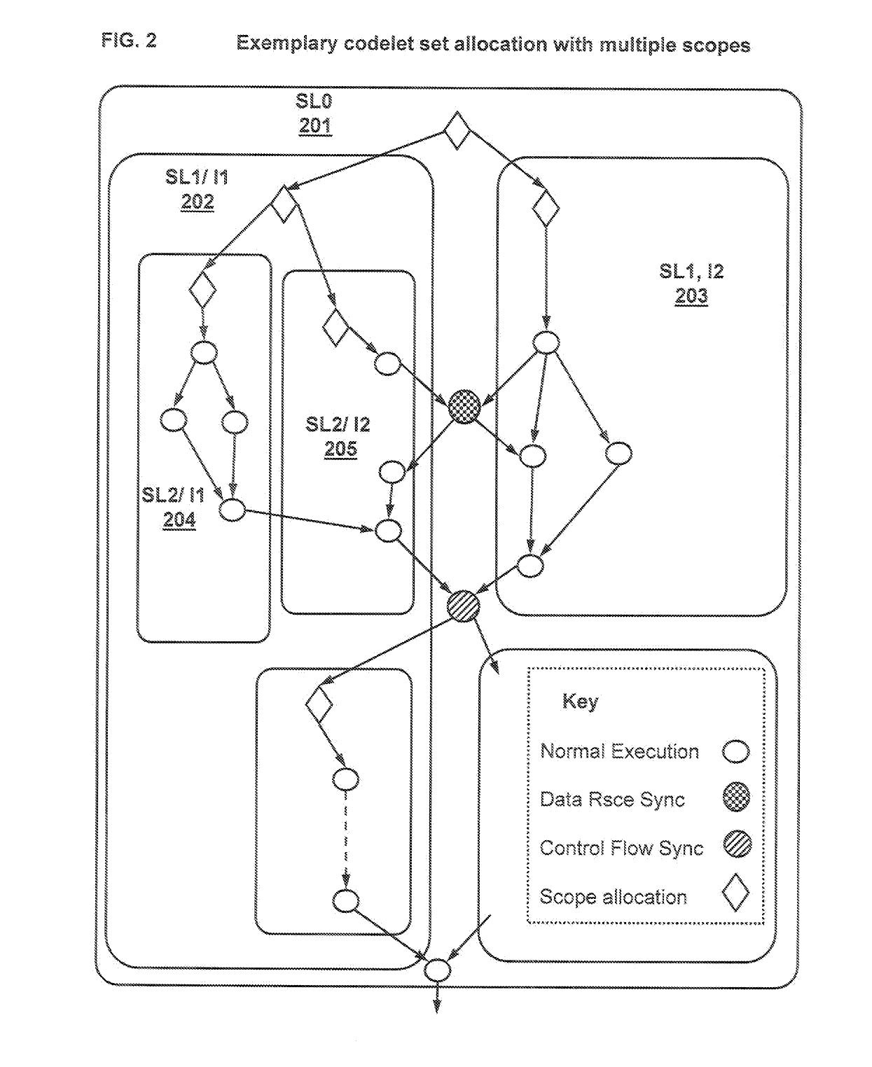

An embodiment of TVM is illustrated in FIG. 2. TVM may abstract any control flow, data dependencies, or synchronization conditions into a unified Data Acyclic Graph (DAG), which the runtime system can break down into codelet mechanisms. On top of this DAG, TVM may also superimpose an additional DAG that may express the locality of the program using the concept of scope. In embodiments of the invention, codelets can access any variables or state built at a parent level (e.g., 201), but siblings (e.g., 202 and 203 or 204 and 205) cannot access each others' memory space. Using this scope, the compiler and runtime can determine the appropriate working set and available concurrency for a given graph, allowing the runtime system to schedule resources to both the execution of codelets and the percolation of system state or scope variables using power optimizing models to set affinity and load balancing characteristics.

Unlike a conventional OS framework, the TVM may maintain the fractally semantic structure and may give scheduling and percolating control to the runtime system to efficiently perform the task. And by following this fractal nature, the enabled programming model may be able to provide substantial information to the runtime system. Thus, unlike monolithic threads with an unpredictable and unsophisticated caching mechanism, the granularity and runtime overhead may be managed as tightly as possible in both a static and dynamic nature to provide greater power efficiency.

### Runtime System:

The runtime system may be implemented in software as a user library and in hardware by a runtime system core to service a number of worker cores. This runtime system core can be different from the worker cores or can have special hardware to facilitate more efficient runtime operations.

Configuring and executing a dynamic runtime system according to embodiments of the invention may involve methods for efficiently allocating data processing resources to data processing tasks. Such methods may involve, at compile time, analyzing potential code and data allocations, placements and migrations, and at run time, placing or migrating codelets or data to exercise opportunities presented by actual code and data allocations, as well as, in certain embodiments, making copies of at least some data from one locale to another in anticipation of migrating one or more codelets, and moving codelets to otherwise underutilized processors.

Embodiments of the invention may involve a data processing system comprised of hardware and software that can efficiently locate a set of codelets in the system. Elements of such systems may include a digital hardware- or software-based means for (i) exchanging information among a set of processing resources in the system regarding metrics relevant to efficient placement of the set of codelets among the processing resources, (ii) determining to which of the processing resources to locate one or more codelets among said set, and (iii) mapping the one or more codelets to one or more processing resources according to said determining. In various embodiments the mappings may involve data and/or codelet migrations that are triggered by inefficient assignments of data locality. In certain scenarios, volumes codelets and data are migrated, according to the cost of migration. In some embodiments, migration cost drivers may include one or more of the following: the amount of data or code to be migrated, the distance of migration, overhead of synchronization, memory bandwidth utilization and availability.

The runtime system can use compile-time annotations or annotations from current or previous executions that specify efficient environments for codelets. Related methods in embodiments of the invention may involve compiling and running a computer program with a goal of seeking maximally resource-efficient program execution. Such methods, at a program compile-time, may determine efficient execution environments for portions of program referred to as codelets, and accordingly, at a program run-time, may locate codelets for execution at respective efficient execution environments. Furthermore, in certain embodiments, the determining of optimal environments may be done based on indications in program source code such as, for example: (i) compiler directives, (ii) function calls, wherein a type of function called may provide information regarding an optimal execution environment for said function, and/or (iii) loop bodies that may have certain characteristics such as stride, working set, floating point usage, wherein the optimal execution environment has been previously determined by systematic runs of similar loops on similar data processing platforms. The efficient execution environment for the execution of a given codelet can be defined by criteria such as, for example: power consumption, processing hardware resource usage, completion time, and/or shortest completion time for a given power consumption budget.

### Internal Hardware/Software Runtime Stack:

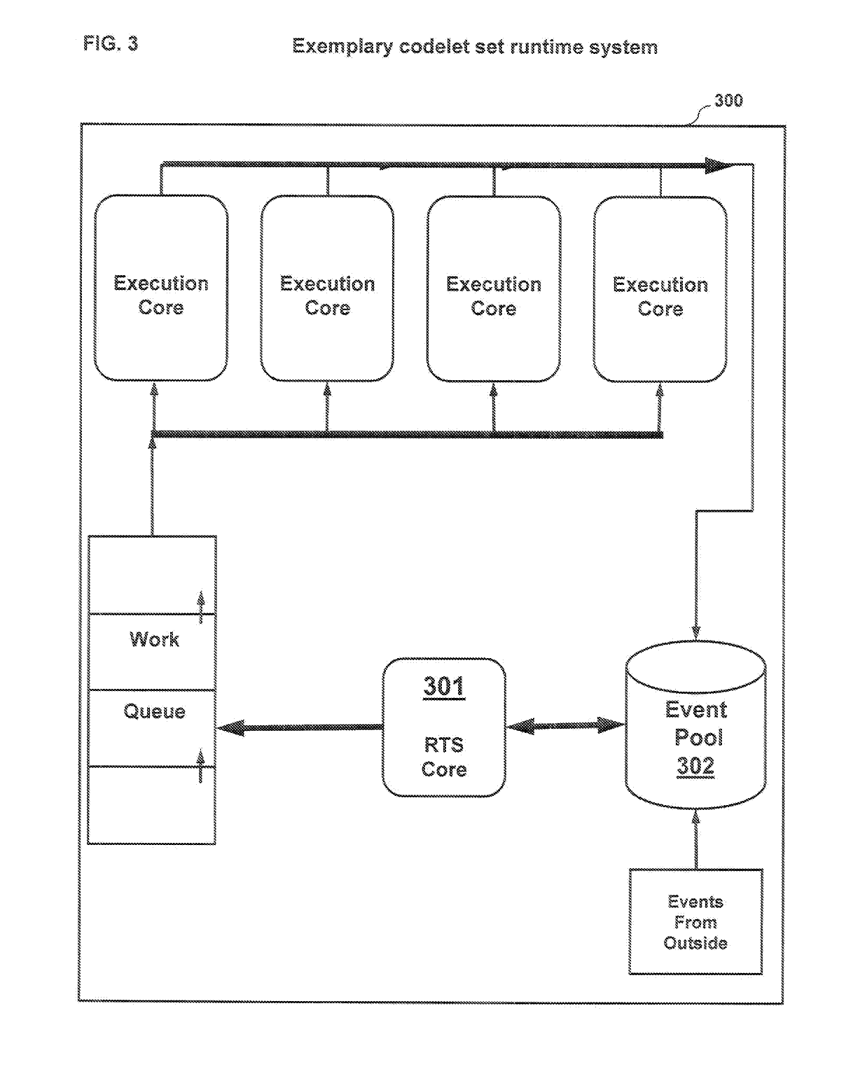

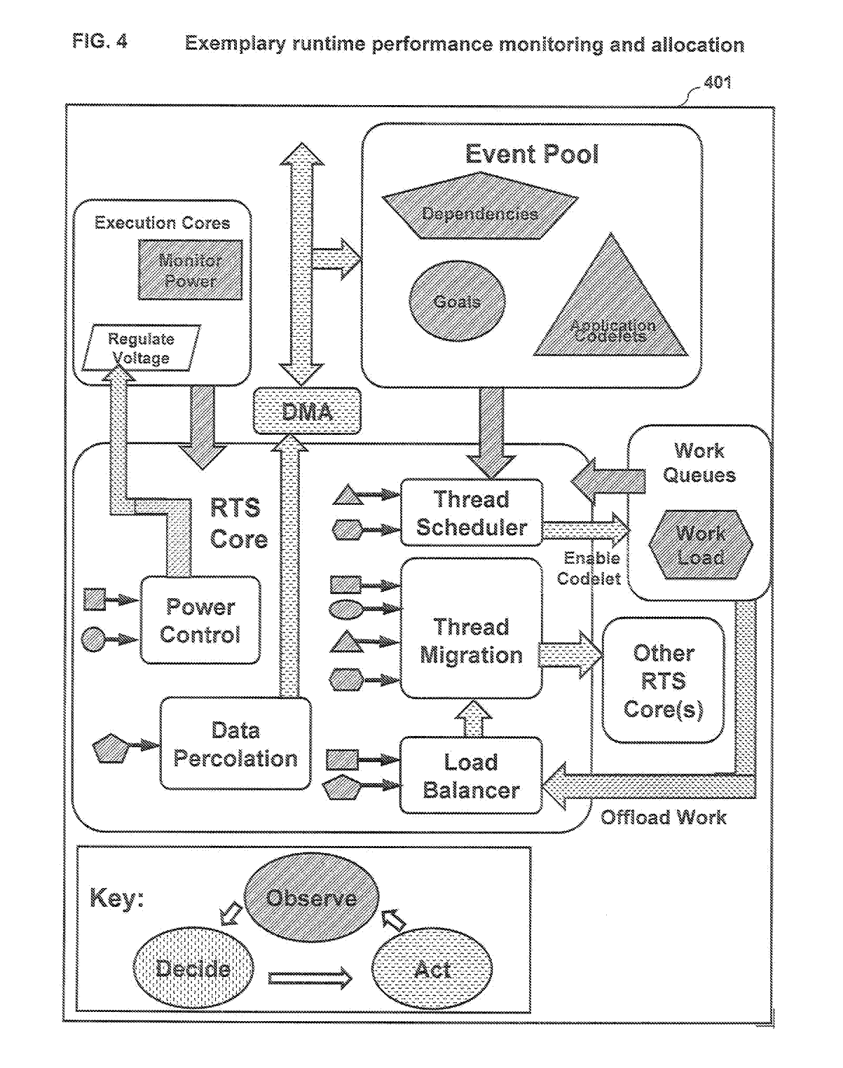

In embodiments of the invention, such as the system 300 illustrated in FIG. 3, the runtime system core 301 may be collocated with an event pool storage 302. The event pool 302 may contain fine-grain codelets to run, application and system goals (such as performance or power targets) and data availability events. The event pool 302 may be an actual shared data structure, such as a list, or a distributed structure, such as a system of callbacks to call when resource utilization changes (such as when a queue has free space, a processing element is available for work, or a mutex lock is available). The runtime system core 301 may respond to events in the event pool 302. According to embodiments of the invention, there may be five managers running on the runtime system core 301: (1) data percolation manager, (2) codelet scheduler, (3) codeletset migration manager, (4) load balancer and (5) runtime performance monitor/regulator. In certain embodiments, these managers may work synergistically by operating in close proximity and sharing runtime state. The inputs, outputs, and interactions 401 of the managers running on the runtime system core 301 of one exemplary embodiment are depicted in FIG. 4. When it deems appropriate, the data percolation manager may percolate data dependencies (i.e., prefetch input data, when available) and/or code dependencies (i.e., prefetch instruction cache). When all input dependencies are met, the codelet scheduler may place the codelet in the work queue, in certain scenarios reordering the priority of the ready codelets in the queue. Worker cores may repeatedly take tasks from the work queue and run them to completion. In the process of running a codelet, an execution core may create codelets or threads and place them in the event pool. The runtime performance monitor/regulator monitors power and performance of the execution cores and can make adjustments to decrease power (e.g., scale down frequency and/or voltage of cores, turn off cores, or migrate some or all work from the work queues to other domains of computation on the chip and turn off cores) or increase performance (e.g., scale up frequency and/or voltage, turn on cores, recruit more work from other computational domains or turn on different computational domains and join them to the application). The load balancer may analyze the work queue and event pool and may determine if work should be done locally (i.e., in this computational domain) or migrated elsewhere. The codelet migration manager may work with other runtime system cores on the node and/or on remote nodes to find an optimal destination for a set of codelets and may migrate them appropriately. Codelet migration may also be triggered by poor data locality: if many codelets in a codeletset request data located on another node, it may be better to relocate the code than to relocate the data.

These managers may also communicate together in a synergistic manner to attain goals that have mutual interest, e.g., a minimum completion time for given power consumption budget, etc. For example, if the performance manager wants to throttle power down, and the load balancer wants to migrate more work locally, having the two managers collocated on an RTS core means they may be able to communicate the best course of action for both their goals simultaneously and make quick, decisive actions. Thus, these subsystems may provide a control architecture that may build an internal model of performance and may attain set points based on the Generalized Actor (GACT) goals. An objective of the system may be, for example, to provide the highest performance for the least power consumption in an energy-proportional manner bounded by the GACT constraints. In embodiments of the invention, these functions may rely on the runtime system cores to asynchronously communicate with a master runtime system core by sending load and power indicators and receiving goal targets. The master runtime system core may monitor the overall performance/power profile of a given application on the chip and may tune the performance (which may include frequency, voltage, and on/off state of individual cores) of each computational domain appropriately.

The master runtime system core of each node allocated to an application may asynchronously communicate with the master runtime system core of a so-called head node for the application and may exchange performance metrics and goal targets, such as time to completion, power consumption, and maximum resource constraints (e.g., memory space, nodes, network links, etc). The hierarchical and fractal regulation structure of the runtime system hardware may reflect the hierarchical nature of the execution model. Collectively, the master runtime system cores of the nodes running an application may perform hypervisor tasks, as described further below. Runtime systems may communicate with each other and may provide feedback (e.g., the local runtime core may determine that workload is low, may tell the master runtime core, and may receive more work) such that the system as a whole is self-aware.

In an embodiment of a self-aware operating system, a fractal hierarchical network of monitoring domains may achieve regulation of a data processing system. For example, in a basic cluster, domains may be: cluster, node, socket, core, hardware thread. A process (which may be the scheduler) at each leaf domain may monitor the health of the hardware and the application (e.g., power consumption, load, progress of program completion, etc). Monitors at higher levels in the hierarchy may aggregate the information from their child domains (and may optionally add information at their domain—or may require that all monitoring is done by children) and may pass information up to their parents. When a component of the hardware fails, it may be reported up the chain. Any level in the hierarchy can choose to restart codelets that ran on the failed hardware, or they may be passed up the chain. Once a level chooses to restart the codelets, it can delegate the task down to its children for execution. Enabled codelets can also be migrated in this way. If a level finds that its queues are getting too full or that it is consuming too much power, it can migrate enabled codelets in the same way as described above. Finally, if a level finds that it has too little work, it can request work from its parent, and this request can go up the chain until a suitable donor can be found.

### Runtime System User API:

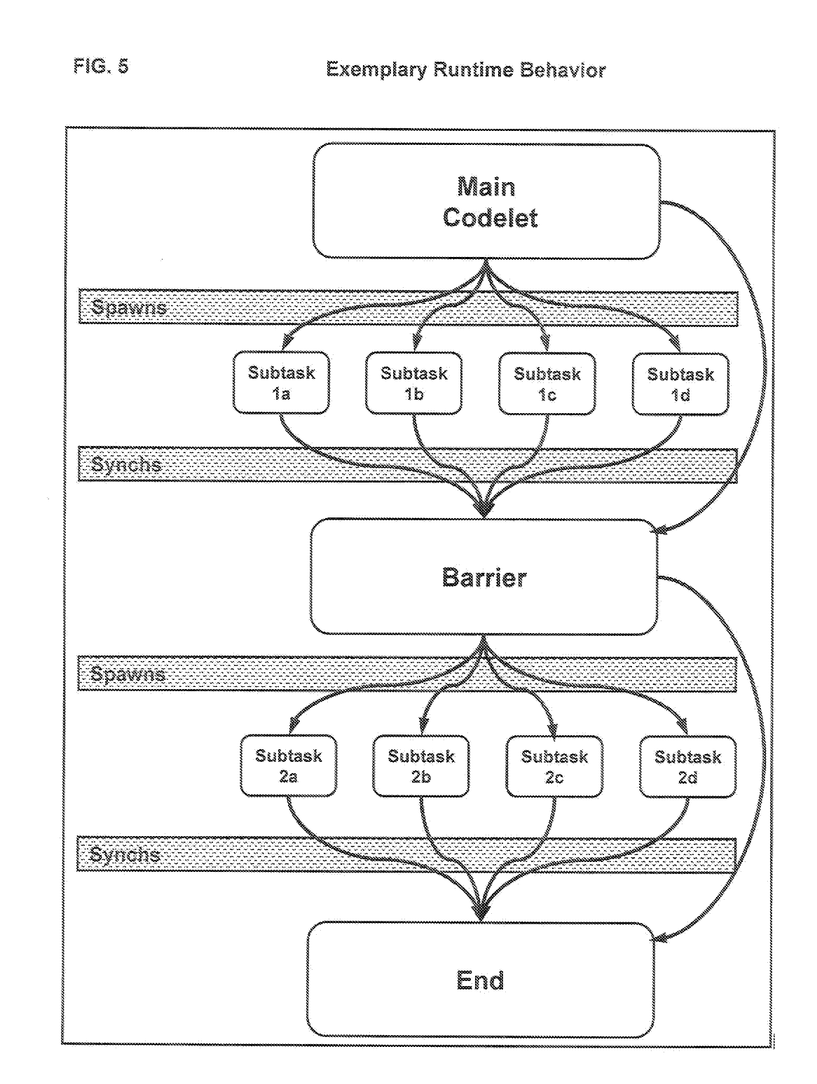

Codelets can create additional codelets by calling runtime library calls to define data dependencies, arguments, and program counters of additional codelets. Synchronization can be achieved through data dependence or control dependence. For example, a barrier may be implemented by spawning codelets that depend on a variable's equality with the number of actors participating in the barrier (see FIG. 5). Each of the participating codelets may atomically add one to the barrier variable. Mutexes can be implemented in a similar manner: a codelet with a critical section may use a mutex lock acquisition as a data dependence and may release the lock when complete. However, if the critical section is short, in certain scenarios (e.g., in the absence of deadlock and when the lock is in spatially local memory) it may be more productive for the core to just wait for the lock. Finally, atomic operations in memory (managed by the local memory controller) may allow many types of implicit non-blocking synchronizations, such as compare and swap for queue entry and atomic add for increment/decrement.

### MicroOS:

MicroOS may provide off-node resources and security at the node boundary. In an embodiment of the invention, the microOS may have two components: (1) special codelets that may run on worker cores; and (2) library functions that user codelets may call via system calls (syscalls). The special codelets may be used for event-based, interrupt-driven execution or asynchronous polling of serial devices and placement of the data into queues. Typical devices may include Ethernet, ports of a switch connecting this node to other nodes, and other sources of unsolicited input (for example, but not limited to, asynchronous responses from disk-I/O). Additionally, a codelet may be reserved for timing events such as retransmit operations on reliable communication protocols such as TCP/IP. These codelets may analyze the sender and receiver to ensure that the specific sources belonging to the application that owns the node are allowed to access resources on the node or resources dedicated to the application (such as scratch space on the disk). Accesses to shared resources (such as the global file system) may be authenticated through means such as user, group, role, or capability access levels.

Library functions may allow the user application to access hardware directly without intervention or extra scheduling. Some of these functions can be implemented directly in hardware (e.g., LAN, node-to-node, or disk writes). Others may use lower level support for directly sending and/or receiving data via buffers from asynchronous input polling threads, such as requesting disk access from another node. The library calls may direct the user to access data allocated to its application. The user or the system library can specify whether to block waiting for a response (e.g., “we know it's coming back soon”) or may schedule a codelet to run with a data dependence on the result.

The library functions may be designed to be energy-efficient and hide latency by being tightly coupled with the runtime system. For example, a codelet that calls a file-system read may make the file-system request, create a codelet to process the response that has a data dependency on the file system response, and exit. This may allow the worker core to work on other codelets while the data is in transit (instead of sitting in an I/O wait state). If there is not enough concurrency, the runtime system can turn off cores or tune down the frequency of cores to allow for slower computation in the face of long latency read operations.

Embodiments of the invention may provide security in two modes: high performance computing (HPC) mode, where entire nodes are owned by one application; and non-HPC mode, where multiple applications can co-exist on one node. In HPC mode, it may generally be sufficient that security is performed at the node boundary (i.e., on-chip accesses may not be checked except for kernel/user memory spaces and read-only memory). It may also be sufficient for user applications to know the logical mapping of nodes in their application (i.e., node 0 through N−1, where N is the number of nodes in the application). The microOS may know the physical mapping of node IDs to the logical node IDs and may re-write the addresses as appropriate. Also, when the microOS obtains input from outside the node boundary, it may verify that the data is for that node. Thus, on-chip security may encompass protecting the kernel code from the user code and protecting the user's read-only memory from writing. In non-HPC mode, the microOS may allow the node to communicate with outside peripherals but generally not with other nodes. Input may be validated in the same way. Further security may be performed by the hardware as configured by the hypervisor as described in the hypervisor section. Security can be performed at a coarse grain application level, or at a fine grain codelet level. At the codelet level, because the data dependencies and the size of the data blocks are known at runtime, the security can be guaranteed by hardware by using guarded pointers (like those used on the M-machine) or by software using invalid pages or canaries (used in ProPolice or StackGuard) around data objects.

### Hypervisor:

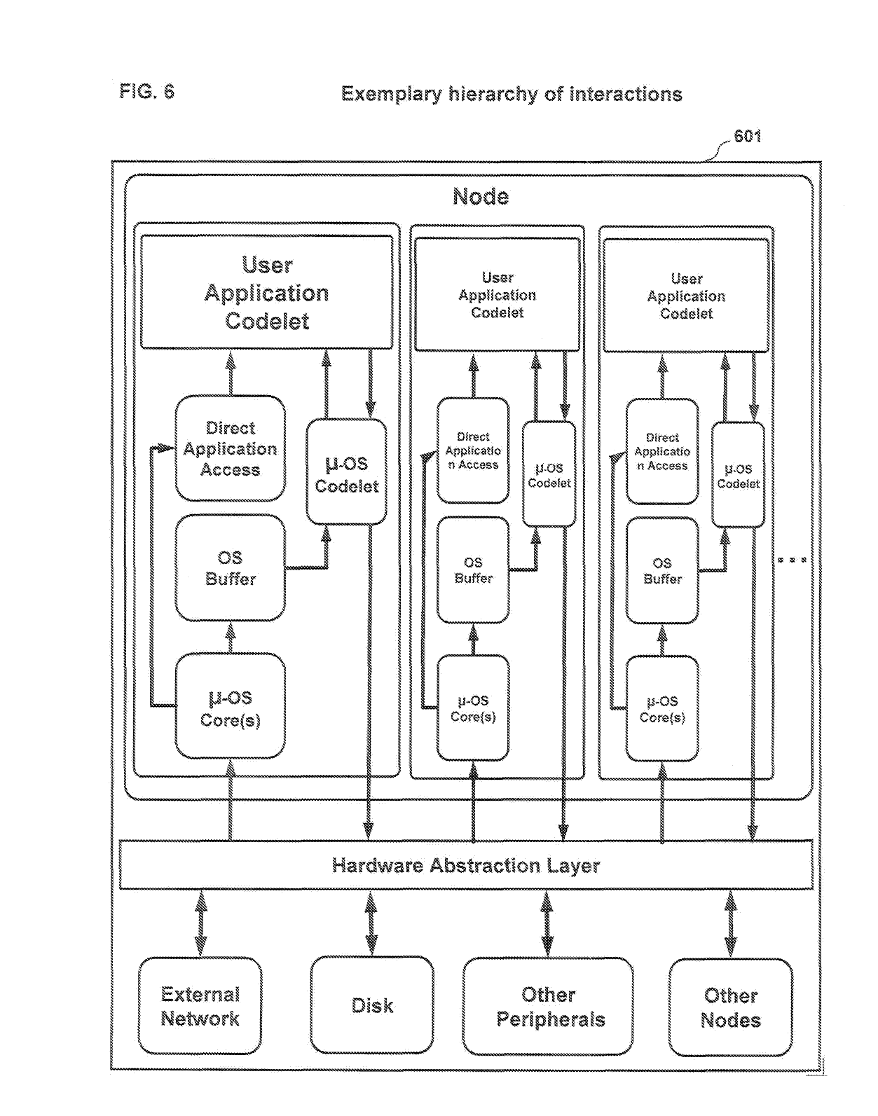

The hypervisor may generally be in charge of allocating resources to a user application. In embodiments of the invention, it may physically reside on all nodes and partially on the host system. One or more codeletsets on each chip may be made available to hypervisor functions. They may reside in runtime system cores and execution cores and may generally follow the same fine-grained execution model as the rest of the system. Embodiments of the hypervisor on the host-software may maintain a state of all resources allocated to all applications in the system. When launching an application, the Generalized Actor (GACT) can specify a set of execution environment variables such as the number of nodes and power and performance targets. The hypervisor may place the application in the system and may allocate resources such that the nodes within the application space are contiguous and may match the GACT's application request. Once a set of nodes are allocated, the host hypervisor may communicate to the hypervisor instance on each of the nodes to allocate the nodes, pass the application code image and user environment (including power and performance targets, if any), and signal the runtime system to start the application. The hypervisor may notify the microOS and runtime system of the resources allocated to the application. Then, the hypervisor instance on a given node may monitor the application performance and may work with the other hypervisor instances on other nodes allocated to the application and/or the runtime system cores to achieve the power/performance targets, e.g., by managing the relationship of power, performance, security, and resiliency to maintain an energy proportional runtime power budget (see FIG. 6 for hierarchy 601 of overall system, hypervisor, and runtime system interactions). The micro OS threads and library may provide security of the application data and environment on all nodes allocated to the application.

In non-HPC mode, where multiple applications can coexist on one node, the hypervisor may create computational domains from sets of cores. Memory, such as random-access memory (RAM), may be segmented for each application, and user applications may generally not write into each other's dynamic RAM (DRAM) or on-chip static RAM (SRAM). This can be accomplished with a basic Memory Management Unit (MMU) for power efficiency or a generalized virtual memory manager (VMM) on legacy machines. The hypervisor may determine the address prefix and size of each segment during the application boot phase, and the application addresses can be rewritten on the fly by the MMU. Generally, the addresses that map to the application's memory space can be accessed in this manner.

### Hardware Abstraction Layer:

The hardware abstraction layer (HAL) may allow the microOS and user application to query the hardware device availability and interact with hardware in a uniform way. Devices can be execution cores, disks, network interfaces, other nodes, etc. Much of the system can be accessed by the user application via file descriptors. MicroOS library function calls, such as open, read, write, and close, may provide a basic hardware abstraction layer for the application. A driver may interact with the HAL with a series of memory reads and writes. The HAL implementation may translate these requests into the bus transactions relevant to the hardware platform. This may allow users to reuse driver code on different underlying platforms.

Additionally, an application can query the hardware or runtime system for the number of nodes available to the application, number of execution cores in a chip and memory availability, to help decide how to partition the problem. For example, if one thousand cores exist, the application can divide a loop of one million iterations into one thousand iteration codelets, whereas if there are only four cores, it could divide the work into coarser grained blocks because there is no more concurrency to be gained from the hardware and the overhead of fewer codelets is lower. In various embodiments, the optimal size of blocks can be, for instance, (1) a rounded integer quotient of the maximum number of units of work that could be done in parallel divided by the quantity of processing elements available to the application, (2) a varying size between blocks such that the maximal difference between the smallest and largest block size is minimized, or (3) a maximum size that allows completing the segment of the application in provided time budget while staying within a provided power consumption budget.

### Self-Optimizing Operating System:

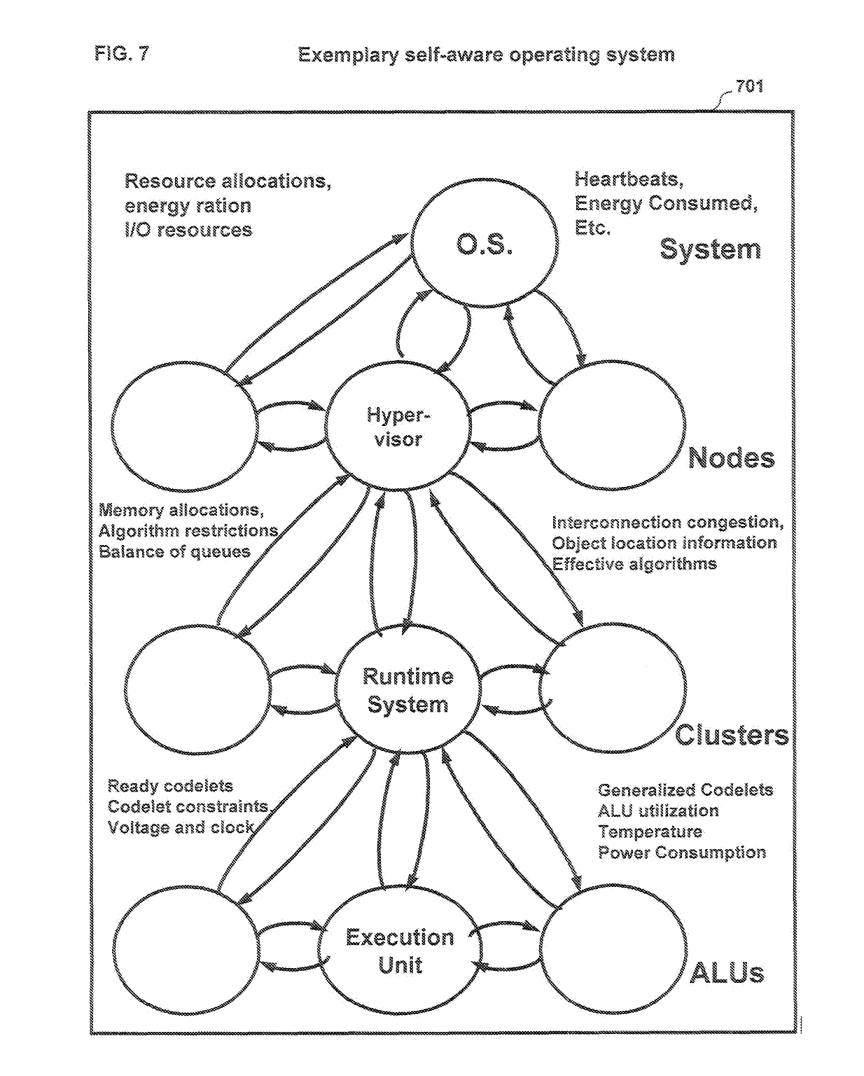

The operating system services may be performed by the microOS and the runtime system and may be regulated through the hypervisor. Together, these components make up the exemplary self-aware operating system 701, as illustrated in an embodiment shown in FIG. 7. The self-optimizing nature of the runtime system may be realized by: (1) the self-aware features of the execution systems; (2) the self-aware features of the OS; and (3) the interactions between (1) and (2). As illustrated in FIG. 7, the OS, hypervisor, runtime system, and execution units may communicate with each other and their neighboring levels to provide a feedback observe-decide-control loop.

In this section an embodiment of a self-optimizing system model 701 is described.
a) The self-optimizing loop embedded in the execution systems: An embodiment of the execution model may feature two types of codelets: asynchronous tasks and dataflow codelets. In both types, the invoking of corresponding codelet activities may be event-driven. At least in the case of asynchronous tasks, invocation of codelets may additionally depend on computational load, energy consumption, error rate, or other conditions on a particular physical domain to which the tasks may be allocated. Self-optimization can also be applied to performance-aware monitoring and adaptation.
b) The self-optimizing loop embedded in the operating system: The self-optimizing OS may observe itself, reflect on its behavior, and adapt. It may be goal-oriented; ideally, it may be sufficient for the system's client to specify a goal, and it may then be the system's job to figure out how to achieve the goal. To support such self-optimizing functionality, the OS observer-agents (i.e., the runtime system cores and hypervisors) may be in embodiments equipped with a performance monitoring facility that can be programmed to observe all aspects of program execution and system resource utilization and an energy efficiency monitoring facility that can observe system power assumption at the requests of the OS at different time intervals or specific locations/domains.

In various embodiments, the OS decision-agent (the code running on the runtime system cores) may be equipped with appropriate model builders and learning capabilities so it can take timely and effective actions for self-correction and adaptation to meet the goals. In some embodiments, the OS self-optimizing loop may invoke control theory methods to achieve its objectives. Interactions between (1) and (2) are illustrated in FIG. 7: the control loop in OS and control loops in various execution systems may be connected. The OS control loops can make inquiries to the execution systems regarding their running status, resource usage, energy efficiency and error states, in order to make informed decisions for performing system level global control and adjustments. At the same time, each individual execution system can ask the OS for help to resolve the problems in its own control that can be more efficiently resolved with help at the OS level.

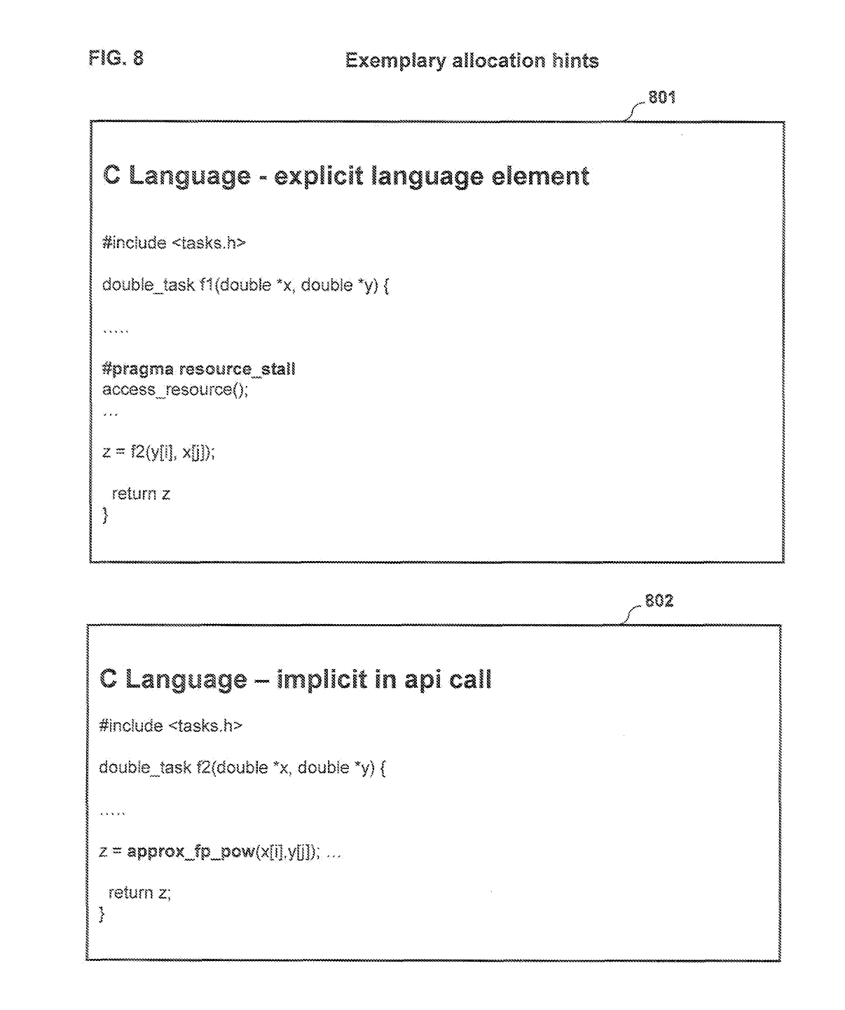

To effectively use the codeletset systems and methods, application developers can provide directives, which the system may note at compile time, and which may result in better initial static allocation, better runtime (dynamic) allocation, or both. FIG. 8 shows an explicit language element (801) in the C language, wherein the application programmer alerts the system to a “resource-stall” that might indicate that the code can be migrated to a very low-power, slow execution unit. Reference 802 shows an implicit directive: a special API call that uses a low-fidelity floating point calculation. Such calculations can be carried out inexpensively on floating point processing units with very few mantissa bits, which may allow for greater specialization, and thus better matching of capability to demands, within the computing domains of the system. These are some examples of user-specified directives that the runtime can use to make dynamic decisions, to which the invention is not limited. In addition, applications can be profiled and annotated with directives so that the runtime can make better dynamic decisions in subsequent runs based on the hints provided by the annotations.

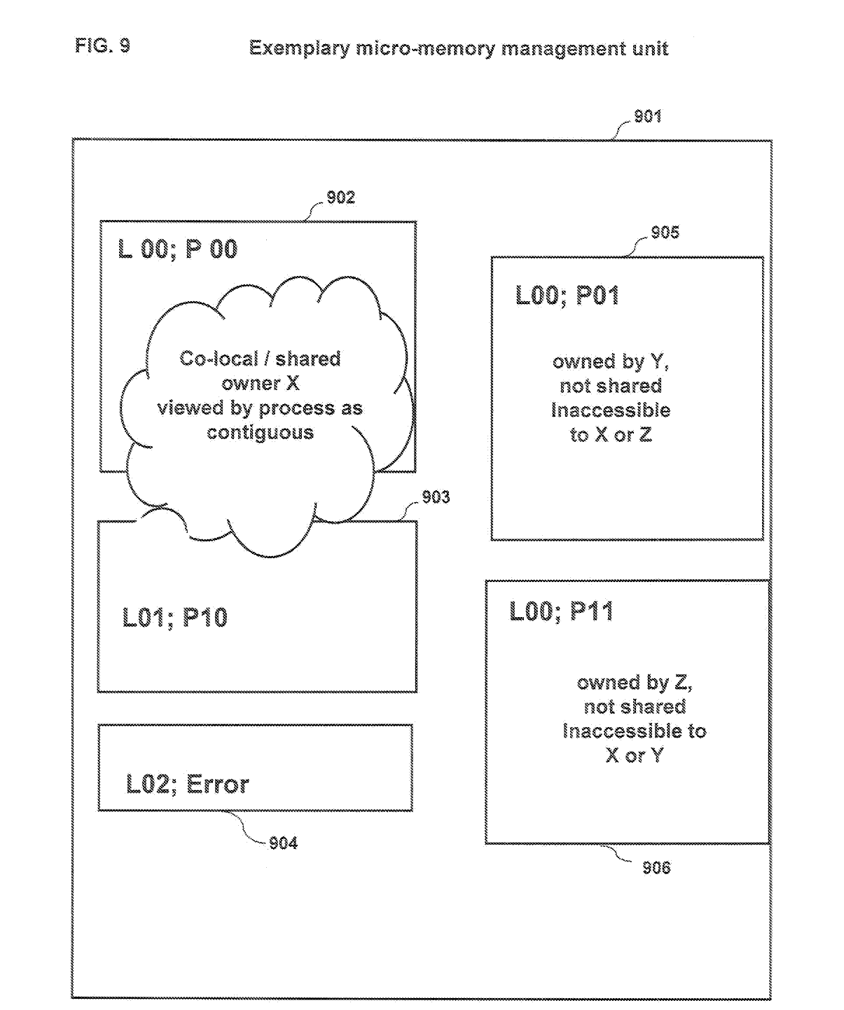

An exemplary micro-memory management unit is illustrated in FIG. 9. Ref. 901 is a processing unit, with local code execution and four local physical memory blocks. Refs. 902 and 903 are two memory blocks owned by the same controlling task, owner X, and accessible to codelets associated with that task. 902 has logical address 00 and physical address 00, while 903 has physical address 10, and logical address L01. Ref. 904 shows how a memory access beyond L01 would appear to codelets owned by X. That is, in this example, any local logical address beyond L02 appears as an error to codelets owned by X. Ref. 905 shows a memory segment residing at physical location 01, which appears logically to codelets owned by Y as L00. All other local physical memory is inaccessible to Y codelets. Ref. 906 shows a memory segment residing at physical location 11, which appears logically to codelets owned by Z as L00. All other local physical memory is inaccessible to Z codelets.

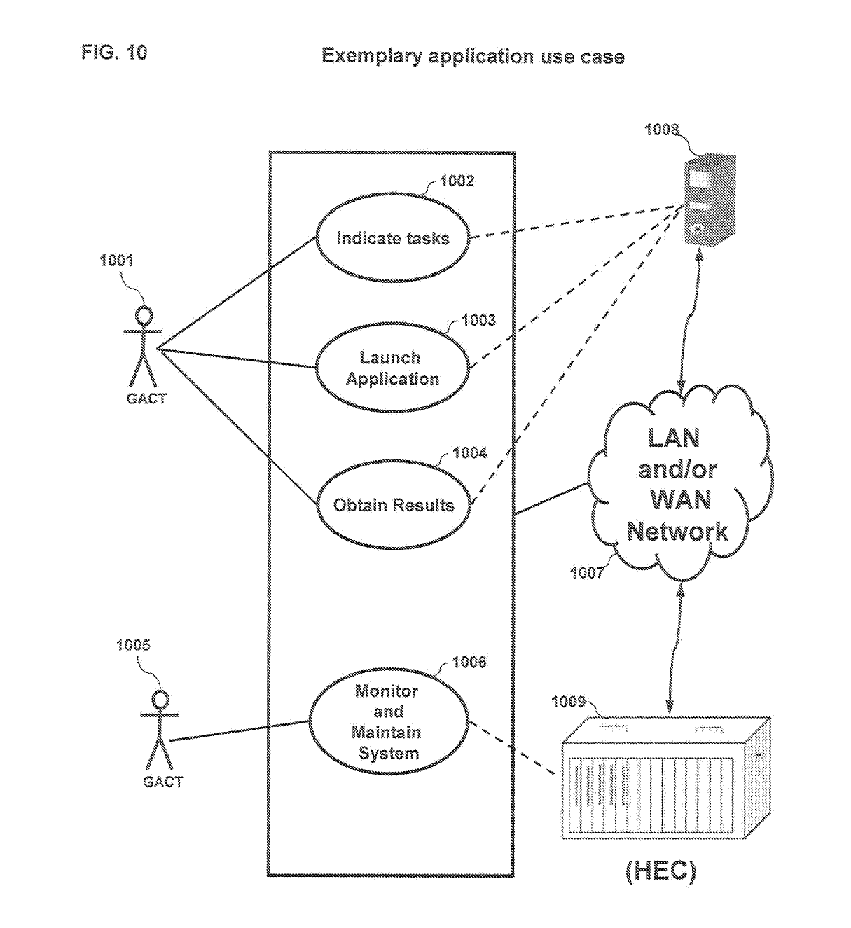

FIG. 10 illustrates a simple use case involving the codeletset system, wherein a generalized agent 1001 may indicate tasks (e.g., by compiling source code), launch an application 1003, and obtain results 1004. Concurrently, another GACT, 1005 may perform monitoring and system maintenance 1006. In a typical environment, the codeletset system may be available via Local Area Network (LAN) and/or Wide Area Network (WAN) 1007 and may proceed by interaction with a conventional front end server 1008, which may communicate with a High End Computer (HEC) 1009.

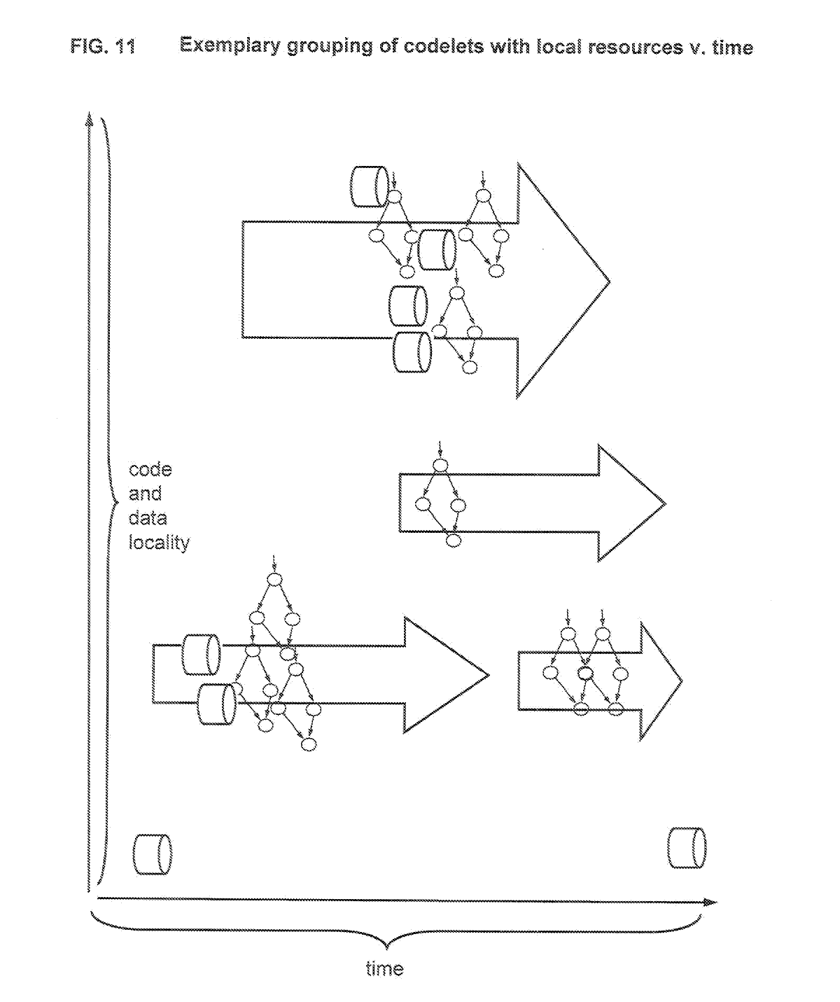

FIG. 11 illustrates an example of code and data locality that may be observed in codeletset, with allocation of codelets and data over time. Additional attributes of codeletset can include peripheral resource demands or allocation, processor operating envelope and constraints, task urgency or deferability, etc. The codeletset system may use a metric space distance model to initially allocate code and data to appropriate local processing elements, and can migrate code and data dynamically, as may be deemed beneficial to optimize system performance with reference to the current goals. The system can use either or both of policy-driven optimization techniques for dynamic allocation and exhaustive optimization approaches at compile time. Additionally, the system can learn from past performance data to improve future allocation of particular codelets, subroutines, tasks, and applications.

### Cross-Cutting Interactions:

Execution model: The runtime system and microOS may manage, migrate, and spawn codelets. They may choose the codelet versions to run according to the runtime goals. As described above, the runtime system core may manage the data dependencies between codelets, migrating data and codelets together and spawning the correct codelet version based on runtime constraints. Dependability may be viewed as a combination of security and resilience. Security aspects of the invention, according embodiments, may involve providing security markings for codelets, where marking may be used to indicate restrictions or privileges to be considered in allocations of codelets in question and their related data. Accesses of memory outside of the data bounds or prescribed privileges may result in a security exception to be handled by the runtime system. In HPC mode, a node may be completely owned by an application. Security may be provided at the core level by the user/kernel space memory and instruction set enforcement. Security is provided at the application level by the host system, which may define the set of nodes on which the application runs, and/or the hypervisor, which may relay that information to the microOS running on the allocated nodes. Security may be provided at the system level by a job manager on the host system, which may schedule and allocate nodes to applications in a mutually exclusive manner. In non-HPC mode, the system may be further subdivided into mutually exclusive chip domains and memory segments, and memory and resources may be mapped in such a way as to prevent applications from accessing each other's data on the same chip.

Resilience may be maintained by fractally monitoring the health of the system and re-executing codelets that fail. The local runtime core in a computational domain may monitor the worker core health. A node-level runtime core may monitor the runtime cores. The node-level runtime core may be monitored by the host system. When a component fails, the codelets running on the core may either be restarted (if they created no state change in the program), or the application may be restarted from a checkpoint (if the state of the program is non-determinant).

The efficiency goal may be used to maximize performance and to minimize power consumption given a set of application and system goals. This may be achieved through frequency and/or voltage scaling at the execution core level based on the dependencies of the codes and the availability of work. Also, codelets and data may be migrated to where they can most effectively communicate with each other (e.g., by keeping more tightly interacting codelets together) and consume the least amount of power (e.g., moving codelets together to allow for power domain shutdown of unused clusters and eliminate idle power consumption).

Self-optimizing: Self-optimization may be maintained through the fractal monitoring network (of both health and performance) and runtime system rescheduling to achieve the goals of the application and system while maintaining dependability and efficiency.

### Description of Embodiments:

Operating examples and application scenarios of embodiments of the invention are described in the following with further references to the drawings.

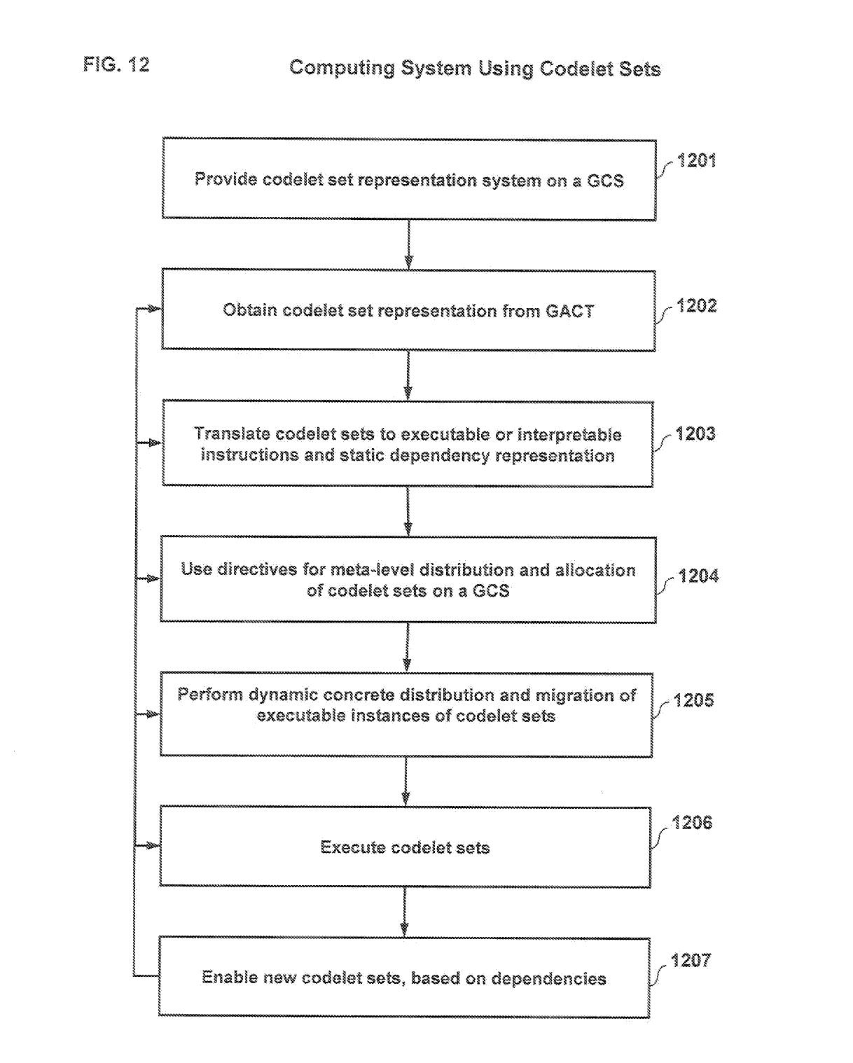

FIG. 12 illustrates an exemplary computing system using codeletsets. The system may include: 1201 providing codeletset representation system on a GCS; 1202 obtaining codeletset representation from GACT; 1203 translating codeletsets to executable or interpretable instructions and dependency representation; 1204 using directives for meta-level distribution and allocation of codeletsets on a GCS; 1205 performing dynamic concrete distribution and migration of executable instances of codeletsets; 1206 executing codeletsets; and 1207 enabling new codeletsets, at least in part based on dependencies.

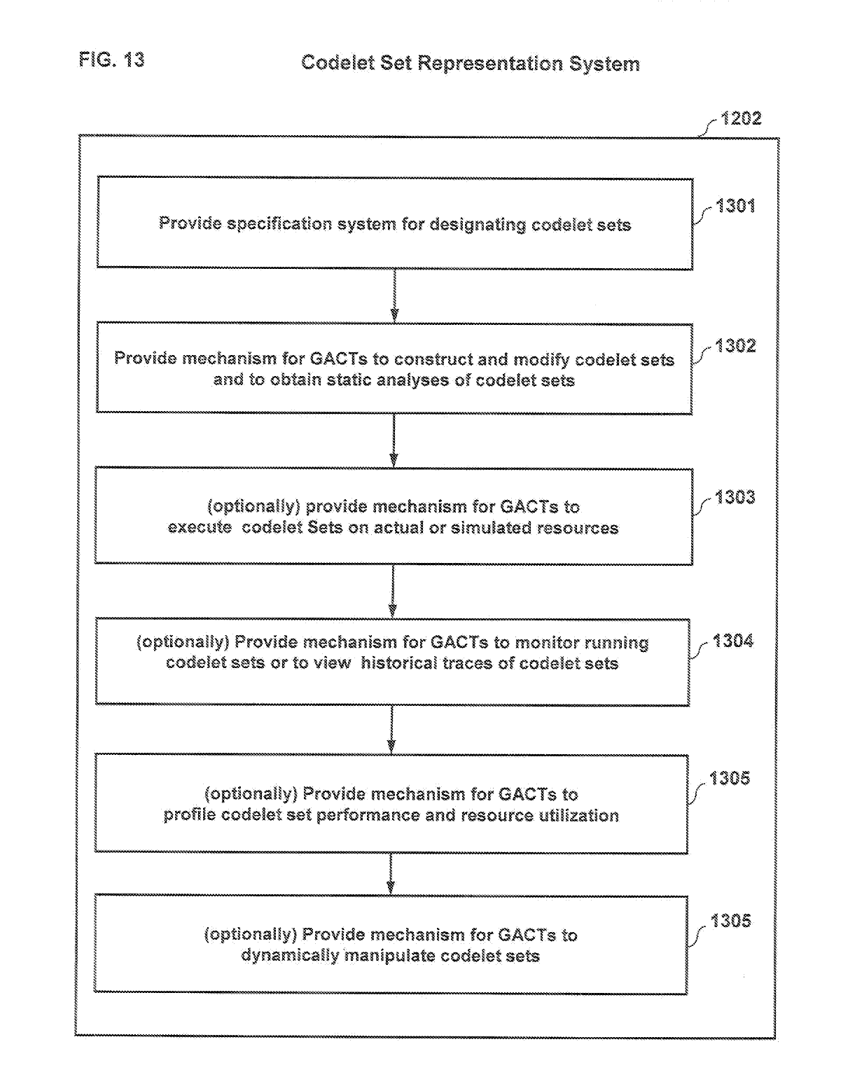

FIG. 13 shows an exemplary codeletset representation system, such as may be used to implement 1202, and which may include: 1301 providing a specification system for designating codeletsets; 1302 providing a mechanism for GACTs to construct and modify codeletsets and to obtain initial analyses of codeletsets; 1303 providing a mechanism for GACTs to execute codeletsets on actual or simulated resources; 1304 providing a mechanism for GACTs to monitor running codeletsets or to view historical traces of codeletsets; 1305 providing a mechanism for GACTs to dynamically manipulate codeletsets; and 1306 providing a mechanism for GACTs to profile codeletset performance and resource utilization.

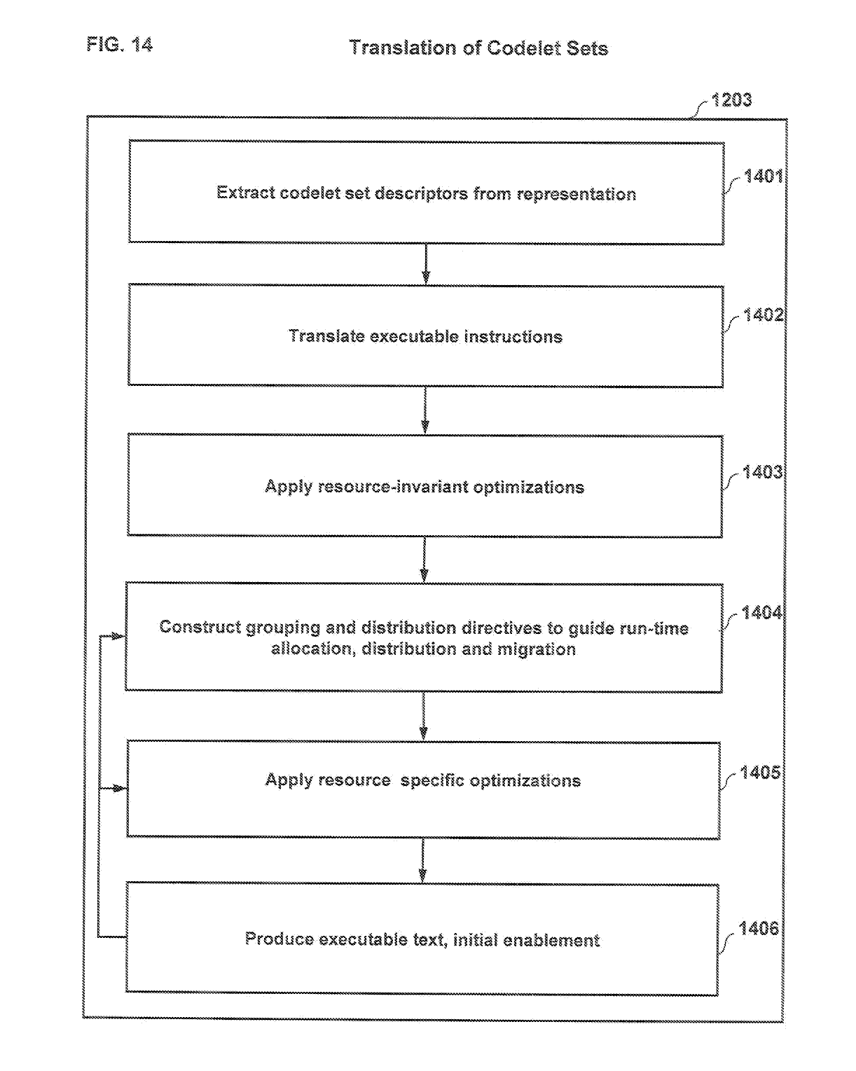

FIG. 14 shows an example of translation of codeletsets, such as may be used to implement 1203, and which may include: 1401 extracting codeletset descriptors from representation; 1402 translating executable instructions; 1403 applying resource-invariant optimizations; 1404 constructing, grouping and distributing directives to guide run-time allocation, distribution and migration; 1405 applying resource specific optimizations; and 1406 producing executable text, and enabling initial codelets.

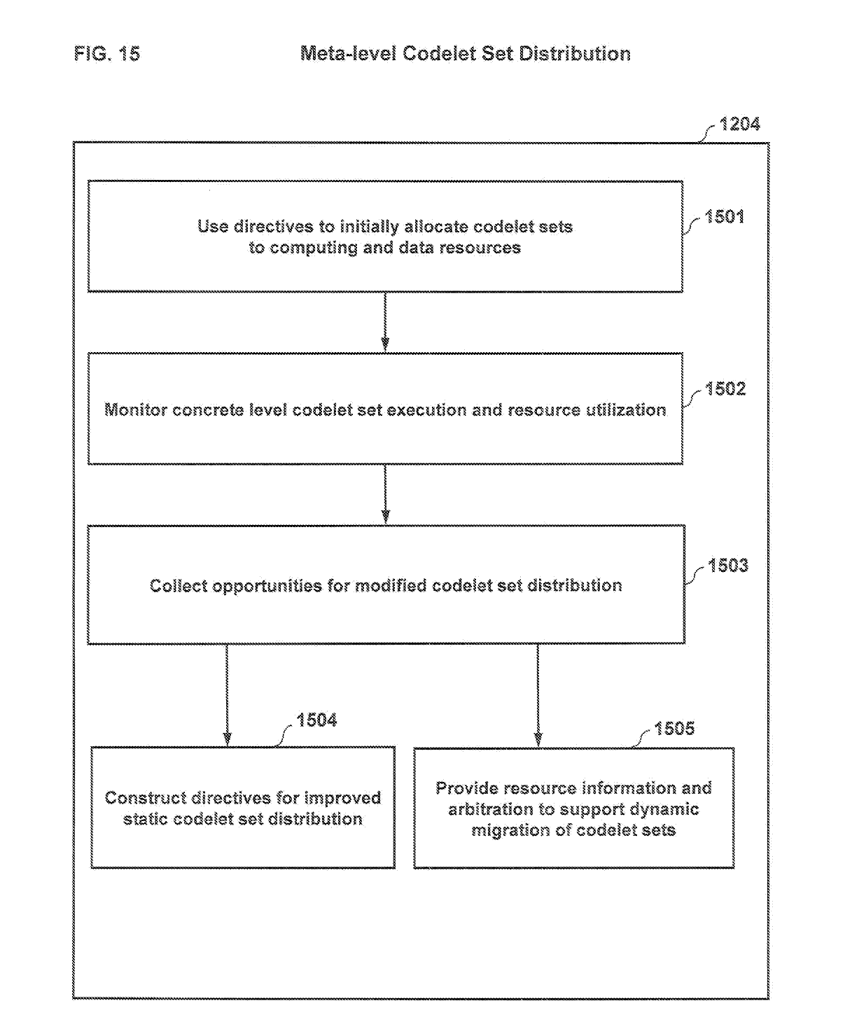

FIG. 15 shows an example of meta-level codeletset distribution, such as may be used to implement 1204, and which may include: 1501 using directives to initially allocate codeletsets to computing and data resources; 1502 monitoring concrete level codeletset execution and resource utilization; 1503 collecting opportunities for modified codeletset distribution; 1504 constructing directives for improved initial (compile-time) codeletset distribution; and 1505 providing resource information and arbitration to support dynamic (run-time) migration of codeletsets.

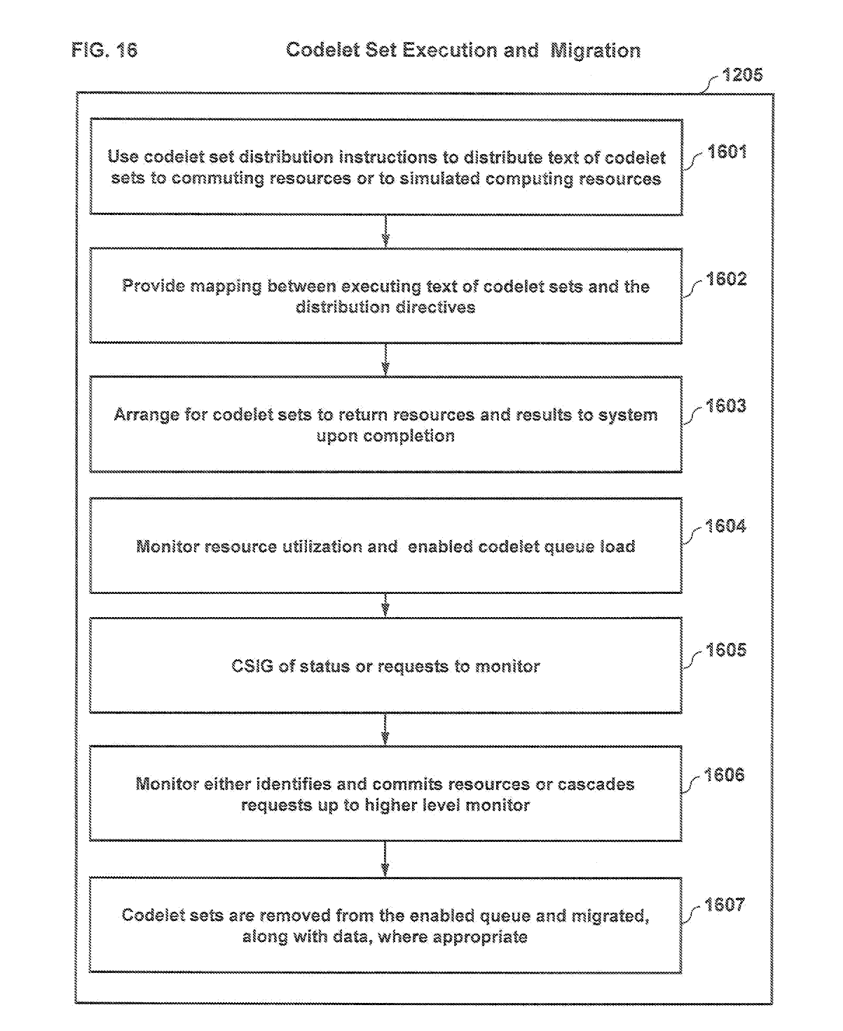

FIG. 16 shows codeletset execution and migration, such as may be used to implement 1205, and which may include: 1601 using codeletset distribution instructions to distribute text of codeletsets to computing resources or to simulated computing resources; 1602 providing mapping between executing text of codeletsets and the distribution directives; 1603 arranging for codeletsets to return resources and results to system upon completion; 1604 monitoring resource utilization and enabled codelet queue load; 1605 using codelet signals to obtain or communicate status information, or to monitor the codelet system; 1606 monitoring to identify and commit resources or cascades requests up to higher level monitor; and 1607 removing codeletsets from the enabled queue and migrating them, along with data, where appropriate.

### Industry Standard Queue Management

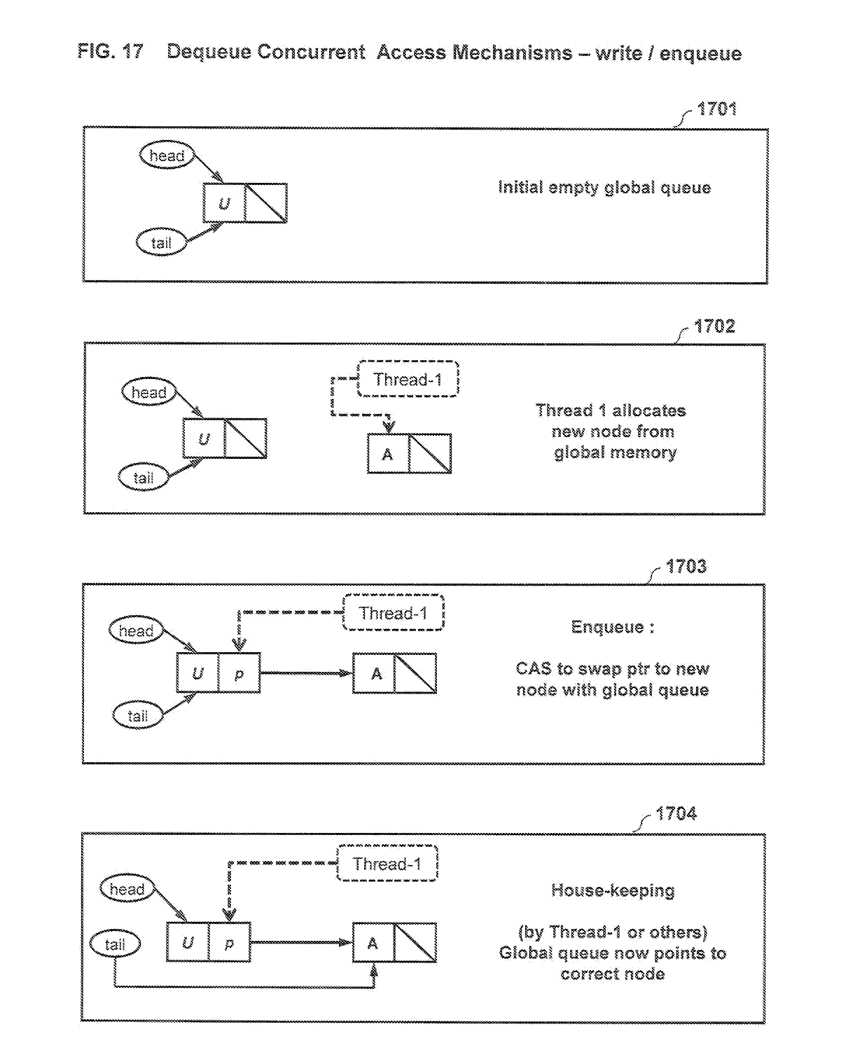

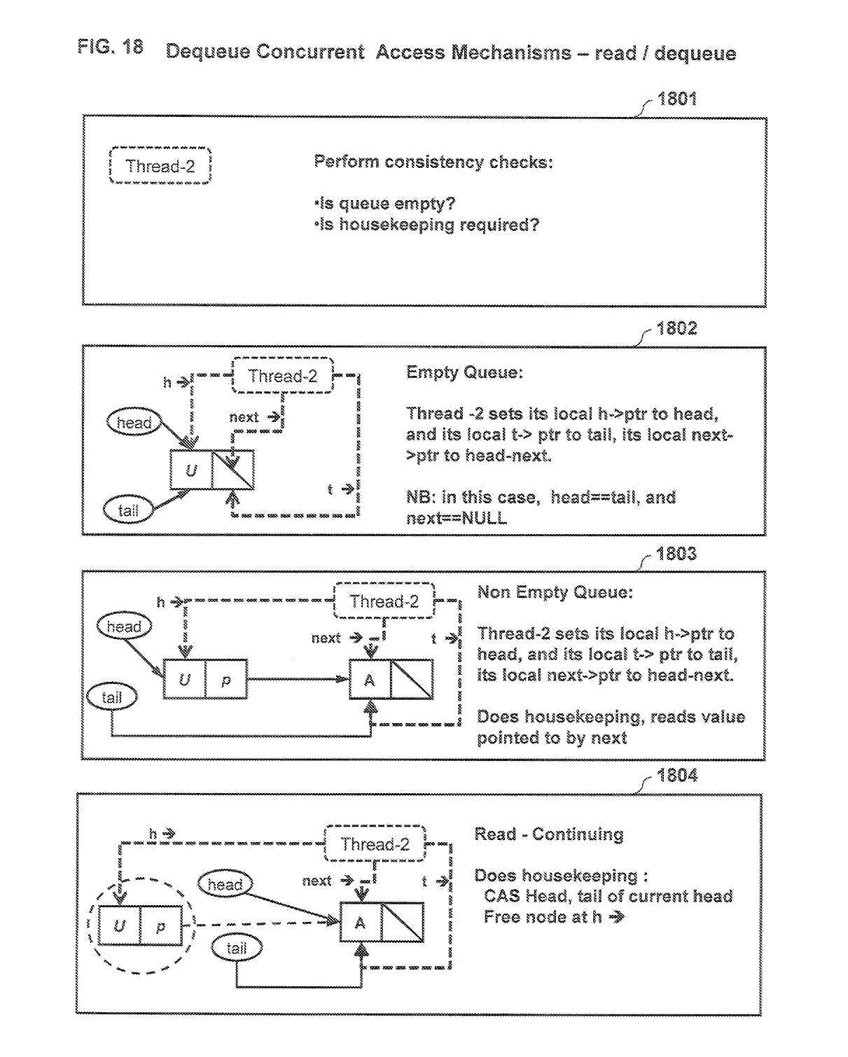

FIGS. 17 and 18 illustrate examples of Industry Standard methods of Queue Management. FIG. 17 illustrates double-ended queue concurrent access mechanisms: write and enqueue. FIG. 18 shows dequeue concurrent access mechanisms this time performing a read and dequeue. Note that one strength of such systems is that the processes using the system have an integral feature of taking care of housecleaning tasks, so the queue may be very robust.

### Queue Management via Atomic Addition Arrays

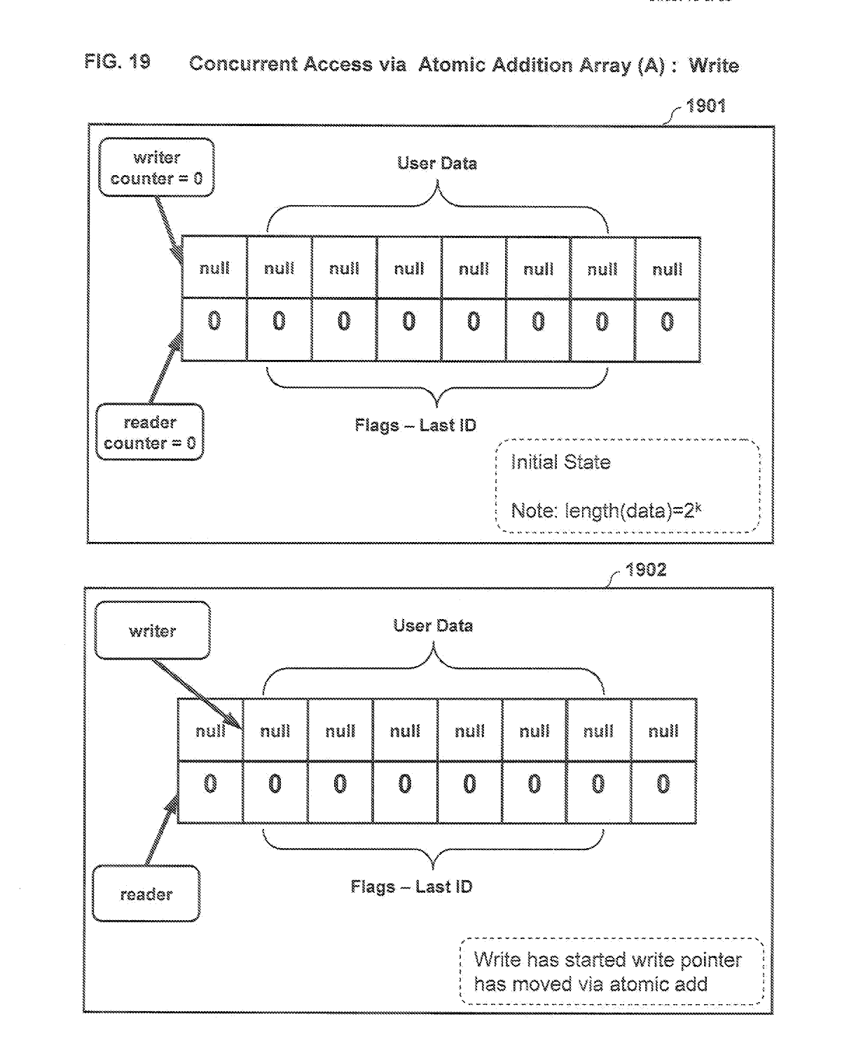

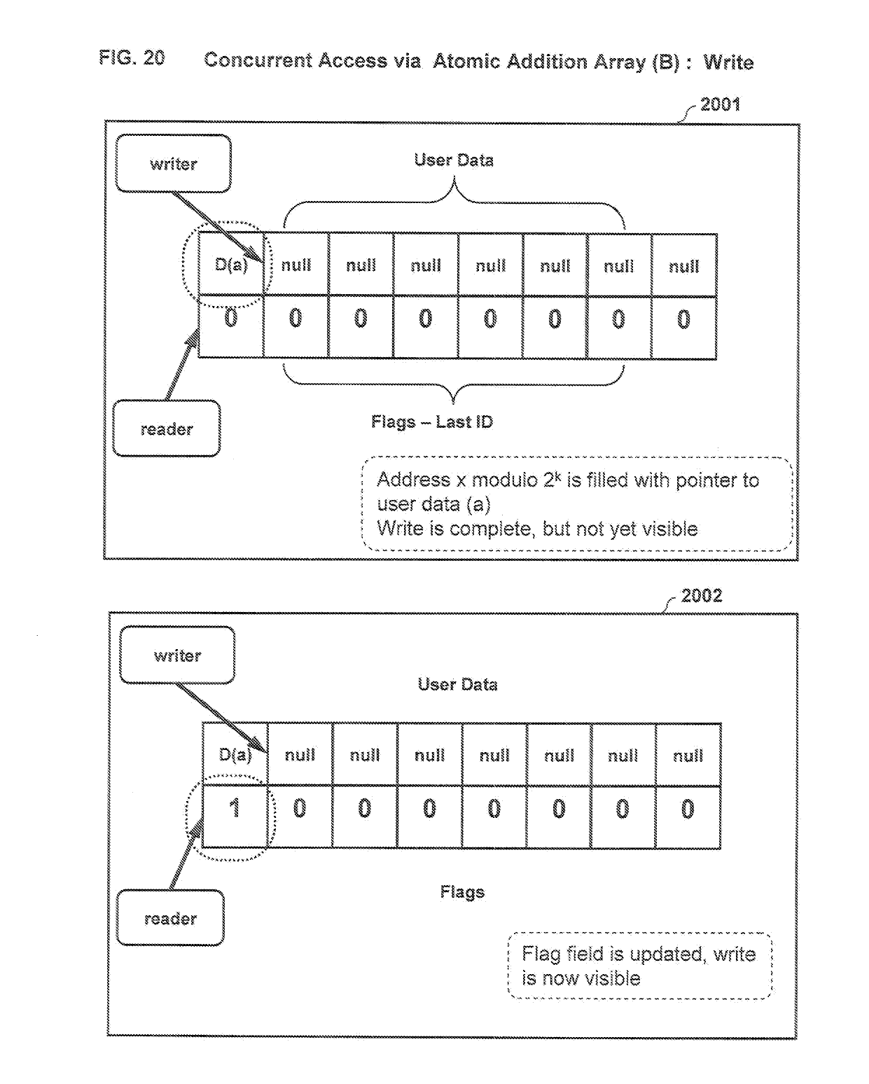

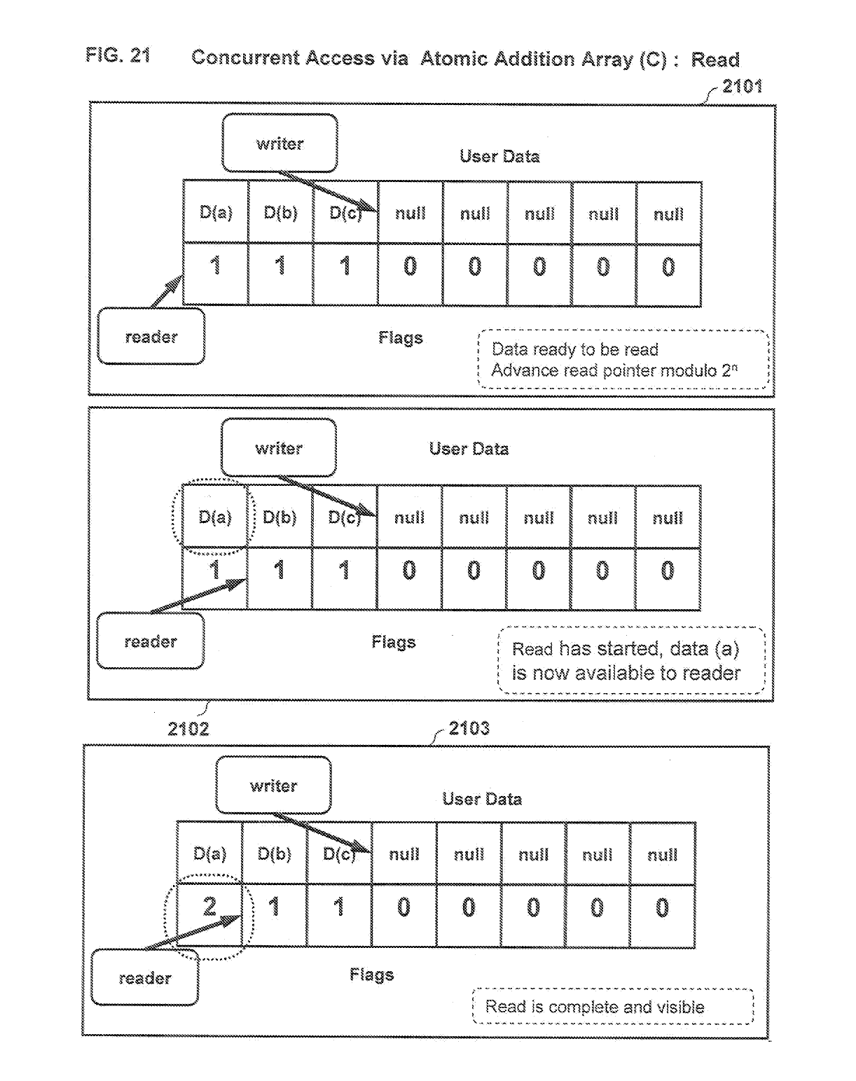

FIGS. 19 through 21 illustrate examples of queue management via atomic addition arrays. FIG. 19 illustrates concurrent access via atomic addition array (A): write. FIG. 20 illustrates concurrent access via atomic addition array (B): write. FIG. 21 illustrates concurrent access via atomic addition array (C): read.

### Queue Management via Linked List/Atomic Addition Arrays

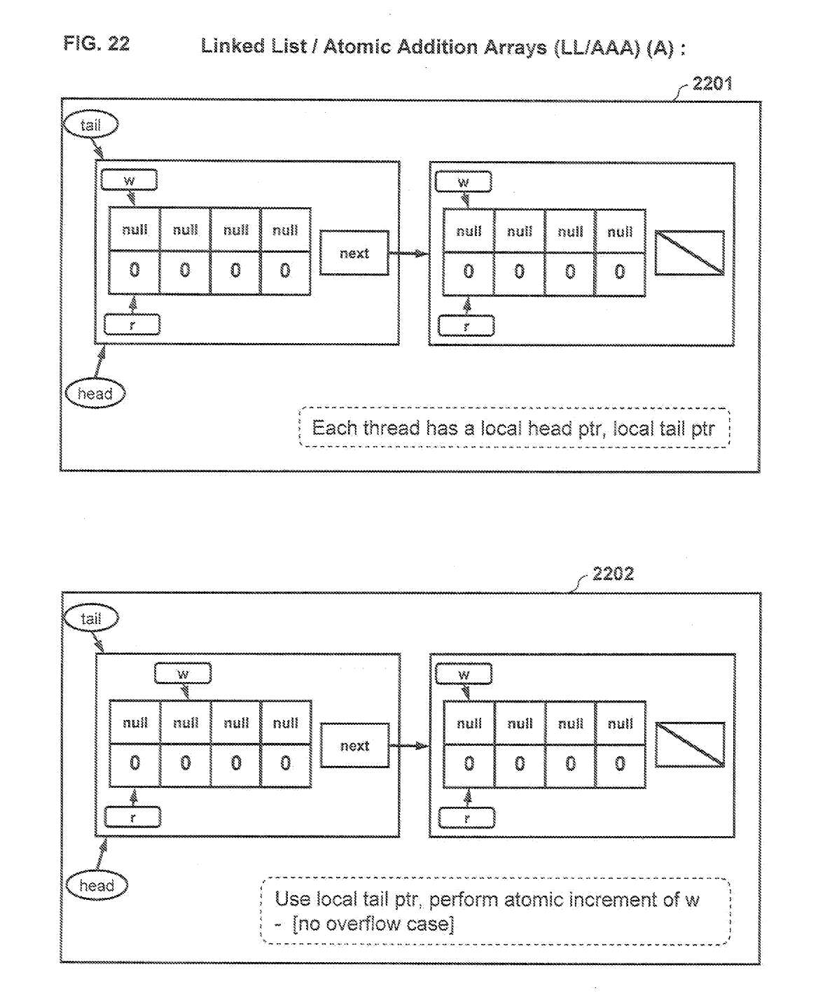

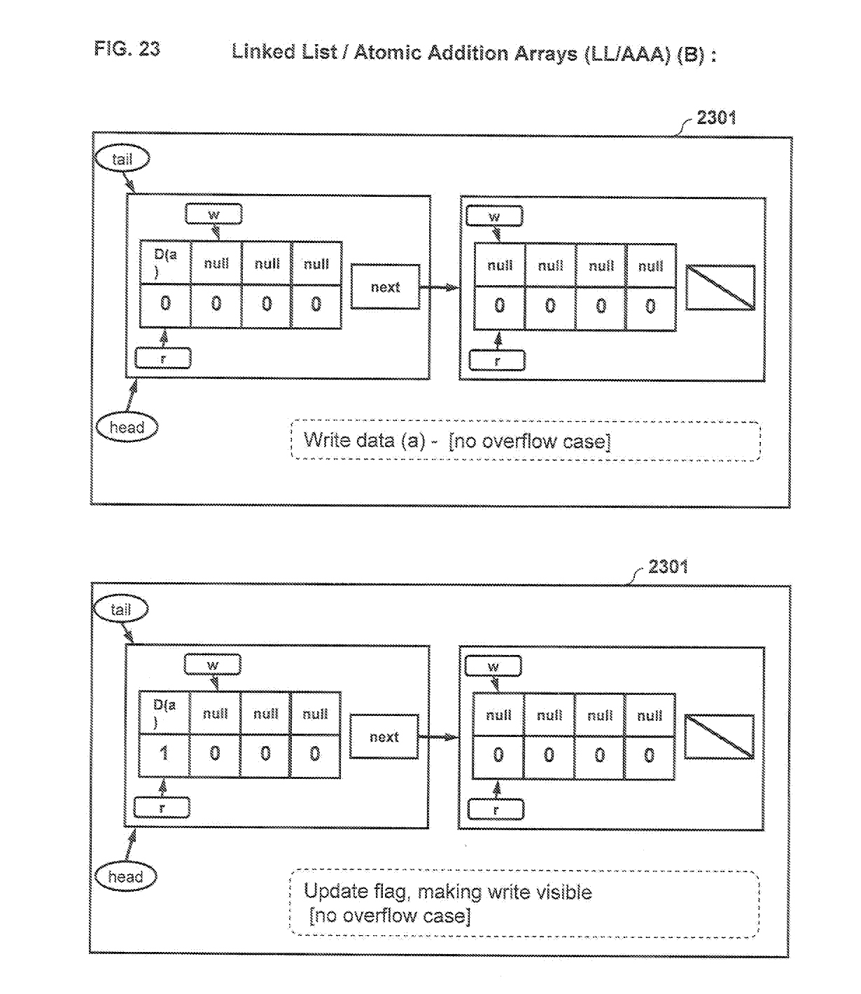

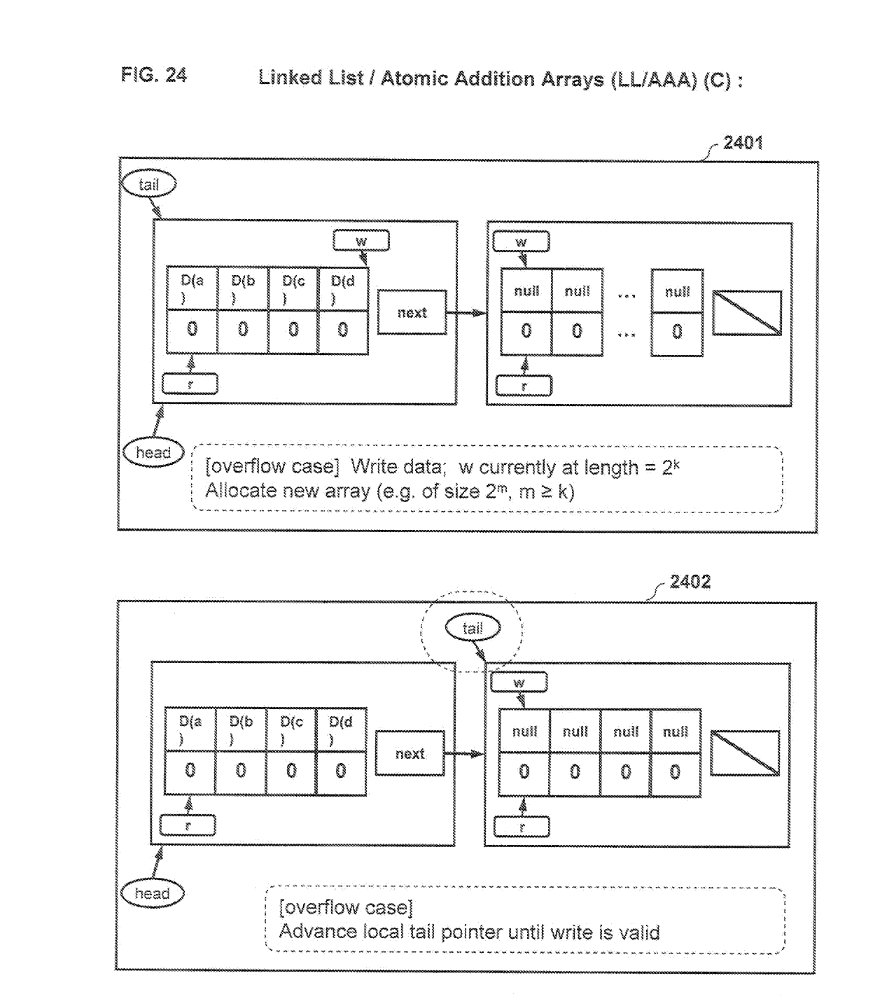

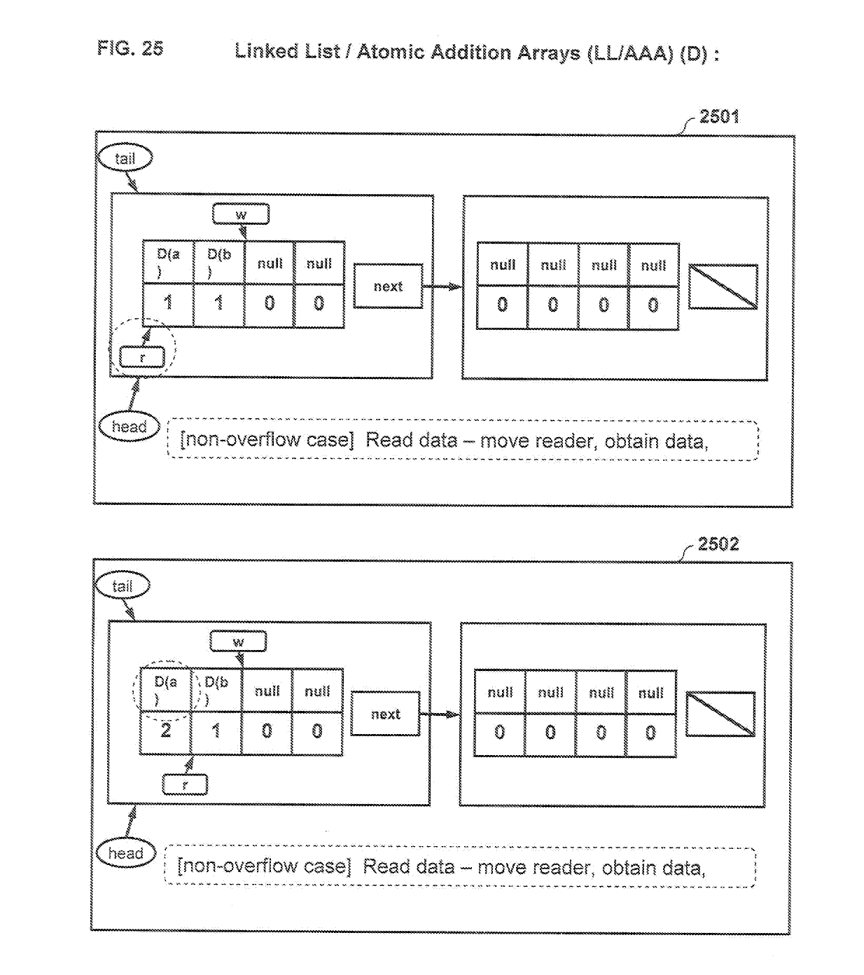

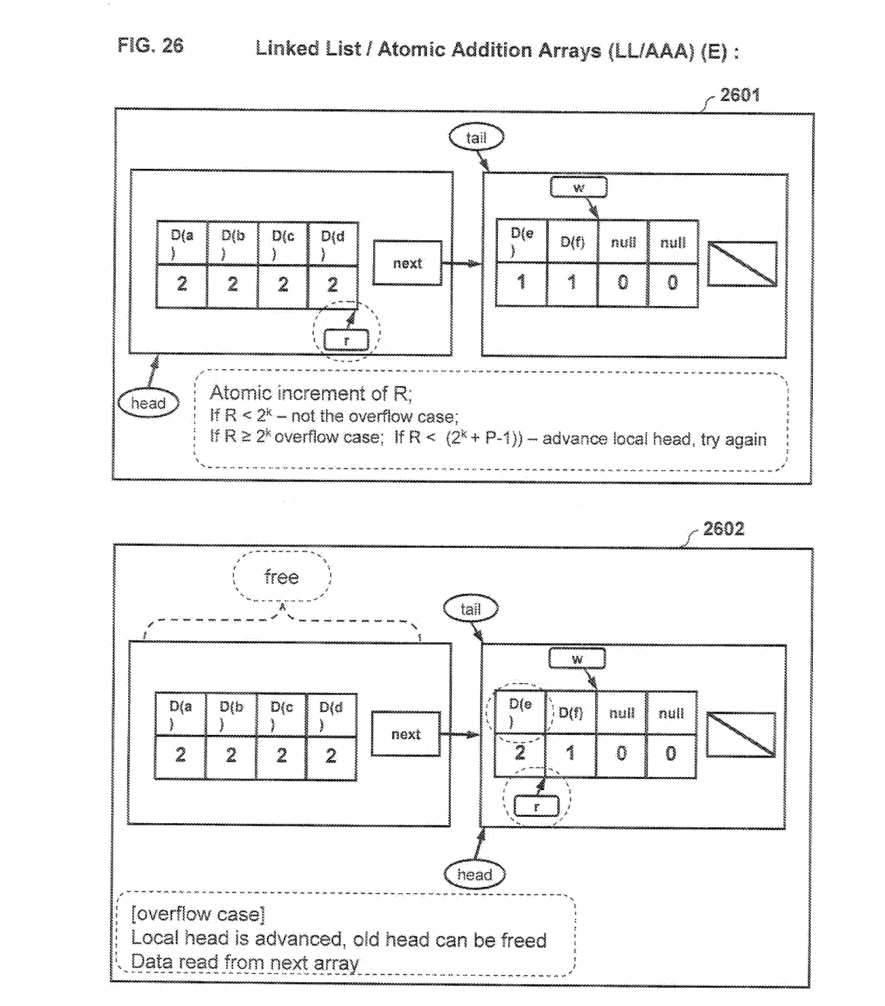

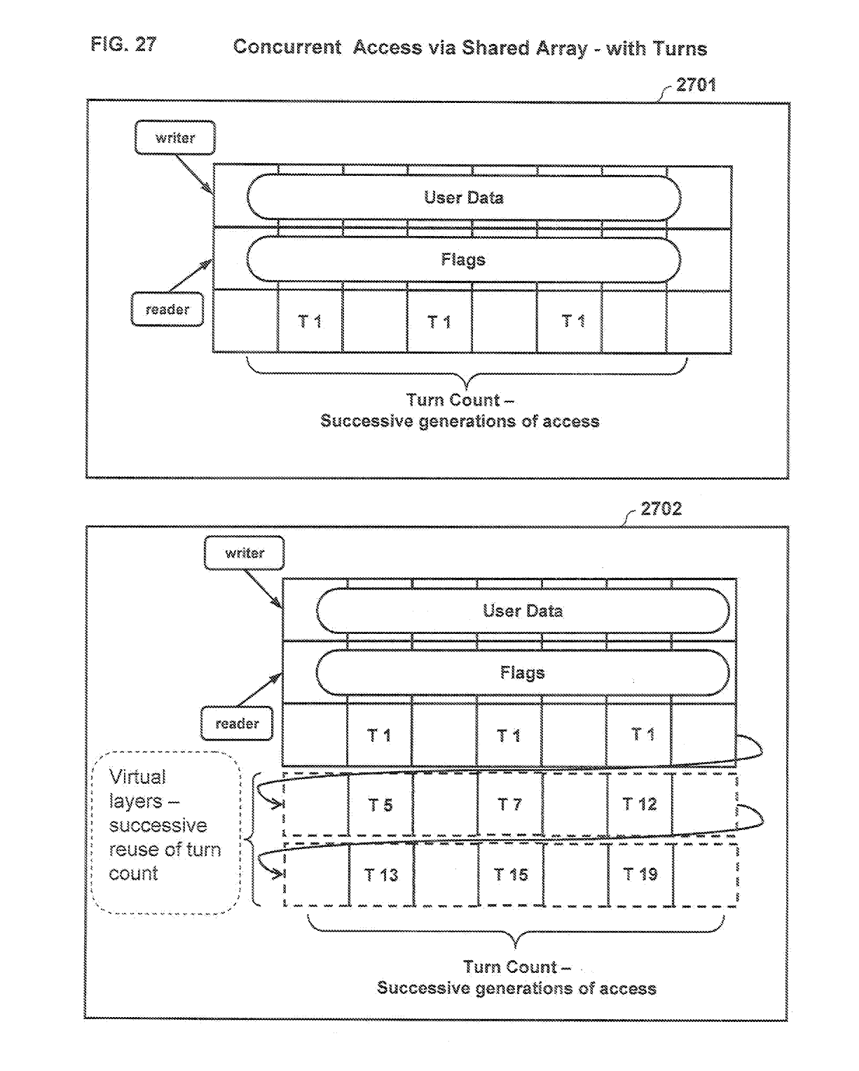

FIGS. 22 through 27 illustrate examples of queue management via linked list atomic addition arrays. FIG. 22 illustrates linked list, specifically atomic addition arrays (A). FIG. 23 illustrates linked list, specifically atomic addition arrays (B). FIG. 24 illustrates linked list, specifically atomic addition arrays (C). FIG. 25 illustrates linked list, specifically atomic addition arrays (D). FIG. 26 illustrates linked list, specifically atomic addition arrays (E). FIG. 27 illustrates concurrent access via shared array with turns.

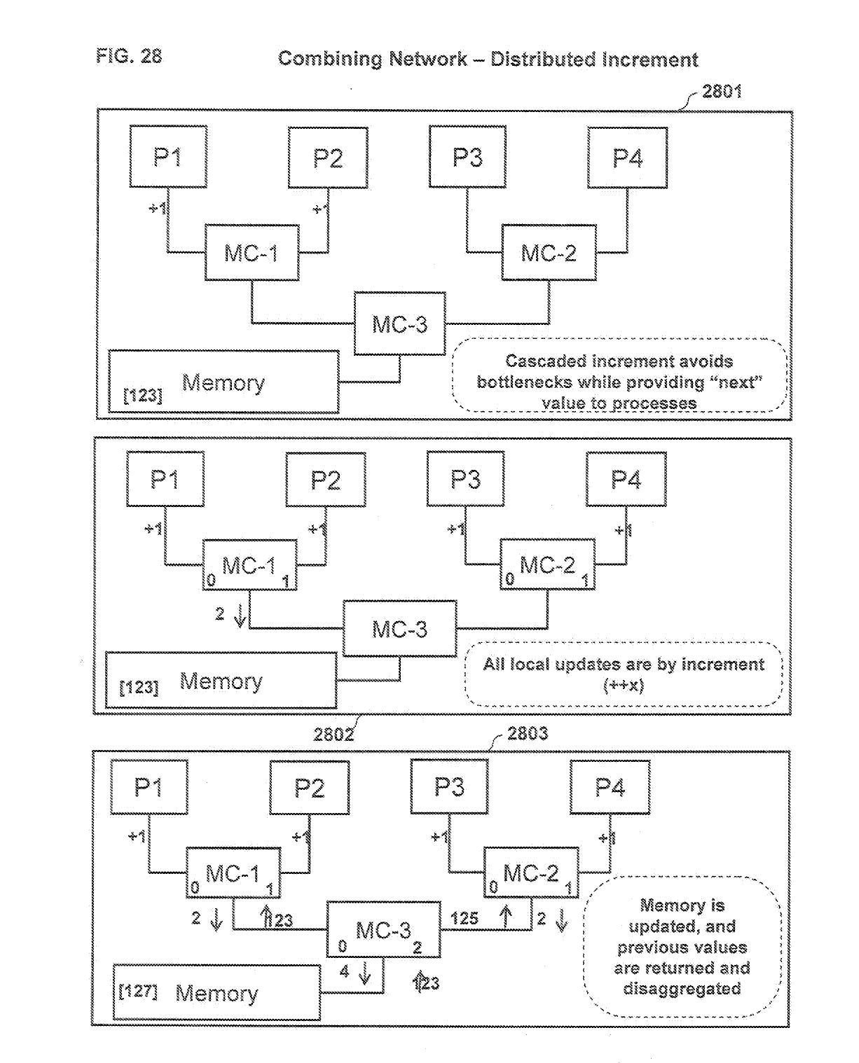

FIG. 28 illustrates a combining network distributed increment. Processes P1 and P2 can issue increment requests that may be handled by memory controller MC-1, which may be cascaded up to MC-3. Each memory controller can handle local requests quickly, while contributing to a cascaded global value. In an alternate embodiment, each local controller can acquire a block of values or a range of values that may be distributed locally until exhausted; this may allow local MC elements to reduce interaction with higher-level controllers.

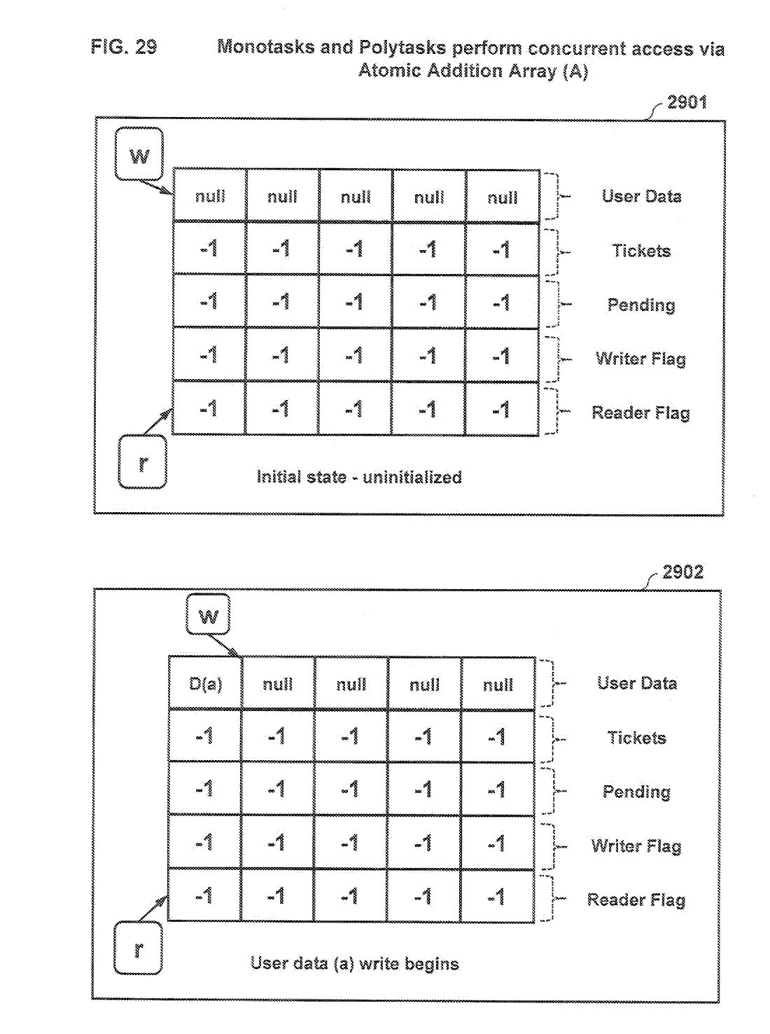

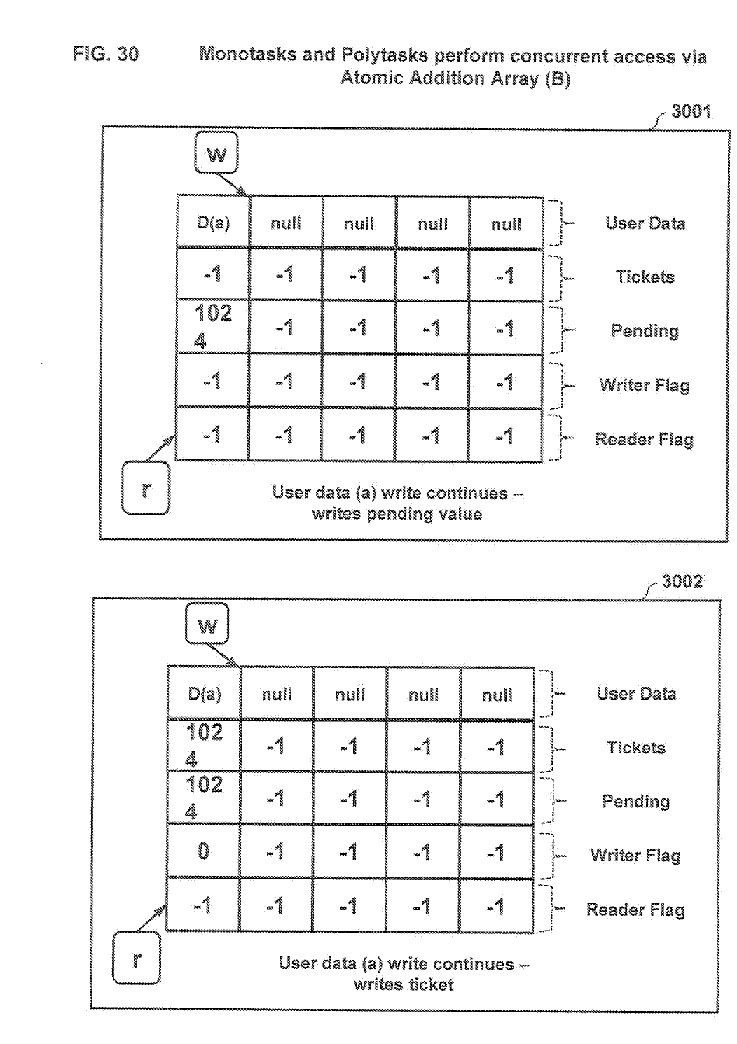

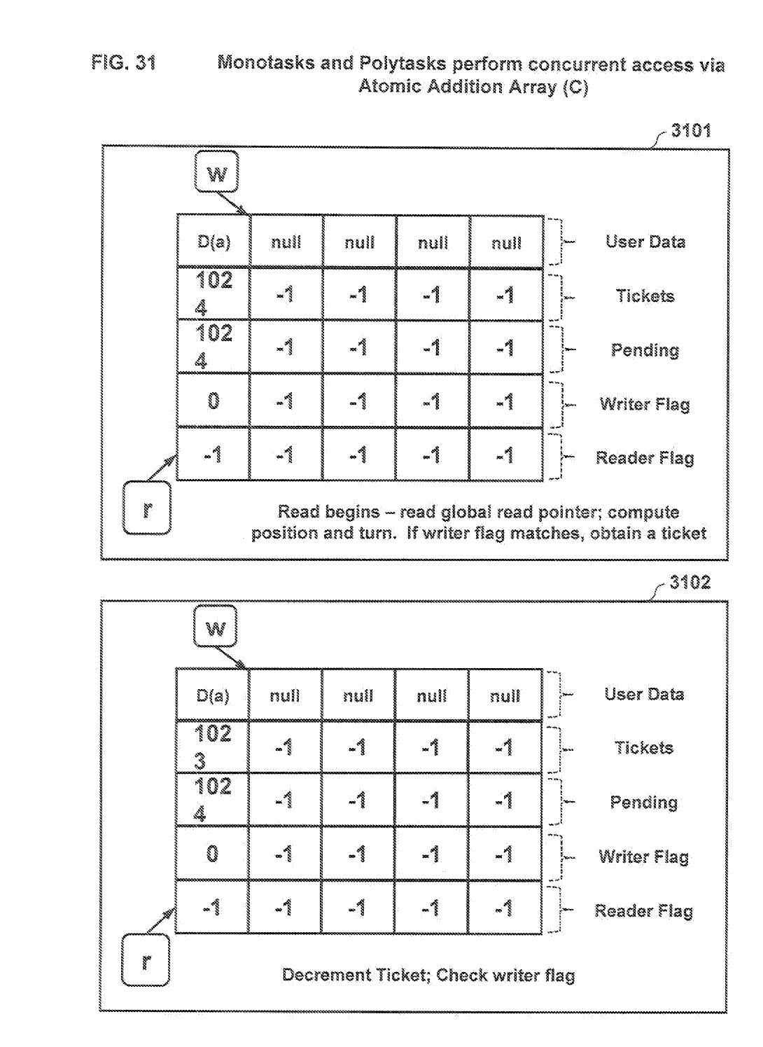

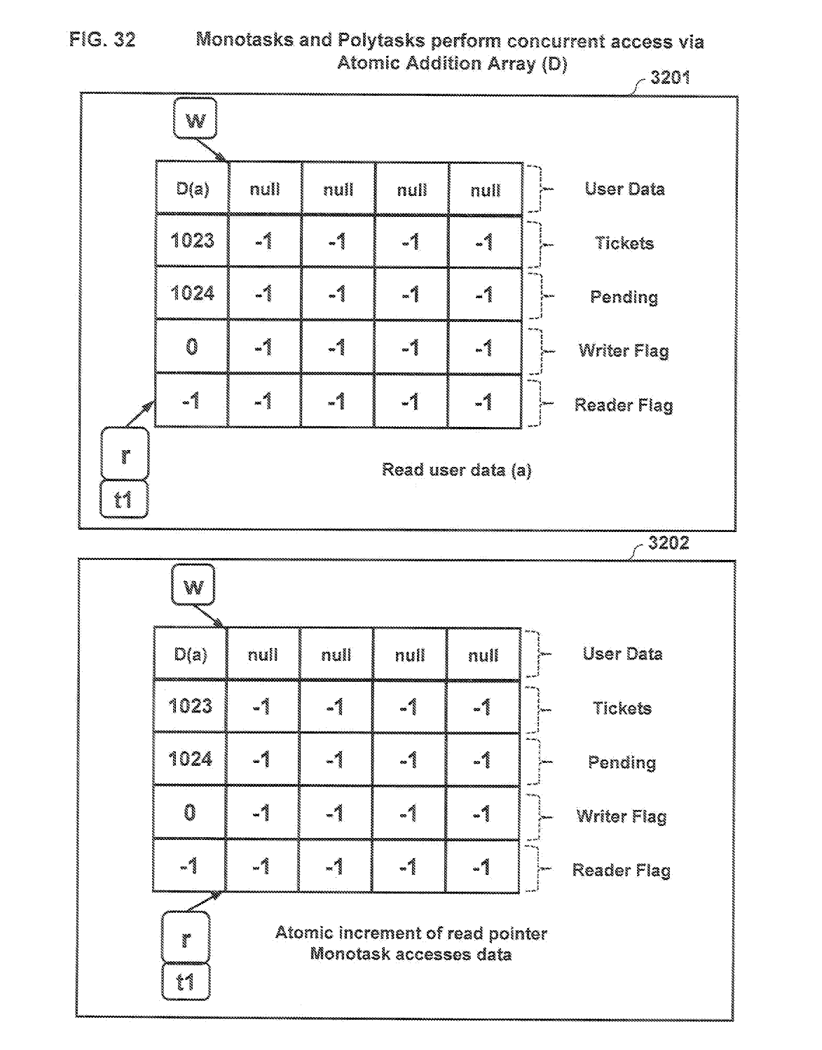

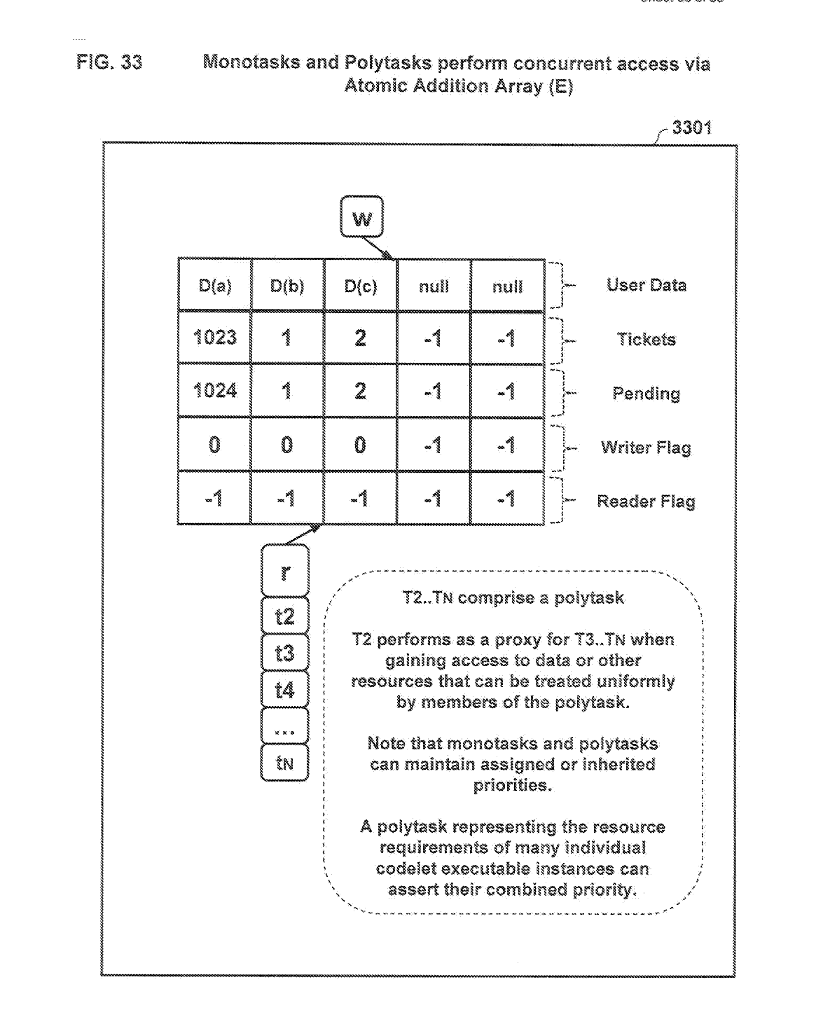

FIGS. 29 through 33 illustrate examples of monotasks and polytasks performing concurrent access via an atomic addition array. FIG. 29 illustrates the initial state 2901, and the state after the first write begins 2902. FIG. 30 illustrates writing of user data 3001, and writing of a ticket 3002. FIG. 31 illustrates beginning of a read 3101, and checking the ticket 3102. FIG. 32 illustrates reading of user data 3201, and increment of a read pointer 3202. FIG. 33 illustrates a polytask performing concurrent access via an atomic addition array 3301. In this case, a single task—T2—can perform as a proxy for a group of tasks—T3 . . . TN.

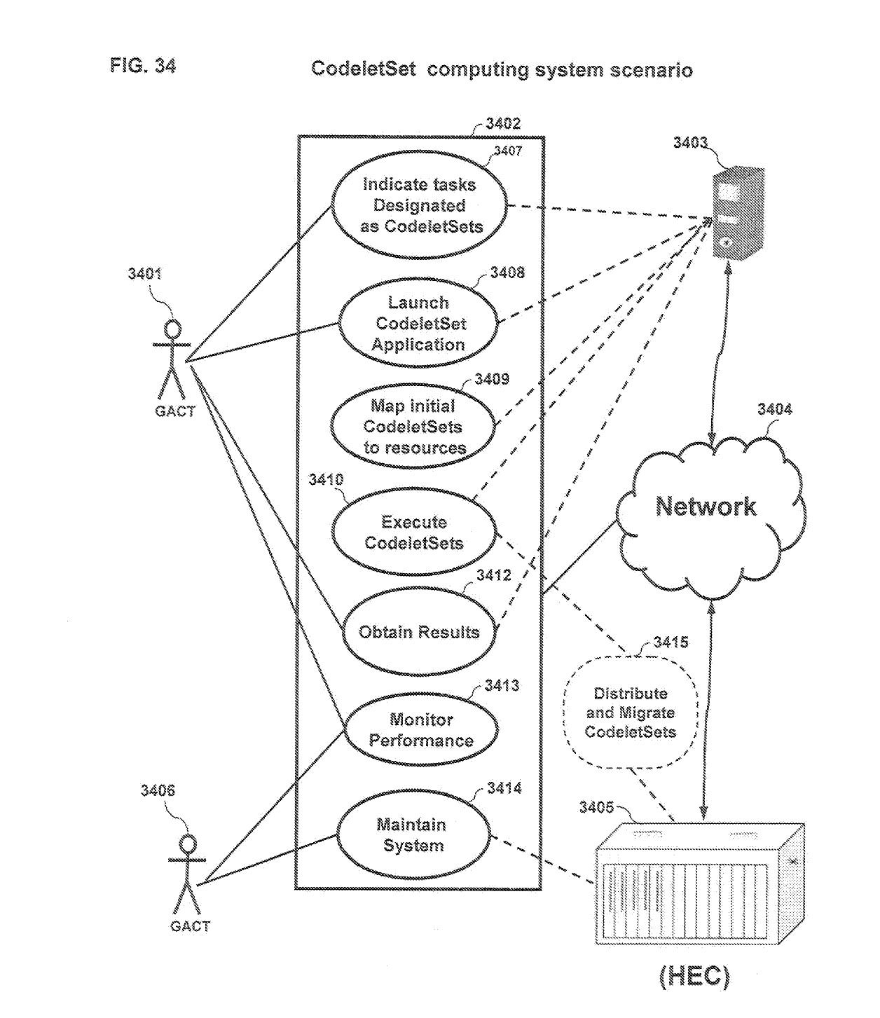

FIG. 34 illustrates an exemplary codeletset computing system scenario, showing the roles of different users with respect to the system.

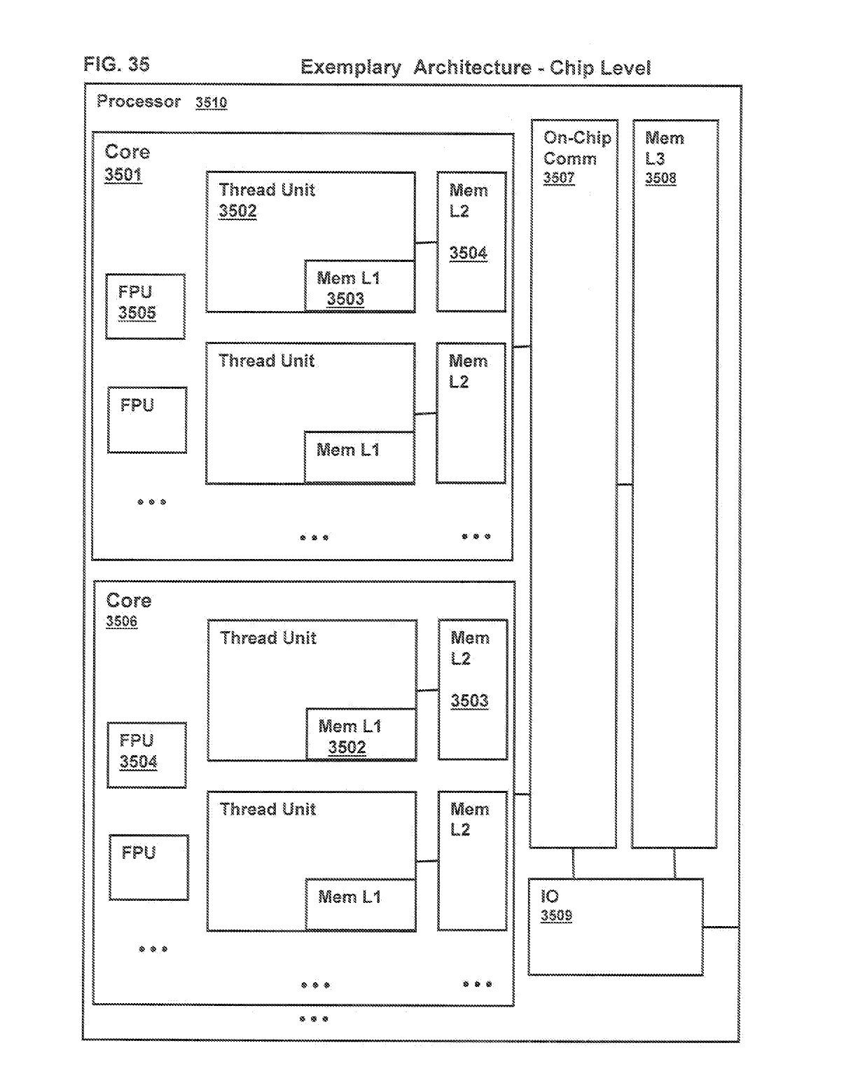

FIG. 35 illustrates a generic exemplary architecture at the microchip level. Note that the memory levels are non-specific and are intended to convey the hierarchy of local memory (with fast access) versus non-local memory. For instance, L1 could be implemented as register files, SRAM, etc.

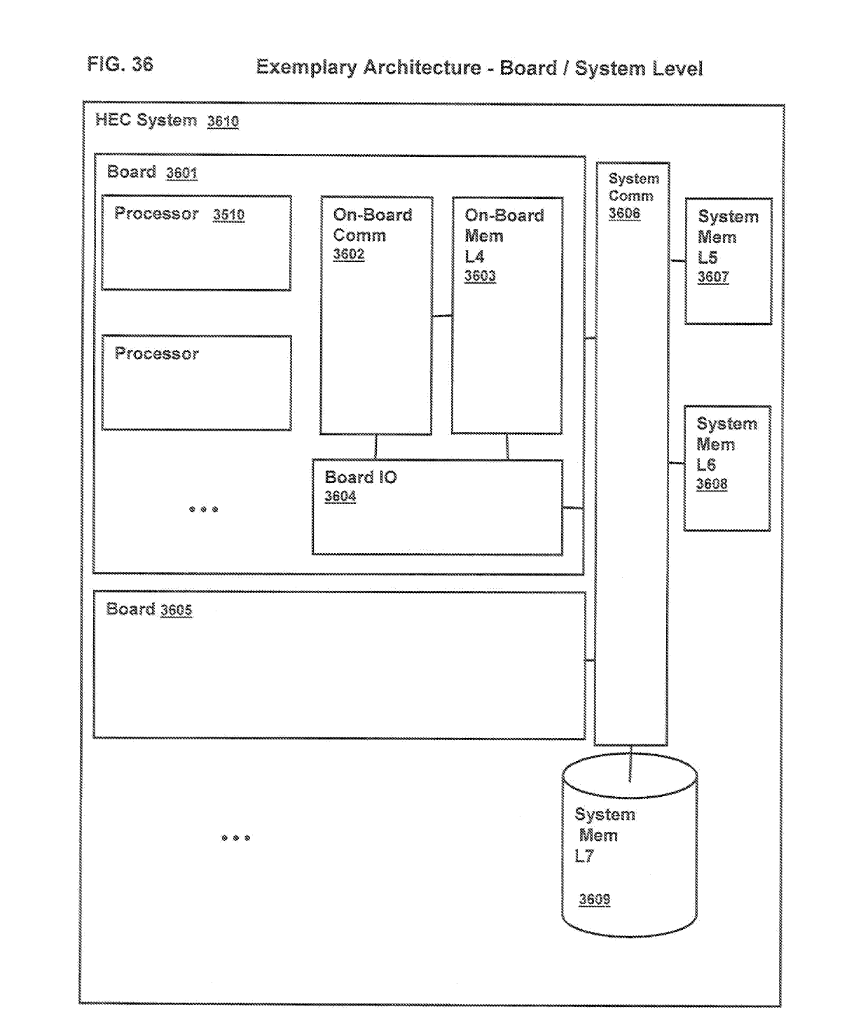

FIG. 36 illustrates a generic architecture at the board/system level. This generic architecture reflects a broad range of possibilities that may influence performance and/or globality.

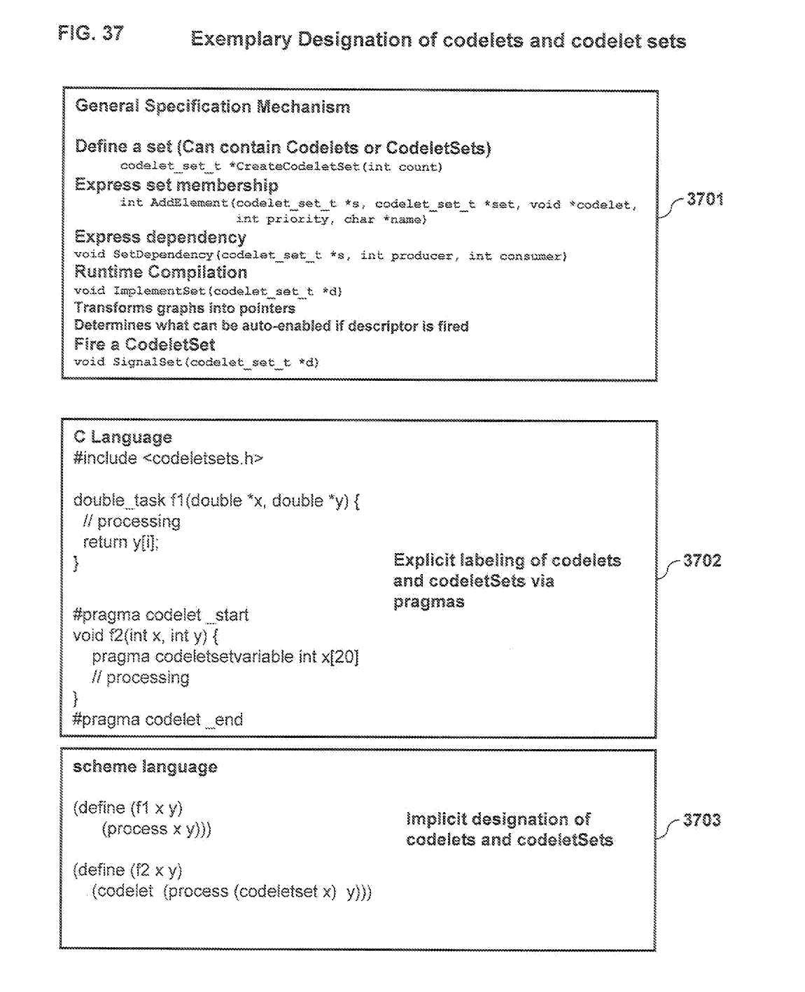

FIG. 37 illustrates an exemplary designation of codelets and codeletsets. There are many equivalent ways to specify codeletsets. Specifications typically may be signaled by the use of special meta-language, by native language constructs, or even by non-executable annotations, or selections made via integrated development environments. Codeletsets may b compose-able and can be defined to fire other codelets or codeletsets. GACTs nay build functionality by constructing codeletsets out of basic codelets and then by combining sets into large sets encompassing entire applications. Function setDependency in 3701 may allow for expression of a dependency between two elements of a codeletset or two elements of different codeletsets. In one embodiment, function implementSet in 3701 may be called at runtime to build the dependence graphs and translate them into pointers. Also, in an embodiment, a compiler may be modified to generate dependency information from the code, even when such dependency information is not provided by the GACT.

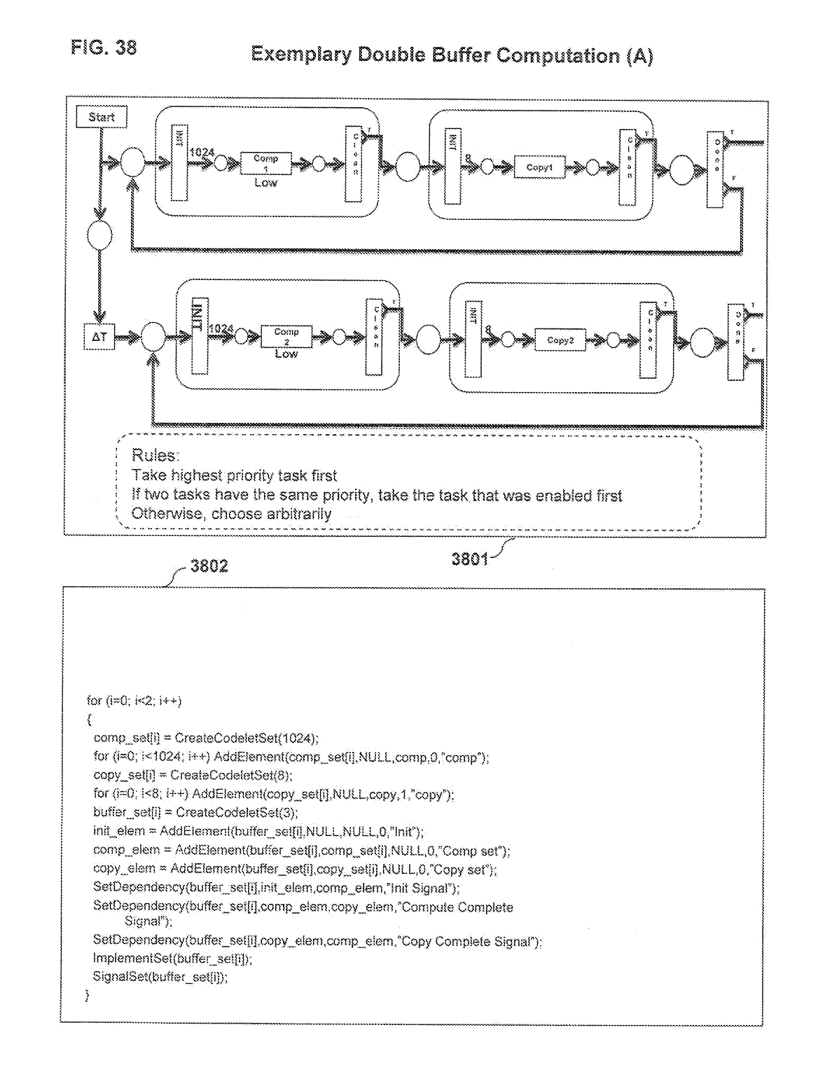

FIG. 38 illustrates an example of double buffer computation (A). Note that every codeletset may have an init and clean procedures to start the system and clean up and fire exit dependencies. In some embodiments, the init and clean tasks may be optimized away statically at compile time or dynamically at runtime. The runtime system may generally be isomorphic when a represented as a Petri net, which is a graph of places and transitions. Places extend dataflow models and allow representation of data dependencies, control flow dependencies, and resource dependencies. In one embodiment, the system may execute higher priority tasks first and then move on to lower priorities. This may allow certain system-critical codelets to be scheduled, such as tasks that maintain concurrent resource access for the system. If all of the worker cores worked on Comp1 and then Comp2, suddenly there may be no work for most of the cores until copy1 and copy2 are finished. Therefore, codelets that produce more codelets may be given higher priority so that the run queue is less likely to be empty. In the following illustrations, once the system is started, it may generally have at least some compute codelets to execute because the copy codelets have high priority when they become available.

Additionally, in the double buffer computation example, the example index 1024 bound indicates that when knit is finished, it may enable 1024 Comp1 codelets. Similarly, the example index bound 8 copy codelets may be fired in the copy codeletset. Note that the count of 8 is used because the system may have many processors demanding memory (e.g., DRAM) bandwidth to be arbitrated among them. Therefore, the codelet system can use fewer worker cores to achieve the same sustained bandwidth, although lower (context switching) overhead, thus achieving improved application program processing throughput. In another embodiment, the system can dynamically supply a place going into copy1 and returning from copy1 with 8 tokens in it all of the time. Similarly, the same optimization can be done for copy2. Finally, in another embodiment, these two places can be fused into the same place, and the copy functions could use a common pool of memory bandwidth tokens. In such a case, if the compute is longer than the copy, the system may ensure that copy1 and copy2 will not occur at the same time. This is an example of the expressive power of the Petri net for resource constraints such as memory bandwidth, execution units, power, network, locks, etc., and demonstrates that codeletsets can exploit that expressive power to enable the construction of highly parallel, highly scalable applications. Note that in 3802, AT is implicit in the fact that SignalSet(buffer_set[0]) is executed before SignalSet(buffer_set[1]).

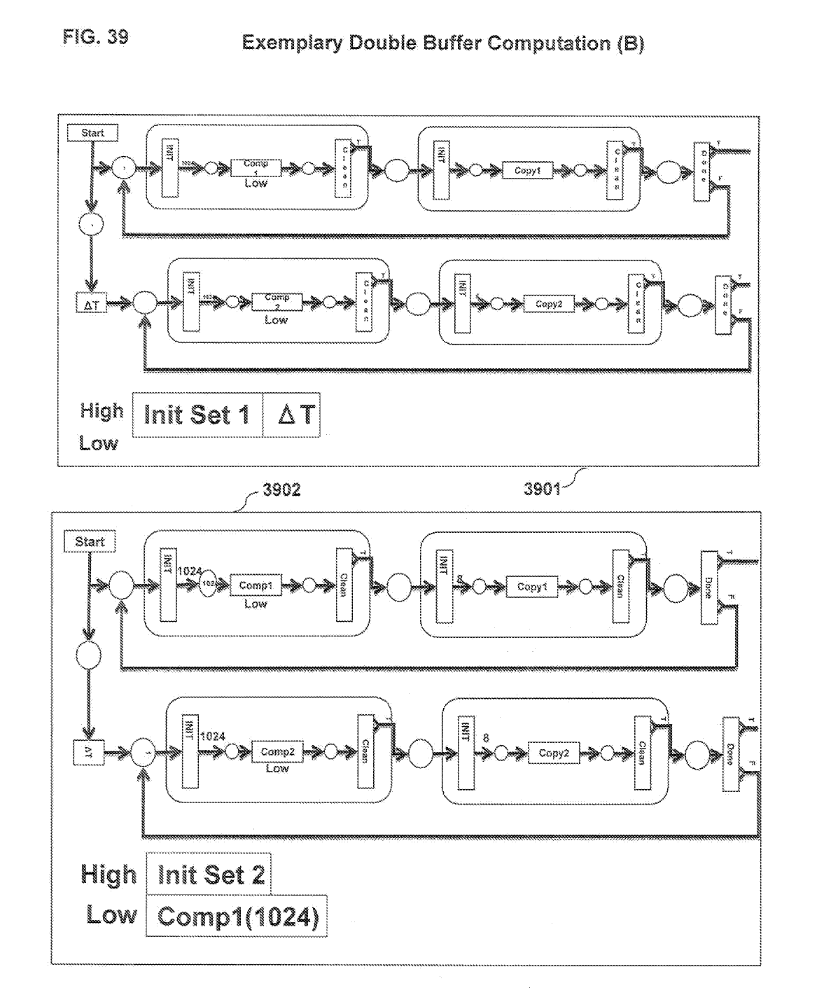

FIG. 39 illustrates an example of double buffer computation (B). In 3901, Init Set 1 may be signaled, while in 3902, Init set 2 may be signaled, and computation of the example number of 1024 codelets may begin.

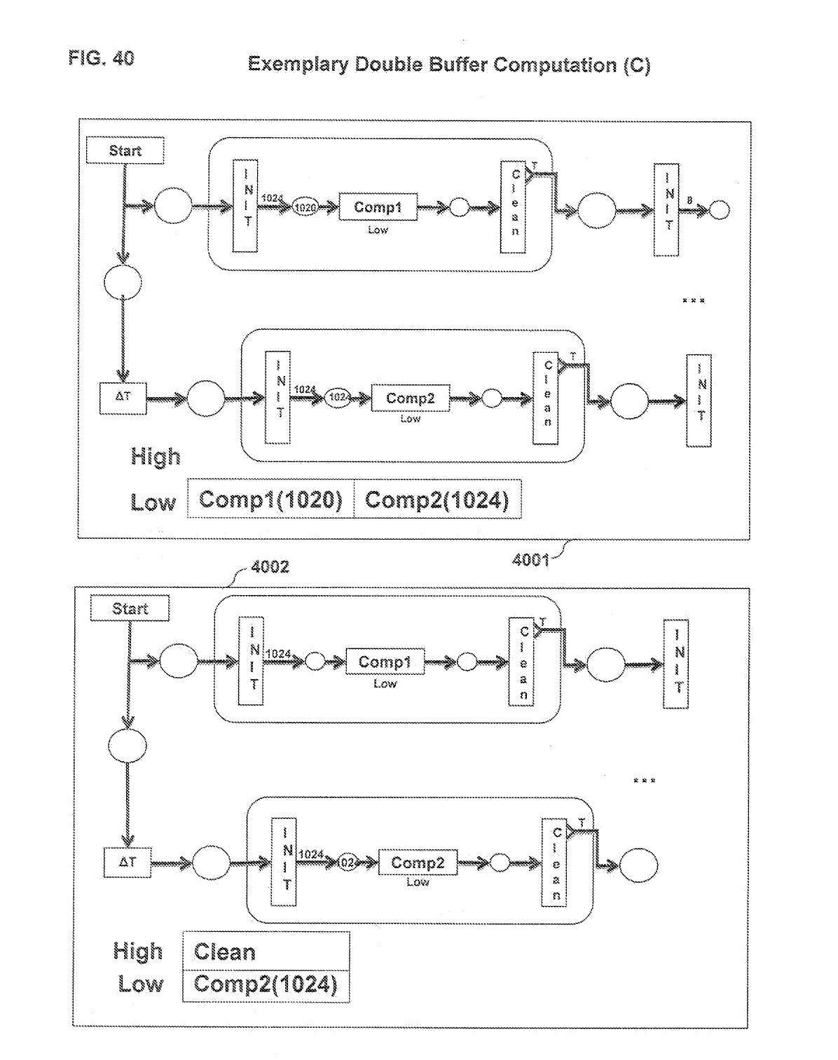

FIG. 40 illustrates an example of double buffer computation (C). In 4001, task Comp2 may be in the queue, but the worker cores may continue to work on Comp1, as the system is operating in first-come-first-served mode in this example (to which the invention is not limited), except for priority differences. In 4002, Comp1 may finish, and a high-priority task of “clean” may be placed. Comp2 can now continue. In other embodiments, work can be consumed in ways other than first-in-first-out, such as last-in-first-out, to give stack-like semantics. This embodiment may be useful for work sharing in recursive applications.

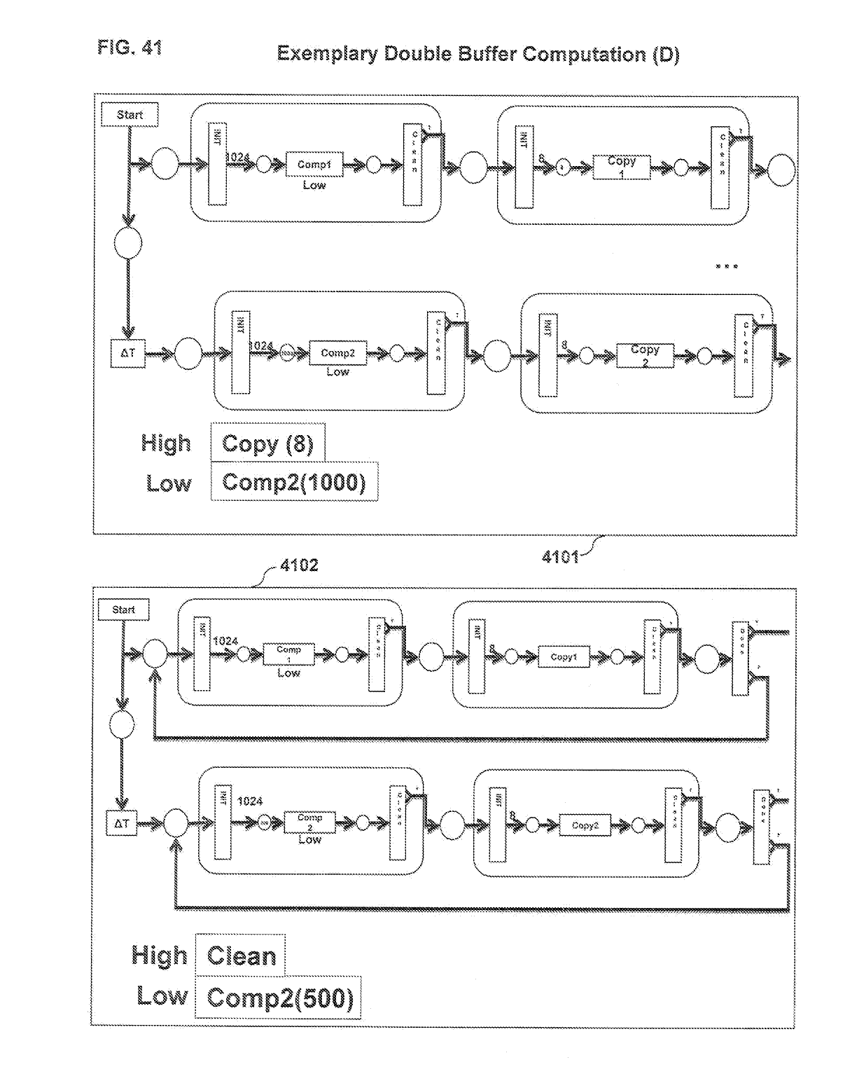

FIG. 41 illustrates an example of double buffer computation (D). In 4101, Comp2 can continue, but at least one execution unit may be used for the high-priority task of copy(8). In 4102, Comp2 may be continuing, but even more execution units may be allocated for copy function. The system may clean resources after the copy.

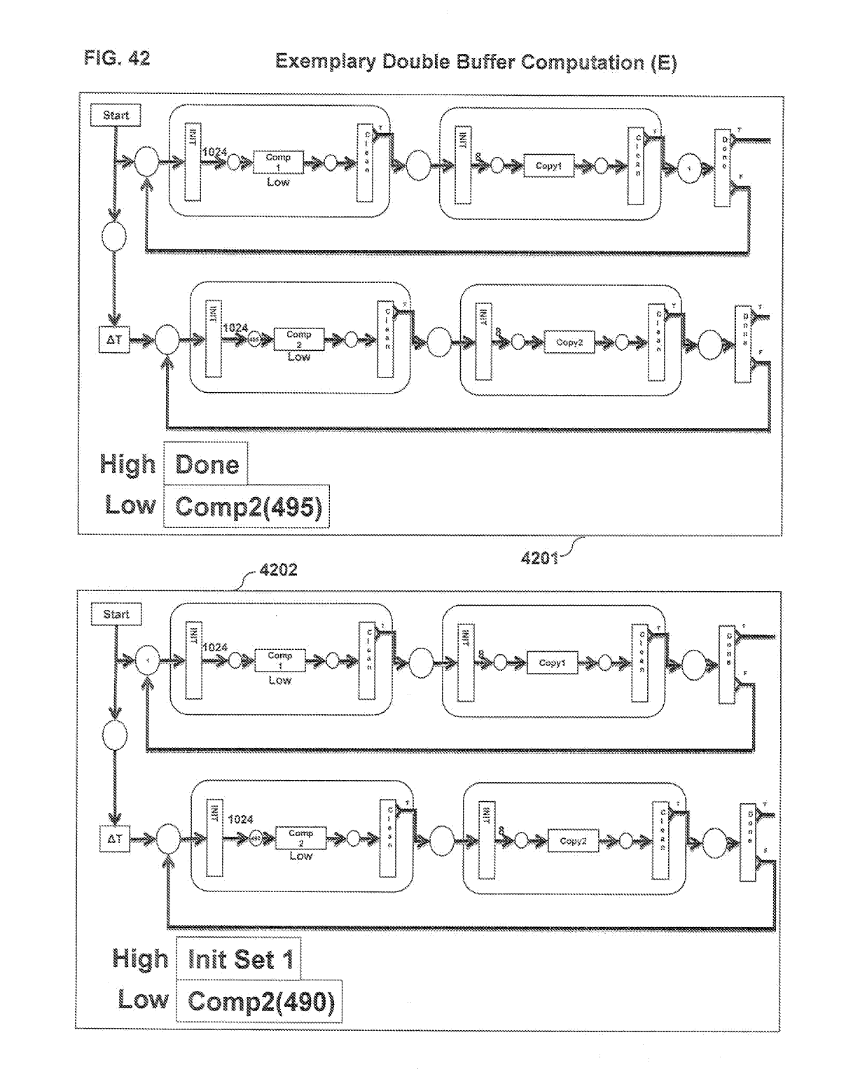

FIG. 42 illustrates an example of double buffer computation (E). In 4201 the system may check to see if done flag is in buffer 1. In 4202, the Comp1 codelet may be initialized.

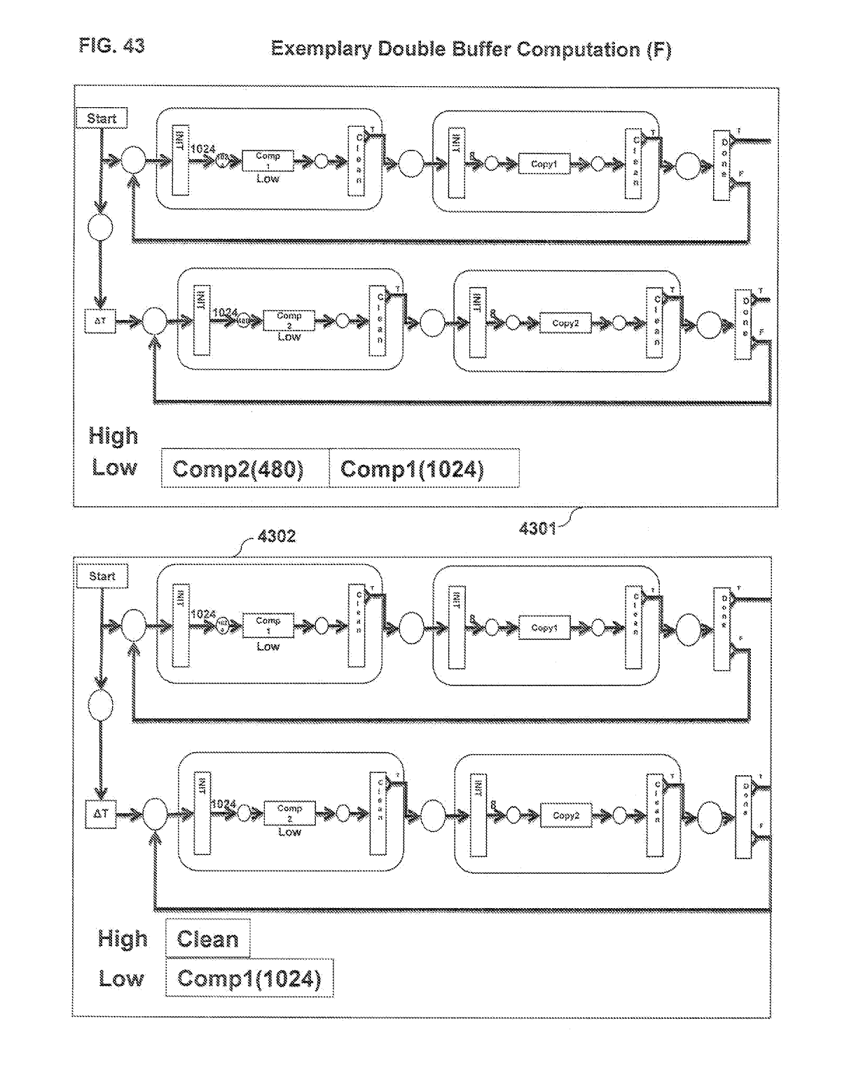

FIG. 43 illustrates an example of double buffer computation (F). In 4301, the Comp1 codelets may be queued behind the existing Comp2 codelets. In 4302, Comp2 may complete, while Comp1 may continue.

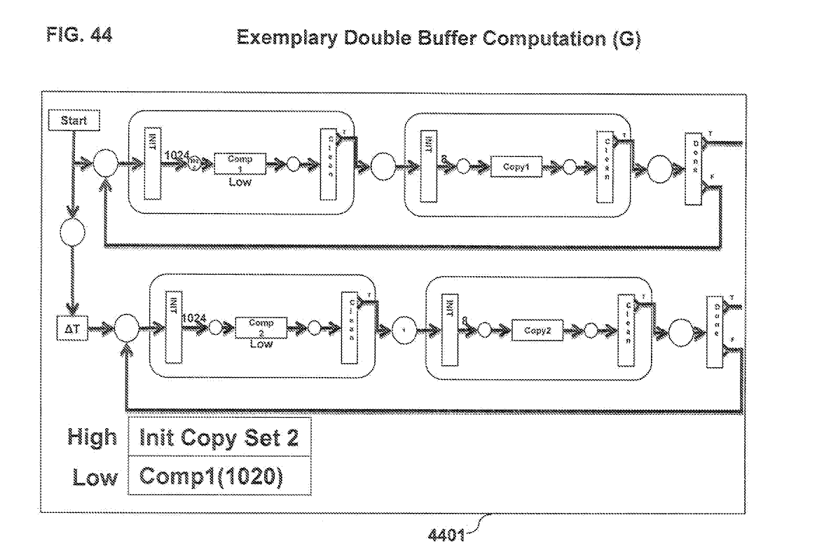

FIG. 44 illustrates an example of double buffer computation (G). In 4401, a high priority codelet of copy set 2 may be initialized, while Comp1 may continue. Note that codelets can receive signals at any time—even during their execution. This may enable migration of code and data to better exploit the computational resources. To summarize, some of the notable aspects may include: (a) priorities; (b) balancing concurrency with queue space; and (c) extensions beyond dataflow, which may include, e.g., early signals, event flow, and/or enabling a programmer to influence the schedule.

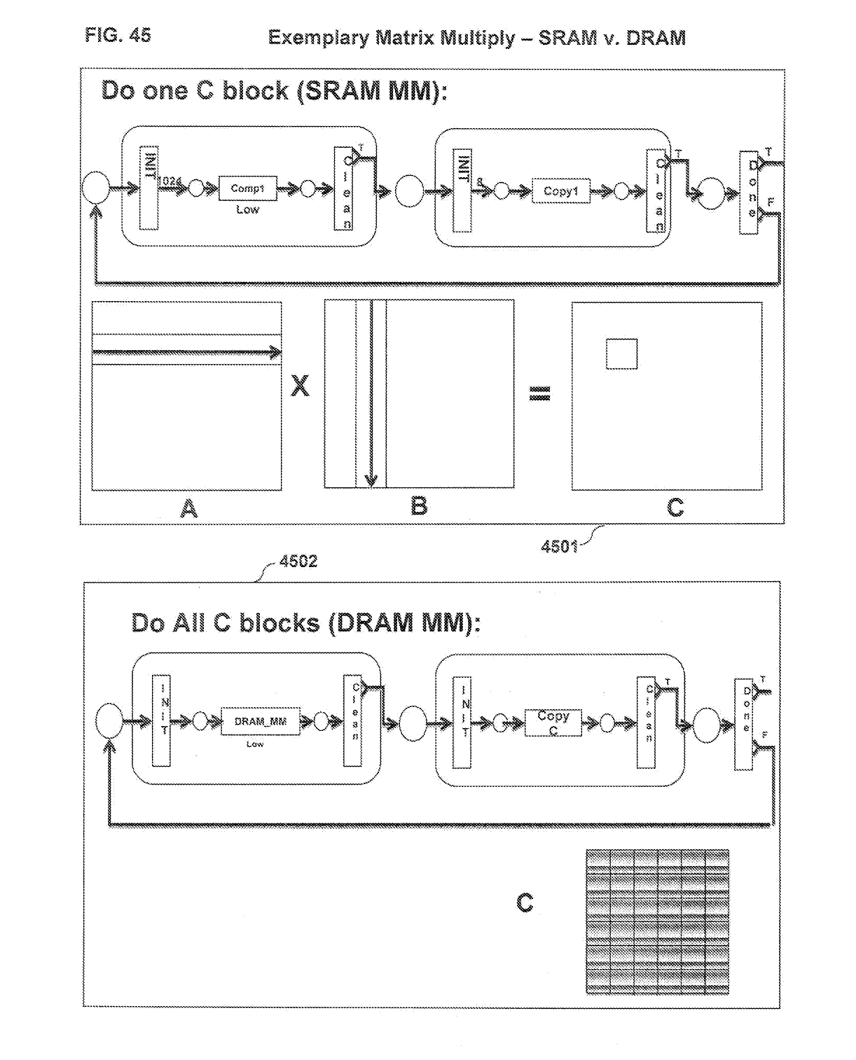

FIG. 45 illustrates an example of a matrix multiply with SRAM and DRAM. In 4501, the system may copy blocks of both matrices A and B from DRAM to SRAM, and computing matrix C in SRAM. In 4502, each block of C may be copied back to the appropriate place in DRAM.

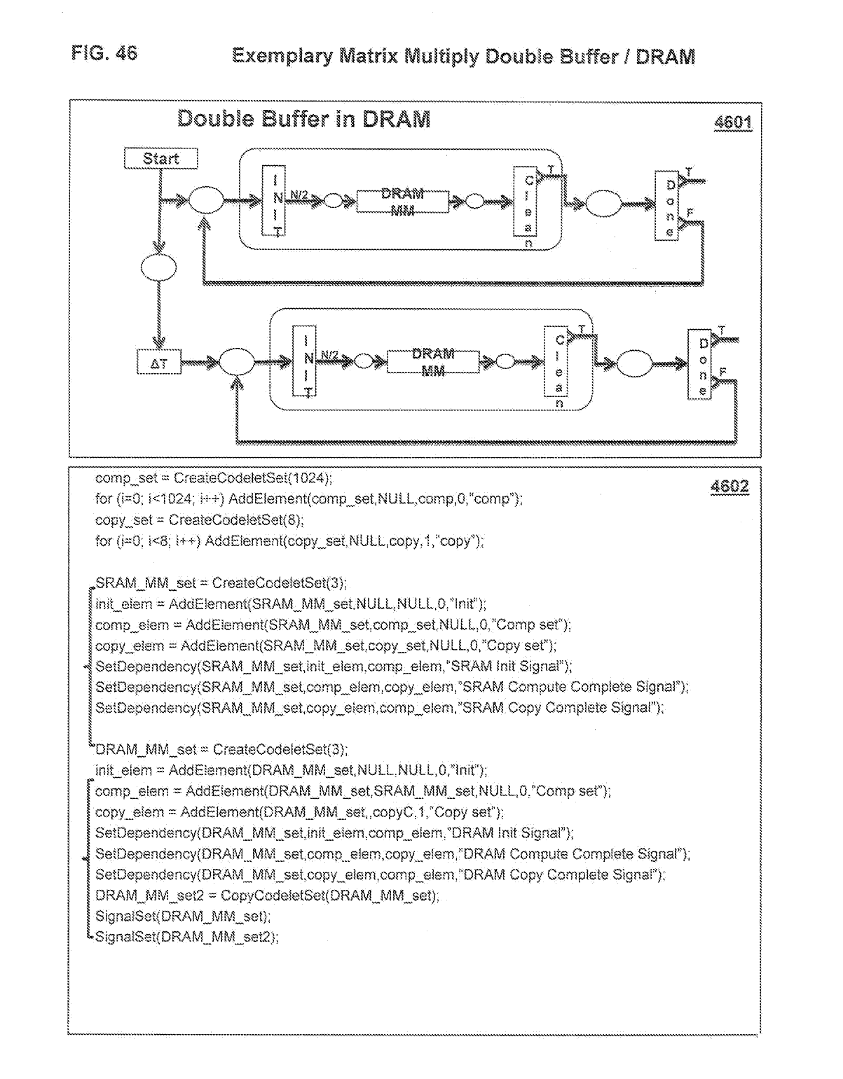

FIG. 46 illustrates an example of a matrix multiply double buffer/DRAM. In this case, codelets may be used to double buffer the DRAM access to reduce the latency of accesses; this is illustrated in the portions of code 4602 shown in brackets.

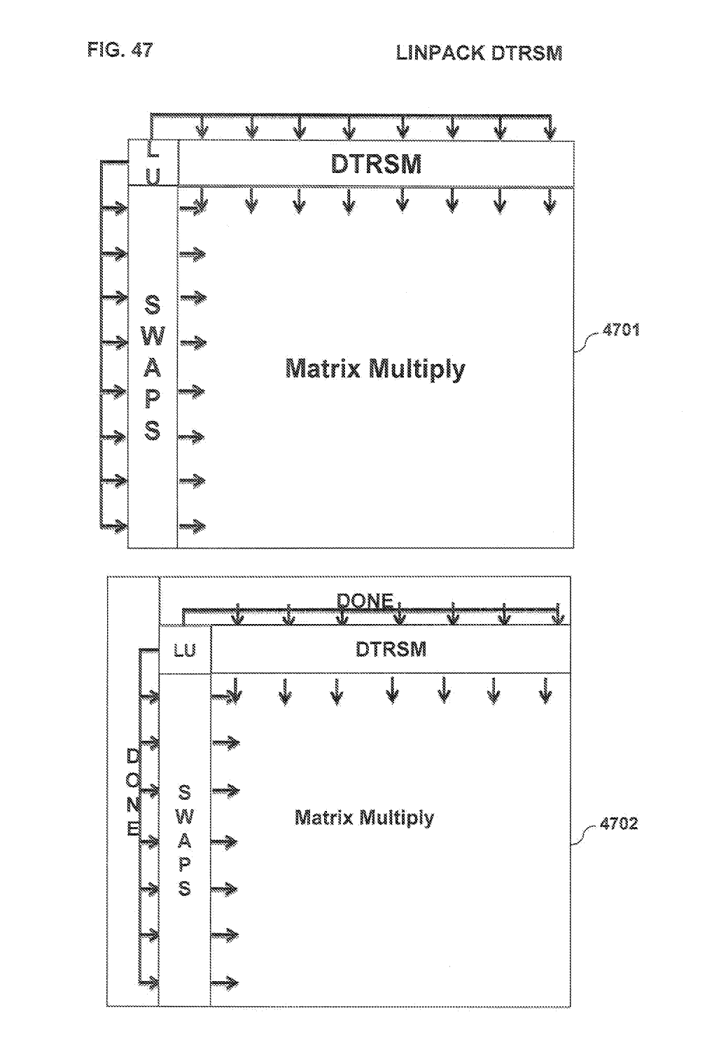

FIG. 47 illustrates an example of computing LINPACK DTRSM (double triangular right solve multiple). 4701 shows the initial dependencies. As soon as the first row and column are done, the system can move on to the next set of data.

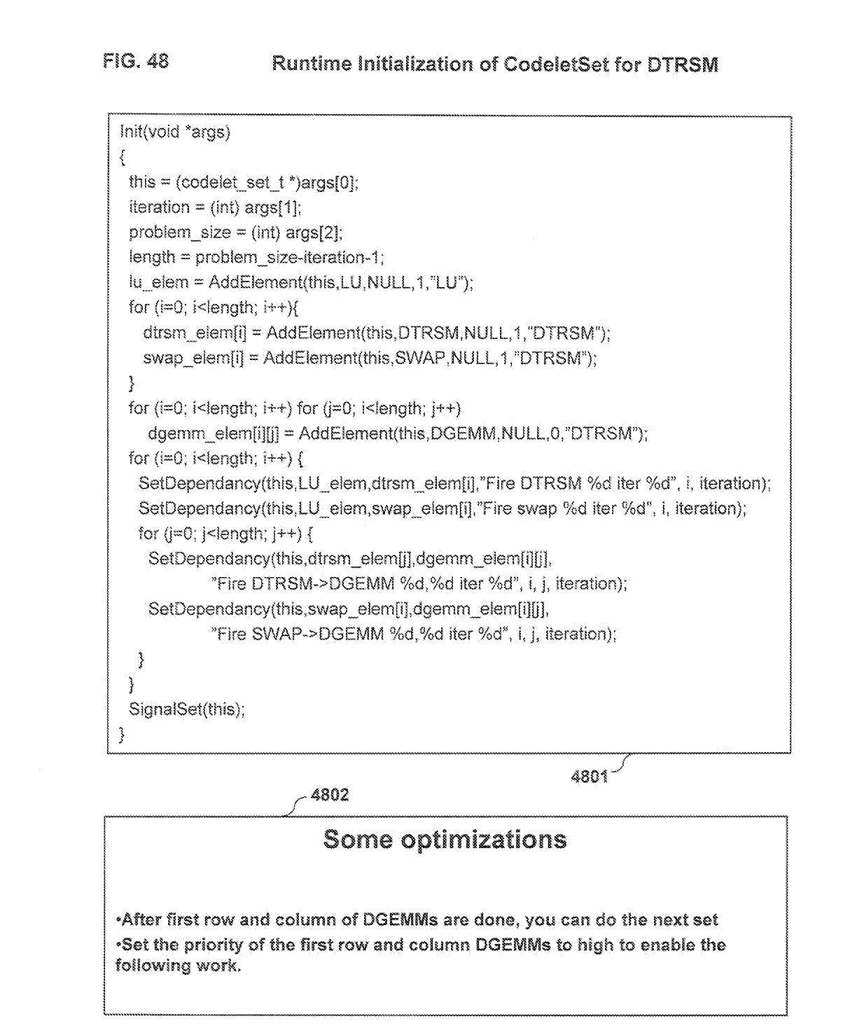

FIG. 48 illustrates exemplary runtime initialization of a codeletset for DTRSM. Note that Init( ) in 4801 may be called with a parameter that may indicate how many codelets will be generated. 4802 shows some optimizations that can be performed on the codelet-set implementation of DTRSM.

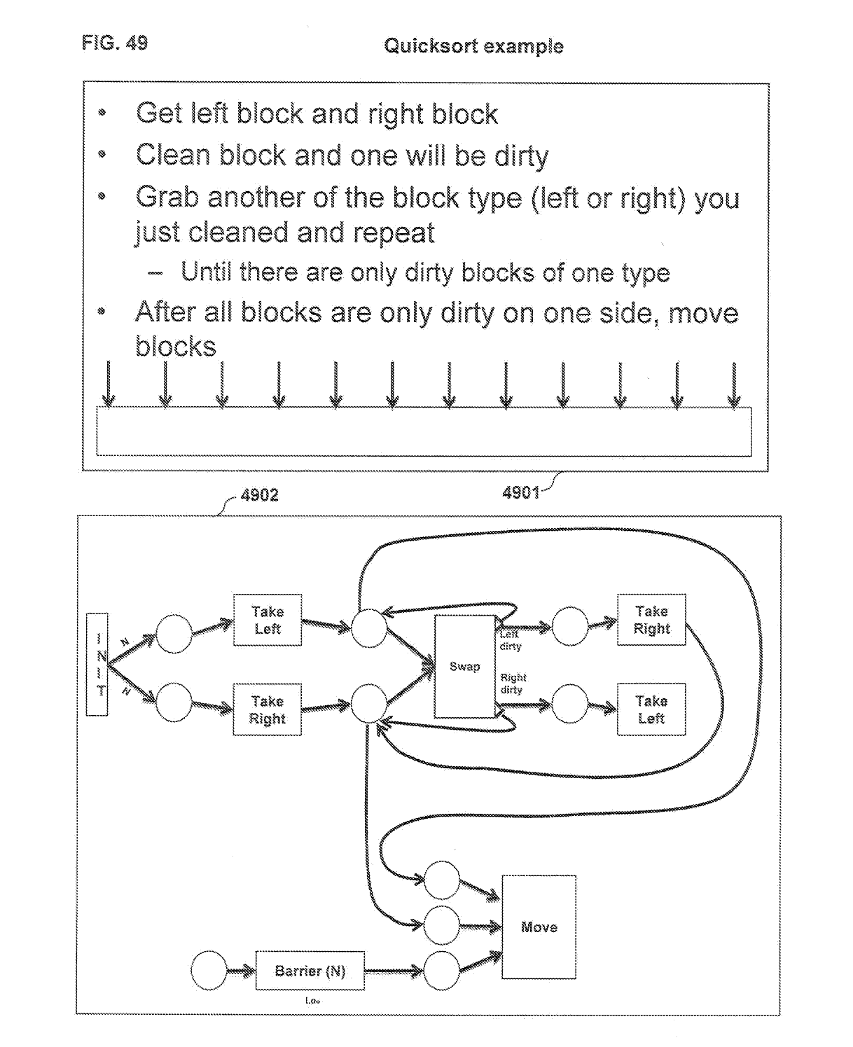

FIG. 49 illustrates a Quicksort example. In 4901, the control flow paths may be data dependent. The dependencies can be conditionally set based on codelet output, or intermediate state, if the dependencies are resolved/satisfied early. 4902 illustrates a Petri net representation for the quicksort graph. Given this representation, the threads may work on the top half until there is no more input data for the swap codelet (either because there is no more data or because all of the dirty data is on one side). When the execution unit has no more high-priority codelets, it may take low-priority codelets, e.g., waiting at the barrier. At this point, the “move” codelets may fire and move the pivot to the correct position.

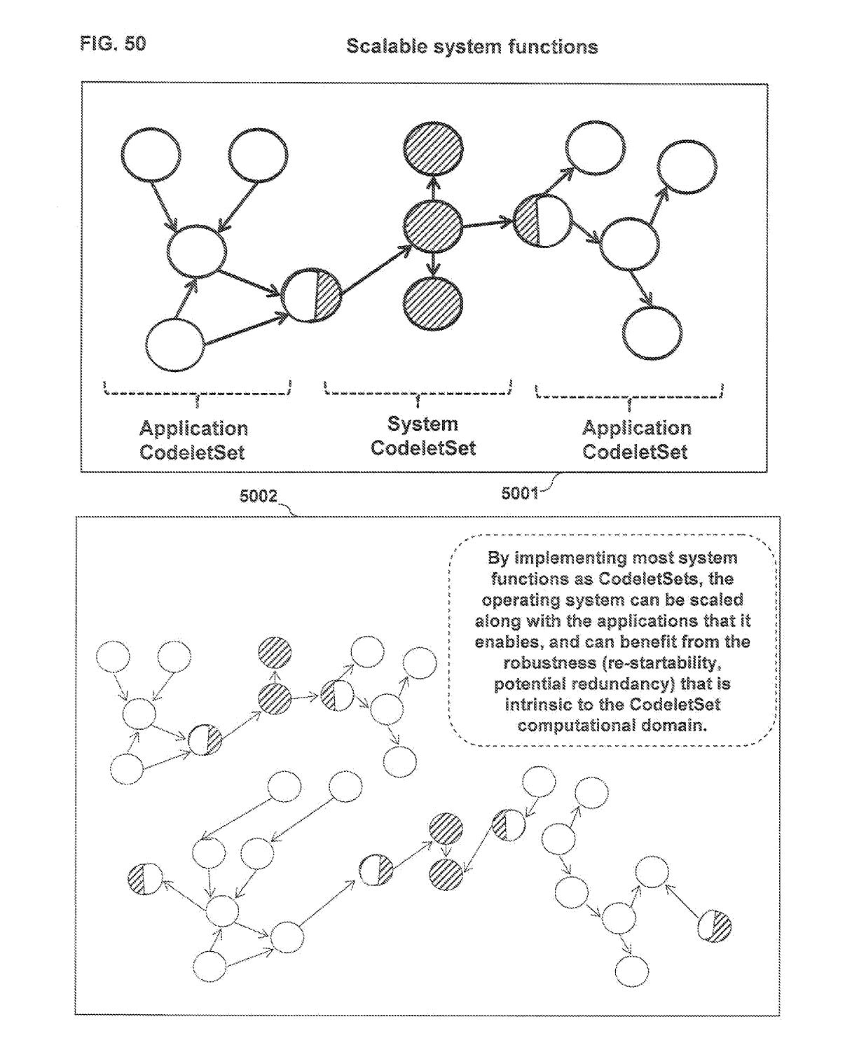

FIG. 50 illustrates an exemplary embodiment of scalable system functions interspersed with application codeletsets. Because system functionality can be fluidly integrated with codeletset applications, system designers may gain great flexibility in balancing system overhead versus system services. For some uses and applications, the system software may be nearly absent, while in other cases, extensive monitoring and debugging may cause more system tasks than application tasks to run at a given time.

### Polvtasks Used for Integration of Legacy Applications:

Note that in the following discussion, the word “function” is not limiting, but meant colloquially. Any computable procedures, even arbitrary blocks of executable code, could be used rather than functions, per se, in various embodiments of the invention. Additionally, most of the discussion describes codeletset components as “polytasks,” but this is not a limitation of the invention, as single tasks could also be integrated via the same approach.

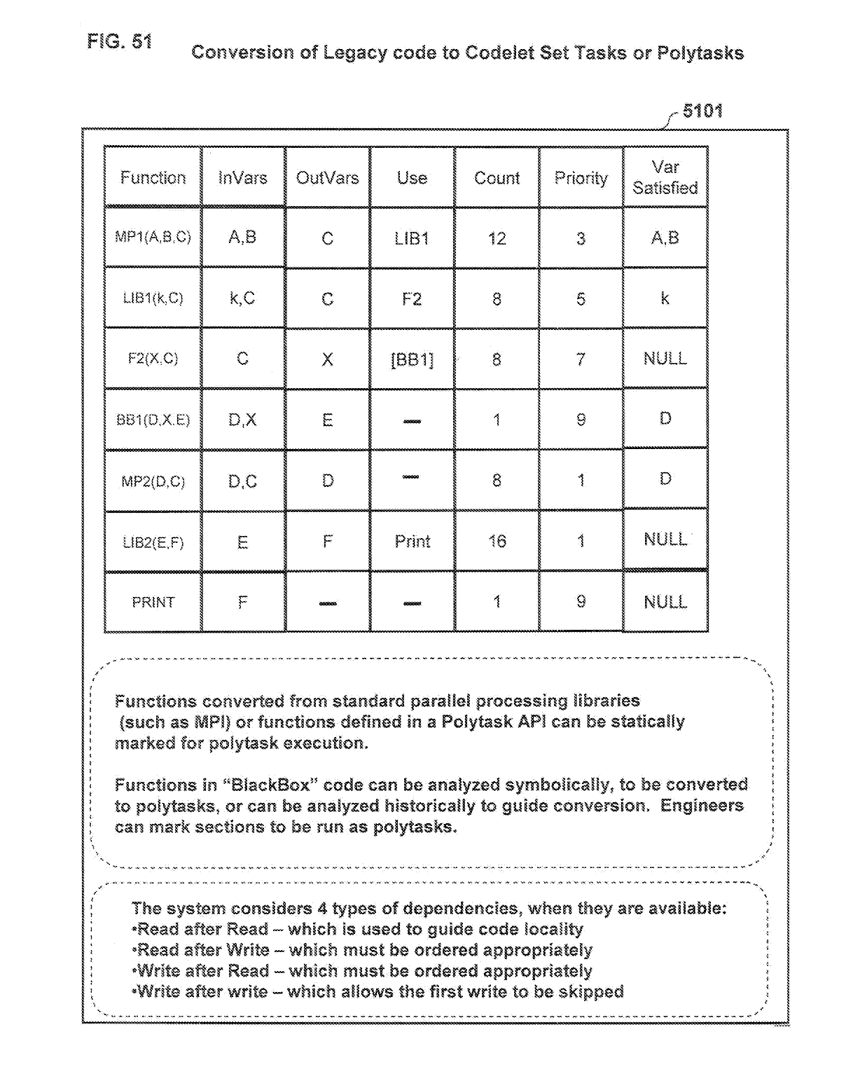

FIG. 51 illustrates an example of conversion of existing program code to tasks or polytasks, showing how polytask input-output tables can be used to develop concurrent evaluation of codes via codeletsets. The priorities may be constructed so that sequential tasks, which may be necessary to enable one or more subsequent concurrent tasks, may have a high priority. The mapping between particular elements of the sets of input variables to output variables may allow recipient functions to start processing as soon as the first instances become available. Counts of the numbers of separable instances in the codeletsets may allow the system software to distribute codelet executions to allow high CPU utilization and/or to exploit locality of data. The runtime system using polytask queues can be integrated into legacy applications. In one such embodiment, it can be integrated in a single threaded sequential program. In another embodiment, it can be integrated into one or more threads of a multithreaded program. In another embodiment, it can be integrated into each process of an MPI program. Functions may be called in a sequential manner in the sequential code. As shown in FIG. 51, one or more polytasks may be “registered” into a table. Each polytask may have a set of input variables, output variables, polytask counts priority, and an indicator “Var Satisfied” that may show whether its inputs have become available. The registration process is described in the next section. After the function registers the polytask, it may return to the legacy code. When the legacy code reaches a position where it needs to run sequential code that depends on the result of some polytask, the legacy code thread may spin calling a ‘check_status’ function with an input argument of the variable to probe for completion.

### Polytask Registration:

A function that registers a polytask may pass pointers to input variables needed for the polytask to be ready, pointers to the output of the polytask, a count of the number of polytasks, a function pointer to the polytask, and a priority. The first registered polytask may have no input dependencies (because there should generally be no output variables to wait for). If a polytask is immediately ready for execution, it may be inserted into a polytask ready queue of the specified priority. When a polytask with input variable dependencies is registered, the ‘check_status’ function may be run on the input variables. If they are already ready, then the polytask may be placed into the polytask ready queue of the correct priority. If they are not ready, the polytask may go into the polytask scoreboard. When a polytask is completed by the runtime system, the output dependencies may be marked as complete so that the ‘check_status’ function may return “true” now. Further, the thread that completed the polytask may also check all pending polytasks in the scoreboard for any that are now ready (because of the just completed polytask) and may put them into the polytask ready queue corresponding to the correct priority.

### Check Status:

Each output of a polytask can be probed to determine if the polytask that creates the output is complete. The thread running the legacy code can spin waiting for status to change. Additionally, when polytasks are completed, the inputs of polytasks in the scoreboard may be checked for dependence on the outputs of the completed polytask (as described above) using check_status.

### Variables as Pointers or Pointer Ranges:

In one embodiment, the variable (for dependence checking) may be identified only by a pointer to the variable. In another embodiment, the input and output variables may be identified by a pointer and a length (or a start and end pointer). In this way, ranges of memory can be marked as complete or incomplete. In another embodiment, the pointer or pointer range can be annotated with an iteration count. In this way, the same memory can be ‘complete’ and ‘not complete’ depending on the iteration.

### Dependence Resolution at Registration:

When a polytask is registered and input dependency variables are present, the table can be scanned for which polytask satisfies the dependence. A satisfying polytask can be annotated with a pointer to the newly registered function. In this way, when the satisfying polytask is completed, the scan can be skipped.

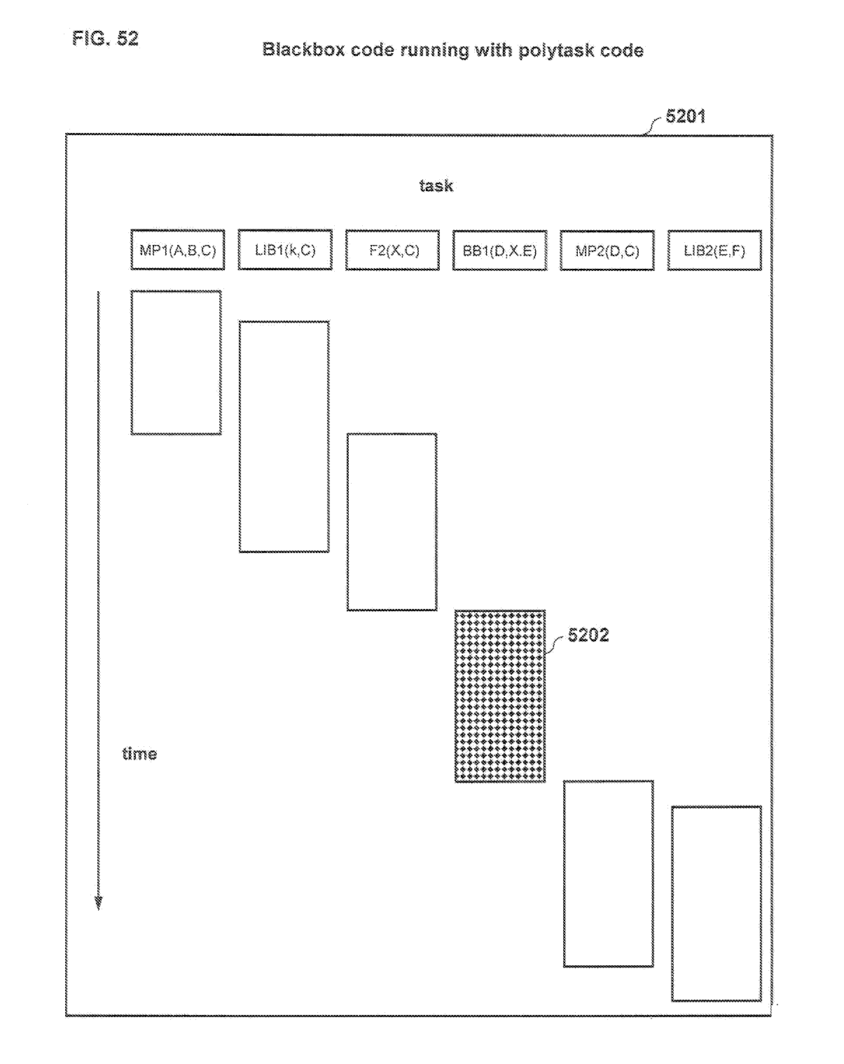

FIG. 52, an example of a case of “black-box” code running with polytask code, illustrates a scenario 5201 in which the library codes have been converted to codeletsets, but a component of black-box user code 5202 may still be inherently sequential. In alternative embodiments, priorities can be conservative, assuming that all blackbox values are needed for subsequent processing, or optimistic, based on user annotation of black-box functions (which can be provided outside of the compiled code), or inferred via actual observation of variable use in test runs of the black-box code. Note that for extensive integration of blackbox code, the system may typically require: annotation of the black-box function, a description of variable uses, requirements and access guarantees by the black-box function along with typical linker information of one or more entry points of the black-box function.

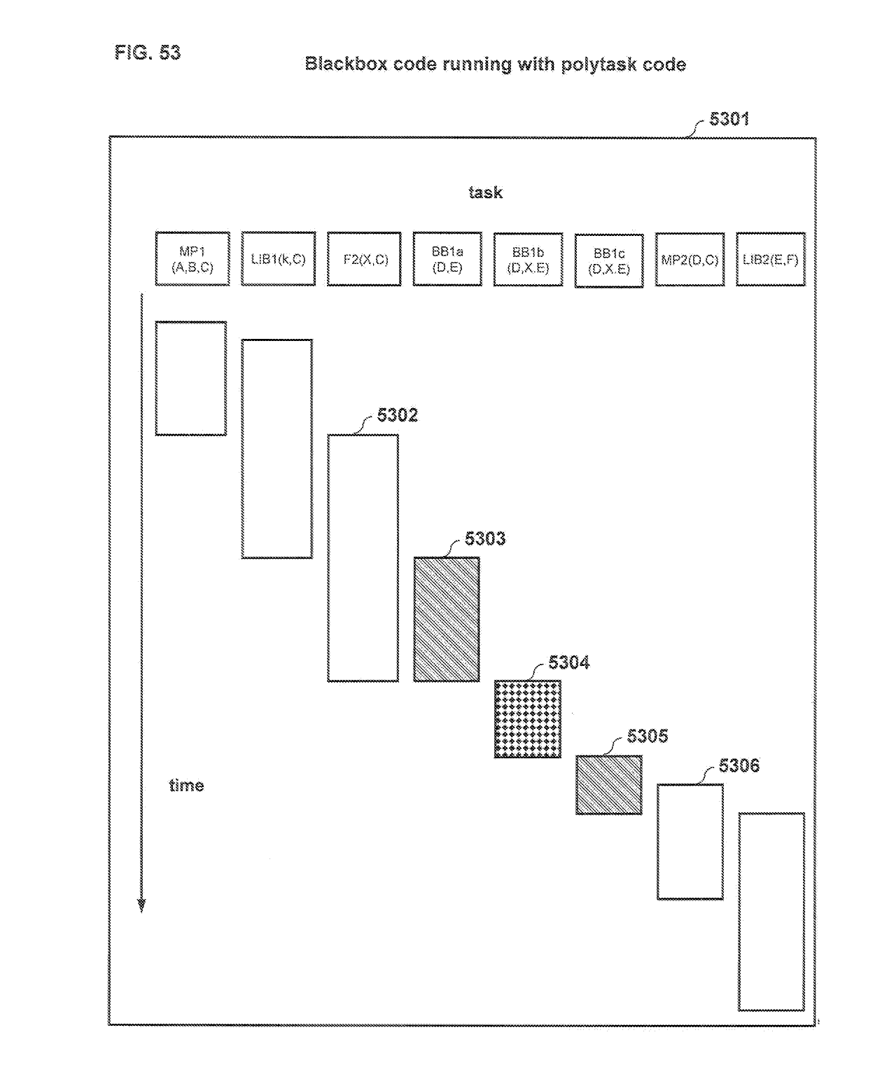

FIG. 53 illustrates an example of improved blackbox code running with polytask code. In this case, portions of the black-box code have been marked by the user, to enable availability for concurrent execution. The polytask 5302, which may correspond to function invocation F2(X,C), may precede the invocation of the black box task BB1. The initial section of the black box task, 5303, may correspond to refactored function BB1 a(D,X,E), and may have been converted to run currently, using results from 5302 as they become available. The next section of black-box function 5304 may correspond to BB1b(D,X,E) and may be inherently sequential, and for the purpose of this example, must complete before any subsequent operations. Ref. 5305 is a third part of the refactored black-box function, corresponding to function BB1 c(D,X,E), and may permit some concurrent execution with library call 5306, corresponding to MP2(D,C). In an embodiment of the invention, black box routines can be refactored, if at least some entry-points to routines, at least some annotation of routine dependency, and at least some data semantics are made available. Note that in alternative embodiments, speculative execution of subsequent functions can be performed, which may provide a way to gain concurrency even during the execution of 5304.

### Further Comments:

Various embodiments of the invention may address optimization of performance of an application program with respect to some performance measure(s) or with respect to some resource constraint(s). Exemplary performance measures or constraints may relate to, but are not limited to, a total runtime of the program, a runtime of the program within a particular section, a maximum delay before an execution of particular instruction, a quantity of processing units used, a quantity of memory used, a usage of register files, a usage of cache memory, a usage of level 1 cache, a usage of level 2 cache, a usage of level 3 cache, a usage of level N cache wherein N is a positive number, a usage of static RAM memory, a usage of dynamic RAM memory, a usage of global memory, a usage of virtual memory, a quantity of processors available for uses other than executing the program, a quantity of memory available for uses other than executing the program, energy consumption, a peak energy consumption, a longevity cost to a computing system, a volume of register updates needed, a volume of memory clearing needed, an efficacy of security enforcement and a cost of security enforcement.

Various implementations of the invention may be embodied in various forms, such as method, apparatus, etc. Among such embodiments may be embodiments in the form of one or more storage media (e.g., various types of memories, disks, etc.), having stored in them executable code/software instructions, which may be usable/readable by a computer and/or accessible via a communication network. While a computer-readable medium may, in general, include a signal carrying such code/software, in the context of this application, “storage medium” is understood to exclude such signals, per se.

### CONCLUSIONS

This detailed description provides a specification of embodiments of the invention for illustrative system operation scenarios and application examples discussed in the preceding. Specific application, architectural and logic implementation examples are provided in this and the referenced patent applications for the purpose of illustrating possible implementation examples of the invented concepts, as well as related invention utilization scenarios. Naturally, there are multiple alternative ways to implement or utilize, in whole or in part, the principles of the invention as set forth in the aforementioned. For instance, elements or process steps described or shown herein as distinct can in various embodiments be combined with each other or with additional elements or steps. Described elements can also be further subdivided, without departing from the spirit and scope of the invention. Moreover, aspects of the invention may in various embodiments be implemented using application and system software, general and specialized micro-processors, custom hardware logic, and various combinations thereof. Generally, those skilled in the art will be able to develop different versions and various modifications of the described embodiments, which, even if not each explicitly described herein individually, rely on the principles of the invention, and are thus included within its spirit and scope. It is thus intended that the specification and drawings be considered not in a restrictive sense, but as exemplary only, with the true scope of the invention indicated by the following claims.

What is claimed is:

1. A computer-implemented method for allocating computing resources of a computing system to computer tasks comprising:
a) obtaining, by the computing system, a group of codelets configured to accomplish at least one task;
b) obtaining, by the computing system, at least one specification of dependencies among the codelets within said group;
c) obtaining, by the computing system, at least one representation of codelet resource requirements of at least one codelet within said group;
d) using the codelet dependencies and codelet resource requirements to determine at least one efficient mapping of codelets to computing resources of the computing system; and
e) computing at least one value and outputting the at least one value to a memory or output device.

2. The method of claim 1, further comprising obtaining at least one representation of available resources and using the codelet dependencies and codelet resource requirements and available resources to determine the at least one mapping of codelets to resources.

3. The method of claim 1, further comprising dynamically assigning a first codelet within said group of codelets to a first set of resources for execution of the first codelet, based at least in part on the codelet dependencies and on the codelet resource requirements.

4. The method of claim 1, wherein the representation of codelet resource requirements includes at least one item selected from the group consisting of:
memory, multi-level memory, dynamic memory, static memory, cache memory, memory described by access rates, memory described by transfer rates, memory described by power consumption; processing elements, processing cores, thread processors, stream processors, processors described by instruction rates, processors described by floating-point instruction rates, processors described by power consumption, processors described by variable power consumption, processors described by idle-level power consumption, processors described by peak power consumption, communication resource, multi-level communication resource, communication resource described by transfer rate, communication resource described by latency, communication resource described by reliability, communication resource described by power consumption, communication resource described by variable power consumption, memory-based communication resource, LAN-based communication resource, switch-based communication resource, broadcast communication resource, multicast communication resource, point-to-point based communication resource, WAN-based communication resource, inter-thread communication resource, and inter-process communication resource.

5. The method of claim 1, wherein the representation of codelet resource requirements includes at least one item selected from the group consisting of:
physical location of the resource, physical location of ports of the resource, logical location of the resource, location of data, location of processing elements, location of memory, location of communication resources, location of at least one codelet currently allocated to at least one physical resource, location of data, location of at least one codelet instance currently allocated to at least one logical resource, location of at least one codelet instance currently executing, location of at least one codelet instance ready to execute, and location of at least one codelet instance that has completed execution.

6. The method of claim 1, further comprising using at least one mapping selected from a group consisting of: placing, locating, re-locating, moving, removing, and migrating.

7. The method of claim 1, further comprising using at least one mapping selected from a group consisting of: determining a start time for execution of a given codelet, and determining a place for the execution of the given codelet.

8. The method of claim 1, further comprising using at least one task to accomplish an application program.

9. The method of claim 1, further comprising performing said mapping based on at least one criterion selected from a group consisting of:
1) improving a performance metric of an application program,
2) improving utilization of the data processing system resources, and
3) improving a performance metric of an application program,
while complying with a given set of resource consumption targets.

10. The method of claim 1, further comprising performing mapping an application program with respect to a measure selected from a group consisting of:
a total runtime of the program, a runtime of the program within a particular section, a maximum delay before an execution of particular instruction, a quantity of processing units used, a quantity of memory used, a usage of register files, a usage of cache memory, a usage of level 1 cache, a usage of level 2 cache, a usage of level 3 cache, a usage of level N cache wherein N is a positive number, a usage of static RAM memory, a usage of dynamic RAM memory, a usage of global memory, a usage of virtual memory, a quantity processors available for uses other than executing the program, a quantify of memory available for uses other than executing the program, energy consumption, a peak energy consumption, a longevity cost to a computing system, a volume of register updates needed, a volume memory clearing needed, an efficacy of security enforcement, and a cost of security enforcement.

11. The method of claim 1, comprising performing mapping an application program within at least one constraint that is selected from the group consisting of:
a total runtime of the program, a runtime of the program within a particular section, a maximum delay before an execution of particular instruction, a quantity of processing units used, a quantity of memory used, a usage of register files, a usage of cache memory, a usage of level 1 cache, a usage of level 2 cache, a usage of level 3 cache, a usage of level N cache wherein N is a positive number, a usage of static RAM memory, a usage of dynamic RAM memory, a usage of global memory, a usage of virtual memory, a quantity processors available for uses other than executing the program, a quantify of memory available for uses other than executing the program, energy consumption, a peak energy consumption, a longevity cost to a computing system, a volume of register updates needed, a volume memory clearing needed, an efficacy of security enforcement, and a cost of security enforcement.

12. The method of claim 1, wherein said mapping is performed using a time-varying mixture of goals, wherein said mixture changes over time due to at least one factor selected from the group consisting of: pre-specified change and dynamically emerging changes.

13. The method of claim 1 further comprising applying a set of compile-time directives configured to aid in carrying out at least one operation selected from:
said obtaining the group of codelets; said obtaining the at least one specification of dependencies; said obtaining the least one representation; and said using the codelet dependencies and codelet resource requirements.

14. The method of claim 13, wherein at least one of the set of compile-time directives is selected from the group consisting of:
a floating point unit desired, a floating point accuracy desired, a frequency of access, a locality of access, a stalled access, a read-only data type, an initially read-only data type, a finally read-only data type, and a conditionally read-only data type.

15. A computer-implemented method for executing at least one computer program in a computing system including a plurality of processing elements, the method comprising:
a) decomposing, by the computing system, the computer program into a set of abstract modules, wherein an abstract module comprises one or more of the following members: a codelet, a set of cooperating codelets, a set of cooperating abstract modules, or data shared by at least some of the other members of an abstract module;
b) defining relations of proximity in memory space and/or execution time among members of the set of abstract modules;
c) performing, by a runtime system of the computing system, at least one of the following: i) initially placing data or starting execution of one or more codelets within an abstract module in a coordinated manner among the plurality of processing elements, or ii) when beneficial in pursuing the user or system defined goal, migrating members of abstract modules in a coordinated manner among the plurality of processing elements, wherein the placing or the migrating, is done based at least in part on the relations of proximity; and
d) computing at least one value and outputting the at least one value to a memory or output device.

16. The method of claim 15, wherein the decomposing comprises decomposing the computer program with the goal of reducing dependencies among the abstract modules.

17. The method of claim 15, wherein said migrating is performed based on one or more goals selected from the group consisting of: user goals, system goals, response time goals, latency goals, throughput goals, reliability goals, and availability goals.

18. The method of claim 15, further comprising determining a set of dependencies among the abstract modules.

19. A computer-implemented method for achieving defined performance goals relating to execution of a computer program in a computing system including a plurality of processing resources, the method comprising:
a) decomposing, by the computing system, the computer program into a set of abstract modules, wherein an abstract module comprises one or more of: a codelet, a set of cooperating codelets, a set of cooperating abstract modules, or data shared by at least some of the other members of an abstract module;
b) obtaining, by the computing system, program run-time information related to the abstract modules, performance, and resource utilization associated with the program;
c) using the program run-time information to guide subsequent placement among the plurality of processing resources or execution scheduling of the abstract modules in an ongoing run or in a subsequent run of at least a portion of said computer program; and
d) computing at least one value and outputting the at least one value to a memory or output device.

20. The method of claim 19, wherein the goals consist of at least one selected from the group consisting of user goals and system goals.

21. The method of claim 19, wherein the decomposing comprises decomposing the computer program with a goal of reducing dependencies among the abstract modules.

22. The method of claim 19, further comprising determining a set of dependencies among the abstract modules.

23. The method of claim 19, further comprising migrating, among the plurality of processing resources, elements of an abstract module containing an executing or soon-to-executed codelet, based at least in part on a criterion of improving locality of the elements of the abstract module.

24. The method of claim 19, further comprising migrating, among the plurality of processing resources, elements of an abstract module, based on a criterion selected from a group consisting of:
improving global allocation of resources, allowing processing resource to be attenuated for energy saving, allowing a processing resource to be powered-down, and using processing resources better suited for a given processing task.

25. A computer-implemented method for allocating a plurality of data processing resources of a computing system to data processing tasks, the method comprising:
a) at compile time, analyzing, by the computing system, potential code and data allocations among the plurality of data processing resources to identify one or more opportunities for an action selected from a group consisting of: codelet migration and data migration;
b) at run time, migrating codelets or data among the plurality of data processing resources to exercise opportunities presented by actual code and data allocations; and
c) computing at least one value and outputting the at least one value to a memory or output device.

26. The method of claim 25, wherein the migrating includes moving codelets to one or more underutilized processing resources.

27. The method of claim 25, further comprising making copies of at least some data from one locale to another, in anticipation of migrating at least one codelet.

28. The method of claim 25, further comprising providing security marking for a codelet, wherein said marking indicates restrictions or privileges to be considered in treatment of said codelet by the method.

29. A computer-implemented method for partitioning execution, in a computing system including a plurality of processing elements, of at least a segment of a software application, the method comprising:
a) querying, by the computing system, a runtime system to discover a quantity of processing elements available for the application segment;
b) determining a maximum quantity of processing units into which the segment is divisible;
c) based on the quantities determined in a) and b), dividing the segment into an efficient number of processing units and allocating the processing units to one or more of the processing elements for execution; and
d) computing at least one value and outputting the at least one value to a memory or output device.

30. A computer-implemented method for improving resource-efficiency of program execution in a computing system, the method comprising:
a) at a program compile-time, determining, by the computing system, an efficient execution environment for respective codelets of the program;
b) at a program run-time, placing and scheduling codelets, in one or more processing elements of the computing system, according to their efficient execution environments, based at least in part on said determining; and
c) computing at least one value and outputting the at least one value to a memory or output device.

31. A data processing system including multiple cores, at least one memory unit, at least one input device, and at least one output device, the data processing system further comprising:
a) a set of multiple system management agents, said set including one or more among: data percolation manager, a codelet scheduler, a codelet migration manager, a load balancer, a power regulator or a performance manager;
b) means for said set of system management agents to interact in a synergistic manner to optimize program execution in the multiple cores; and
c) resulting in at least one computed value held in at least one memory unit.

32. A data processing system including multiple cores, at least one memory unit, at least one input device, and at least one output device, wherein the data processing system is configured to place a set of codelets in the processing system, the data processing system further comprising:
a) means for exchanging information among a set of processing resources in the data processing system regarding metrics relevant to efficient placement of the set of codelets among the processing resources;
b) means for determining to which of the processing resources to locate one or more codelets among said set;
c) means for mapping the one or more codelets to one or more processing resources according to said determining; and
d) resulting in at least one computed value held in at least one memory unit.

33. A computer usable storage medium or network accessible storage medium having executable program code stored thereon, wherein at least a portion of said program code, upon execution, results in the implementation of operations according to the method of claim 19.

34. A computer usable storage medium or network accessible storage medium having executable program code stored thereon, wherein at least in a portion of said program code, upon execution, results in the implementation of operations according to the method of claim 25.

35. A computer usable storage medium or network accessible storage medium having executable program code stored thereon, wherein at least a portion of said program code, upon execution, results in the implementation of operations according to the method of claim 29.

36. A computer usable storage medium or network accessible storage medium having executable program code stored thereon, wherein at least a portion of said program code, upon execution, results in the implementation of operations according to the method of claim 30.

37. A computer usable storage medium or network accessible storage medium having executable program code stored thereon, wherein at least a portion of said program code, upon execution, results in the implementation of operations according to the method of claim 1.

38. A computer usable storage medium or network accessible storage medium having executable program code stored thereon, wherein at least a portion of said program code, upon execution, results in the implementation of operations according to the method of claim 15.

39. The method of claim 1, wherein the computing system is a heterogeneous computing system.

40. The method of claim 39, wherein the processing elements comprise at least one type of processing element selected from the group consisting of:
processing core, thread processor, pipelined processor, superscalar processor, stream processor, CPU, GPU, microprogrammed processing unit, vector processors, virtual processor, processors with differing architectures, processors with differing instruction sets, processors with differing speeds, processors with differing power consumption, processors with differing numbers of cores, processors with differing numbers of thread units, mixed core processors, microcomputer processors, minicomputer processors, workstation processors, mobile unit processors, mainframe processors, cluster processors, grid processors, cloud processors, Single Instruction Single Data (SISD) processors, Multiple Instruction Single Data (MISD) processors, Single Instruction Multiple Data (SIMD) processors, Multiple Instruction Multiple Data (MIMD) processors, Digital Signal Processors (DSP), Field-programmable Gate Arrays (FPGA), Application-Specific Integrated circuits (ASIC), and CPLDs (Complex Programmable Logic Devices).

41. The method of claim 39, wherein the at least one memory unit comprises at least one type of memory unit selected from the group consisting of:
contiguous memory, cache memory, main memory, Random Access Memory (RAM), Dynamic Random Access Memory (DRAM), Double Datarate Synchronous DRAM (DDR), Synchronous DRAM (SDRAM), Fast-Cycle RAM (FCRAM), Magnetic Random Access Memory (MRAM), Non-Volatile Random Access Memory (NVRAM), Read Only Memory (ROM), Electrically Programmable Read Only Memory (EPROM), Uniform Memory Access (UMA) memory, Non-Uniform Memory Access (NUMA) memory, Scratchpad RAM (SPM) memory, disk storage, Direct Access Storage Device (DASD), Distributed Mass Storage System (DMSS), High Capacity Storage System (HCSS), Hierarchical Storage Management (HSM), Mass Storage Device (MSD), Mass Storage System (MSS), Multiple Virtual Storage (MVS), Network Attached Storage (NAS), Redundant Arrays of Independent Disk (RAID), Storage/System Area Network (SAN), and Electrically Erasable Programmable Read-Only Memory (EEPROM).

42. The method of claim 39, wherein a plurality of codelets communicate using at least one of the group consisting of:
communication ports, input-output ports, Ethernet ports, Myrinet ports, gigabit ethernet ports, Infiniband interconnects, fiber optic communication ports, local area networks, network switches, PCI Express, Serial ATA, Firewire, SONET, Wireless networks, wide area networks, cellular networks, computer bus signaling, shared memory, direct memory access, switches, crossbars, peripheral busses, and peripheral ports.

43. The method of claim 39, wherein the heterogeneous computing system consists of heterogeneity in at least one aspect selected from the group consisting of:
CPU, GPU, memory, input devices, output devices, storage devices, execution model, operating system, pre-existing computational load, predicted computational load, instruction set, version of component and version of software.

44. A computer-implemented method for improving computing of at least one legacy application in a computing system, the method comprising:
a) obtaining, by the computing system, at least one specification of a group of codelets configured to accomplish at least one task;
b) obtaining at least one specification of a legacy procedure that will interact with the task;
c) using the at least one specification of a group of codelets and the at least one specification of a legacy procedure to integrate the execution of the codelets and the legacy procedure,
d) executing the legacy procedure and the task on the computing system; and
e) computing at least one value and outputting the at least one value to a memory or output device.

45. The method of claim 44, further comprising obtaining a result from the combined legacy procedure and the task to satisfy one or more requirements of the original legacy application.

46. The method of claim 44, wherein the at least one specification of the group of codelets or of the legacy procedure comprises at least one item selected from the group consisting of:
incoming variables, outgoing variables, use indicator, count, priority, and variable satisfaction state.

47. The method of claim 44, further comprising using procedural annotations and procedural data use descriptions to integrate codeletset implementations of task execution with existing legacy application code, wherein the source code of the legacy application is unavailable.

48. A computer usable storage medium or network accessible storage medium having executable program code stored thereon, wherein at least a portion of said program code, upon execution, results in the implementation of operations according to the method of claim 39.

49. A computer usable storage medium or network accessible storage medium having executable program code stored thereon, wherein at least a portion of said program code, upon execution, results in the implementation of operations according to the method of claim 44.
